(19) United States
(12) Patent Application Publication
(10) Pub. No.: US 2022/0312774 A1
(43) Pub. Date: Oct. 6, 2022

(54) COMPOSITIONS AND METHODS FOR IMPROVING PLANT HEALTH AND CONTROLLING PLANT DISEASE

(71) Applicant: AgBiome, Inc., Durham, NC (US)

(72) Inventors: David Joseph Ingham, Cary, NC (US); Vincent James Spadafora, Yardley, PA (US); Mathias Twizeyimana, Durham, NC (US)

(73) Assignee: AgBiome, Inc., Durham, NC (US)

(21) Appl. No.: 17/616,800

(22) PCT Filed: Jun. 5, 2020
(86) PCT No.: PCT/US2020/036460

§ 371 Date: Dec. 6, 2021

Related U.S. Application Data
(60) Provisional application No. 62/858,653, filed on Jun. 7, 2019.
(60) Provisional application No. 62/967,852, filed on Jan. 30, 2020.

(51) Int. Cl. A01N 63/27; A01N 25/14; A01N 43/50; A01N 43/54; A01N 43/653

(52) U.S. Cl. CPC A01N 63/27; A01N 25/14; A01N 43/50; A01N 43/54; A01N 43/653

(57) ABSTRACT

Compositions and methods for treating or preventing plant disease are provided. Such compositions and methods comprise a combination of at least one synthetic fungicide selected from the group consisting of tetraconazole, triflumizole, azoxystrobin, flutriafol, tebuconazole, chlorothalonil, and difenoconazole, and a bacterial strain that control one or more pathogens that cause plant disease or improve at least one agronomic trait of interest in a plant. The combination of the synthetic fungicide and bacterial strain can be used as an inoculant for plants. Therefore, methods for growing a plant susceptible to a plant disease and methods for controlling plant disease on a plant susceptible to the plant disease are provided.

### FIELD OF THE INVENTION

The invention relates to bacterial strains and populations for controlling plant disease and/or improving an agronomic trait of interest in a plant. test

### BACKGROUND

Plant diseases are responsible for significant agricultural losses. Effects can range from mild symptoms to catastrophic plant damage, which can lead to major economic and social consequences. Methods are needed to effectively control plant diseases and the pathogens that cause them.

### SUMMARY

Compositions and methods for controlling plant disease and/or for improving at least one agronomic trait of interest in a plant are provided. Such compositions and methods comprise a population of biocontrol agents or bacterial strains that control one or more pathogens that cause plant disease and/or improve at least one agronomic trait of interest. The biological agents or bacterial strains can be used as an inoculant for plants. Methods for growing a plant susceptible to plant disease and methods and compositions for controlling plant disease are also provided. Further provided are methods and compositions of increasing disease resistance in plants. Methods and compositions for improving plant health and/or improving at least one agronomic trait of interest are also provided.

### DETAILED DESCRIPTION

### I. Overview

Compositions and methods for improving at least one agronomic trait of interest and/or improving plant health and/or for controlling one or more plant diseases are provided. The compositions and methods described herein comprise a combination (applied simultaneously or sequentially) of a biocontrol agent and at least one synthetic fungicide selected from the group consisting of tetraconazole, triflumizole, azoxystrobin, flutriafol, tebuconazole, chlorothalonil, and difenoconazole. A biological agent, biocontrol agent, bacterial strain, modified bacterial strain, modified biological agent, or modified biocontrol agent or active variant thereof are used herein to describe a microorganism that is used to control disease-causing plant pathogens and/or improve at least one agronomic trait of interest and/or improve plant health. Combination (applied simultaneously or sequentially) of a biocontrol agent with at least one synthetic fungicide selected from the group consisting of tetraconazole, triflumizole, azoxystrobin, flutriafol, tebuconazole, chlorothalonil, and difenoconazole can provide an improvement in at least one agronomic trait of interest and/or improving plant health and/or for controlling one or more plant diseases are provided. When certain biocontrol agents are used together with at least one synthetic fungicide selected from the group consisting of tetraconazole, triflumizole, azoxystrobin, flutriafol, tebuconazole, chlorothalonil, and difenoconazole, lower amounts of the biocontrol agent and/or the synthetic fungicide can provide an improvement in at least one agronomic trait of interest and/or plant health and/or can control one or more plant diseases than when applying the standard amounts of the biocontrol agent and synthetic fungicide independently.

In some embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the biocontrol agents listed herein produce at least an additive effect, and in particular embodiments a synergistic effect, that allows for use of a lower amount of the biocontrol agent and/or synthetic fungicide (i.e., tetraconazole, triflumizole, azoxystrobin, flutriafol, tebuconazole, chlorothalonil, or difenoconazole) than the suggested or commonly used amount for application. In this manner, lower amounts of biocides can be added to crops or plants in order to increase disease control, reduce chemical residues, reduce pathogen resistance, and increase product usage base acres in multiple crops for the bacterial strain and synthetic fungicide. Thus, in some embodiments, lower rates of the biocontrol agent and the synthetic fungicide can provide a synergistic effect (i.e., greater than additive or superadditive).

As used herein, a “synthetic fungicide” is a chemical substance that can exert a controlling effect on one or more fungi or fungal-like organism by chemical means, leading to the death of the fungus or fungal-like organism or its spores or inhibition of the growth of the fungus or the fungal-like organism. In particular embodiments, the synthetic fungicide of the presently disclosed compositions and methods is tetraconazole, triflumizole, azoxystrobin, flutriafol, tebuconazole, chlorothalonil, and difenoconazole. Tetraconazole, tebuconazole, flutriafol, and difenoconazole are triazoles. Azoxystrobin is a methoxyacrylate strobilurin antifungal agent. Chlorothalonil is an aromatic fungicide.

### II. Bacterial Strains

Various biocontrol agents or bacterial strains are provided which can be used in combination with at least one synthetic fungicide selected from the group consisting of tetraconazole, triflumizole, azoxystrobin, flutriafol, tebuconazole, chlorothalonil, and difenoconazole to control one or more plant disease and/or improve at least one agronomic trait of interest and/or improve plant health. Such bacterial strains include AIP1620 and AIP050999. AIP1620 is a Pseudomonas strain that has been selected for glyphosate tolerance. AIP050999 is a Pseudomonas strain that has been selected for glufosinate tolerance. Biocontrol agents further comprise CGA267356 (ATTC Accession no. 55169) described in U.S. Pat. No. 5,348,742. Cell populations comprising one or more of AIP1620, AIP050999, and CGA267356 are provided.

Thus, various bacterial strains and/or the pesticidal compositions provided herein comprise as an active ingredient (a) a cell population comprising one or more of AIP1620, AIP050999, and CGA267356, or an active variant of any thereof along with at least one synthetic fungicide selected from the group consisting of tetraconazole, triflumizole, azoxystrobin, flutriafol, tebuconazole, chlorothalonil, and difenoconazole.

AIP1620 was deposited with the Patent Depository of the National Center for Agricultural Utilization Research Agricultural Research Service, U.S. Department of Agriculture, 1815 North University Street, Peoria, Ill. 61604 U.S.A. on Jan. 31, 2014 and assigned NRRL No. B-50897. AIP050999 was deposited with the Patent Depository of the National Center for Agricultural Utilization Research Agricultural Research Service, U.S. Department of Agriculture, 1815 North University Street, Peoria, Ill. 61604 U.S.A. on Jan. 23, 2015 and assigned NRRL No. B-50999. Each of these deposits will be maintained under the terms of the Budapest Treaty on the International Recognition of the Deposit of Microorganisms for the Purposes of Patent Procedure. This deposit was made merely as a convenience for those of skill in the art and are not an admission that a deposit is required under 35 U.S.C. § 112.

The term “isolated” encompasses a bacterium, spore, or other entity or substance, that has been (1) separated from at least some of the components with which it was associated when initially produced (whether in nature or in an experimental setting), and/or (2) produced, prepared, purified, and/or manufactured by the hand of man. Isolated bacteria may be separated from at least about 10%, about 20%, about 30%, about 40%, about 50%, about 60%, about 70%, about 80%, about 90%, or more of the other components with which they were initially associated.

As used herein, a substance is “pure” if it is substantially free of other components. The terms “purify,” “purifying” and “purified” refer to a bacterium, spore, or other material that has been separated from at least some of the components with which it was associated either when initially produced or generated (e.g., whether in nature or in an experimental setting), or during any time after its initial production. A bacterium or spore or a bacterial population or a spore population may be considered purified if it is isolated at or after production, such as from a material or environment containing the bacterium or bacterial population or spore, and a purified bacterium or bacterial population or spore may contain other materials up to about 10%, about 20%, about 30%, about 40%, about 50%, about 60%, about 70%, about 80%, about 90%, or above about 90% and still be considered purified. In some embodiments, purified bacteria or spores and bacterial populations or spore populations are more than about 80%, about 85%, about 90%, about 91%, about 92%, about 93%, about 94%, about 95%, about 96%, about 97%, about 98%, about 99%, or more than about 99% pure. In specific embodiments, a culture of bacteria contains no other bacterial species in quantities to be detected by normal bacteriological techniques.

By “population” is intended a group or collection that comprises two or more (i.e., 10, 100, 1,000, 10,000, 1×10⁶, 1×10⁷, or 1×10⁸ or greater). Various compositions are provided herein that comprise a population of at least one bacterial strain. In specific embodiments, the population of at least one of a bacterial strain (i.e., AIP1620, AIP050999, and CGA267356 or an active variant of any thereof) comprises a concentration of at least about 10³ CFU/ml to about 10⁵ CFU/ml, 10³ CFU/ml to about 10⁴ CFU/ml, 10³ CFU/ml to about 10⁶ CFU/ml, 10⁴ CFU/ml to about 10⁸ CFU/ml, 10⁵ CFU/ml to about 10¹¹ CFU/ml, about 10⁵ CFU/ml to about 10¹⁰ CFU/ml, about 10⁵ CFU/ml to about 10¹² CFU/ml, about 10⁵ CFU/ml to about 10⁶ CFU/ml, about 10⁶ CFU/ml to about 10⁷ CFU/ml, about 10⁷ CFU/ml to about 10⁸ CFU/ml, about 10⁸ CFU/ml to about 10⁹ CFU/ml, about 10⁹ CFU/ml to about 10¹⁰ CFU/ml, about 10¹⁰ CFU/ml to about 10¹¹ CFU/ml, about 10¹¹ CFU/ml to about 10¹² CFU/ml. In other embodiments, the concentration of the bacterial strain provided herein or active variant thereof comprises at least about 10² CFU/ml, at least about 10³ CFU/ml, at least about 10⁴ CFU/ml, at least about 10⁵ CFU/ml, at least about 10⁶ CFU/ml, at least about 10⁷ CFU/ml, at least about 10⁸ CFU/ml, at least about 10⁹ CFU/ml, at least about 10¹⁰ CFU/ml, at least about 10¹¹ CFU/ml, or at least about 10¹² CFU/ml or equivalent measure of bacterial concentration. In particular embodiments, the population of at least one bacterial strain (i.e., AIP1620, AIP050999, and CGA267356 or an active variant of any thereof) comprises a concentration of at least about 10³ CFU/g to about 10⁴, 10³ CFU/g to about 10⁵ CFU/g, CFU/g, 10³ CFU/g to about 10⁶ CFU/g, 10⁴ CFU/g to about 10⁸ CFU/g, 10⁵ CFU/g to about 10¹¹ CFU/g, about 10⁵ CFU/g to about 10¹⁰ CFU/g, about 10⁵ CFU/g to about 10¹² CFU/g, about 10⁵ CFU/g to about 10⁶ CFU/g, about 10⁶ CFU/g to about 10⁷ CFU/g, about 10⁷ CFU/g to about 10⁸ CFU/g, about 10⁸ CFU/g to about 10⁹ CFU/g, about 10⁹ CFU/g to about 10¹⁰ CFU/g, about 10¹⁰ CFU/g to about 10¹¹ CFU/g, about 10¹¹ CFU/g to about 10¹² CFU/g. In other embodiments, the concentration of the bacterial strain provided herein or active variant thereof comprises at least about 10² CFU/g, at least about 10³ CFU/g, at least about 10⁴ CFU/g, at least about 10⁵ CFU/g, at least about 10⁶ CFU/g, at least about 10⁷ CFU/g, at least about 10⁸ CFU/g, at least about 10⁹ CFU/g, at least about 10¹⁰ CFU/g, at least about 10¹¹ CFU/g, or at least about 10¹² CFU/g or equivalent measure of bacterial concentration. The bacterial concentration of a given solid or liquid composition or formulation can be expressed in CFU/g or CFU/mL, respectively, or by an equivalent measure of bacterial concentration using any methods described herein. For example, a measure of bacterial concentration that is equivalent to CFU can be expressed in terms of cells/g or cells/mL if using epifluorescent measurements or μg of pyrrolnitrin per g of bacteria when using pyrrolnitrin measurements as a reporter metabolite. When applied with at least one synthetic fungicide selected from the group consisting of tetraconazole, triflumizole, azoxystrobin, flutriafol, tebuconazole, chlorothalonil, and difenoconazole, the concentration of the bacterial strain can be lower in a composition intended for application as a diluted mixture when compared to the concentration of the bacterial strain in a composition intended for application as a diluted mixture in the absence of the synthetic fungicide (i.e., tetraconazole, triflumizole, azoxystrobin, flutriafol, tebuconazole, chlorothalonil, or difenoconazole).

The compositions comprising a bacterial strain (i.e., at least one of AIP1620, AIP050999, and CGA267356, or an active variant of any thereof, and/or at least one synthetic fungicide selected from the group consisting of tetraconazole, triflumizole, azoxystrobin, flutriafol, tebuconazole, chlorothalonil, and difenoconazole can further comprise an agriculturally acceptable carrier. The term “agriculturally acceptable carrier” is intended to include any material that facilitates application of a composition to the intended subject (i.e, a plant or plant part susceptible to a plant disease of interest (i.e., Asian Soybean Rust (ASR), or any other disease disclosed herein or a plant or plant part for improving an agronomic trait of interest)). Carriers used in compositions for application to plants and plant parts are preferably non-phytotoxic or only mildly phytotoxic. A suitable carrier may be a solid, liquid or gas depending on the desired formulation. In one embodiment, carriers include polar or non-polar liquid carriers such as water, mineral oils and vegetable oils. Additional carriers are disclosed elsewhere herein.

Compositions and/or formulations comprising the bacterial strain, or variant thereof, disclosed herein can be combined with at least one synthetic fungicide composition as disclosed herein, as a pre-mix or, if appropriate, not combined until immediately prior to use (i.e, tank mix). A pre-mix formulation can comprise 1 to 95 percent, of the desired ingredients (bacterial composition or synthetic fungicide), 99 to 5 percent, of a solid or liquid adjuvant (including, for example, a solvent such as water), where the auxiliaries 0.5 to 40 percent, based on the pre-mix formulation. In specific embodiments compositions and/or formulations comprising the bacterial strain, or variant thereof, disclosed herein can be packaged with a at least one synthetic fungicide composition as disclosed herein. For example, a single container can comprise a packaged bacterial composition or formulation and a separately packaged synthetic fungicide formulation. In some embodiments, the compositions and/or formulations comprising the bacterial strain, or variant thereof, and the synthetic chemistry disclosed herein can be provided in a single container as a pre-mix formulation or as a blended formulation.

A. Active Variants of a Bacterial Strain

Further provided are compositions comprising at least one synthetic fungicide selected from the group consisting of tetraconazole, triflumizole, azoxystrobin, flutriafol, tebuconazole, chlorothalonil, and difenoconazole and/or active variants of AIP1620, AIP050999, and/or CGA267356. Variants of AIP1620, AIP050999, and/or CGA267356 will retain the ability to control one or more plant diseases (i.e., reduce disease severity and/or reduce disease development) and/or control one or more plant pathogens when applied in combination with at least one synthetic fungicide selected from the group consisting of tetraconazole, triflumizole, azoxystrobin, flutriafol, tebuconazole, chlorothalonil, and difenoconazole. In some embodiments, variants of AIP1620, AIP050999, and/or CGA267356 will retain the ability to control one or more fungal plant diseases and/or plant disease caused by a fungal-like pathogen and/or one or more fungal pathogens and/or one or more fungal-like pathogen in combination with at least one synthetic fungicide selected from the group consisting of tetraconazole, triflumizole, azoxystrobin, flutriafol, tebuconazole, chlorothalonil, and difenoconazole. In other embodiments, variants will retain the ability to control ASR when applied in combination (simultaneously or sequentially) with at least one synthetic fungicide selected from the group consisting of tetraconazole, triflumizole, azoxystrobin, flutriafol, tebuconazole, chlorothalonil, and difenoconazole. In some embodiments, variants will retain the ability to synergistically control one or more fungal plant diseases, plant diseases caused by fungal-like pathogens, and/or one or more fungal pathogens or fungal-like pathogens in combination with at least one synthetic fungicide (i.e., tetraconazole, triflumizole, azoxystrobin, flutriafol, tebuconazole, chlorothalonil, or difenoconazole).

Active variants of the various bacterial strains provided herein include, for example, any isolate or mutant of AIP1620, AIP050999, and CGA267356.

In specific embodiments, the bacterial strain is applied in combination (simultaneously or sequentially) with at least one synthetic fungicide (which is a synthetic biocide) selected from the group consisting of tetraconazole, triflumizole, azoxystrobin, flutriafol, tebuconazole, chlorothalonil, and difenoconazole. A biocide is a chemical substance that can exert a controlling effect on an organism by chemical or biological means. Biocides include pesticides, such as fungicides; herbicides; insecticides, other crop protection chemicals, and the like. A bacterial strain (e.g., AIP1620, AIP050999, and CGA267356, or an active variant thereof) is compatible with a biocide when the bacterial strain is able to survive, germinate into a vegetative cell, and/or reproduce in the presence of an effective amount of a biocide of interest. In instances where the bacterial strain is not compatible for a biocide of interest, if desired, methods can be undertaken to modify the bacterial strain to impart the compatibility of interest. Such methods to produce modified bacterial strains include both selection techniques and/or transformation techniques. Methods and compositions disclosed herein can include a bacterial strain and at least one synthetic fungicide selected from the group consisting of tetraconazole, triflumizole, azoxystrobin, flutriafol, tebuconazole, chlorothalonil, and difenoconazole, along with another biocide to further increase plant health and/or control plant disease.

By “modified bacterial strain” is intended a population wherein the strain has been modified (by selection and/or transformation) to have one or more additional traits of interest. In some cases, the modified bacterial strain comprises any one of AIP1620, AIP050999, and CGA267356, or an active variant of any thereof. In specific embodiments, the modified bacterial strain is compatible with a biocide of interest, including but not limited to, resistance to a herbicide, fungicide, pesticide, or other crop protection chemical. The modified biocide-resistant strains have the same identification characteristics as the original sensitive strain except they are significantly more resistant to the particular herbicide, fungicide, pesticide, or other crop protection chemical. Their identification is readily possible by comparison with characteristics of the known sensitive strain. Thus, isolated populations of modified bacterial strains are provided.

An increase in resistance to a biocide (i.e., for example, a herbicide, fungicide, pesticide, or other crop protection chemical resistance) refers to the ability of an organism (i.e., bacterial cell or spore) to survive and reproduce following exposure to a dose of the biocide (e.g, herbicide, fungicide, pesticide, or other crop protection chemical) that would normally be lethal to the unmodified organism or would substantially reduce growth of the unmodified organism. In specific embodiments, the increase in resistance to a biocide is demonstrated in the presence of an agriculturally effective amount of the biocide, which is the amount needed to exert its intended effect (e.g., controlling weed(s), controlling pest(s), plant pathogen(s)).

In such instances, the modified bacterial strain having resistance to one or more biocides is useful for enhancing the competitiveness of bacterial strains particularly over other microbial agents which are not resistant to herbicides, fungicides, pesticides, or other crop protection chemicals. Therefore, compositions provided herein include selected or engineered bacterial strains and modified populations of bacterial strains. These bacterial strains or modified bacterial strains can be used as an inoculant for plants. They can also be applied as a spray application directly to the aerial parts of plants, and can be mixed with the herbicide or other chemical to which they have been modified to become tolerant.

Thus, active variants of the bacterial strains disclosed herein, include for example, a modified strain, such that the active variants act in combination with at least one synthetic fungicide selected from the group consisting of tetraconazole, triflumizole, azoxystrobin, flutriafol, tebuconazole, chlorothalonil, and difenoconazole to control a plant disease and further are able to grow in the presence of at least one biocide.

Recombinant bacterial strains having resistance to an herbicide, fungicide, pesticide, or other crop protection chemical can be made through genetic engineering techniques and such engineered or recombinant bacterial strains grown to produce a modified population of bacterial strains. A recombinant bacterial strain is produced by introducing polynucleotides into the bacterial host cell by transformation. Methods for transforming microorganisms are known and available in the art. See, generally, Hanahan, D. (1983) Studies on transformation of Escherichia coli with plasmids J. Mol. Biol. 166, 557-77; Seidman, C. E. (1994) In: Current Protocols in Molecular Biology, Ausubel, F. M. et al. eds., John Wiley and Sons, NY; Choi et al. (2006) J. Microbiol. Methods 64:391-397; Wang et al. 2010. J. Chem. Technol. Biotechnol. 85:775-778. Transformation may occur by natural uptake of naked DNA by competent cells from their environment in the laboratory. Alternatively, cells can be made competent by exposure to divalent cations under cold conditions, by electroporation, by exposure to polyethylene glycol, by treatment with fibrous nanoparticles, or other methods well known in the art.

Herbicide resistance genes for use in transforming a recombinant bacterial strain include, but are not limited to, fumonisin detoxification genes (U.S. Pat. No. 5,792,931); acetolactate synthase (ALS) mutants that lead to herbicide resistance, in particular the sulfonylurea-type herbicides, such as the S4 and/or Hra mutations; inhibitors of glutamine synthase such as phosphinothricin or basta (e.g., bar gene); and glyphosate resistance (EPSPS gene); gluphosinate, and HPPD resistance (WO 96/38576, U.S. Pat. Nos. 6,758,044; 7,250,561; 7,935,869; and 8,124,846), or other such genes known in the art. The disclosures of WO 96/38576, U.S. Pat. Nos. 5,792,931, 6,758,044; 7,250,561; 7,935,869; and 8,124,846 are herein incorporated by reference. The bar gene encodes resistance to the herbicide basta, the nptII gene encodes resistance to the antibiotics kanamycin and geneticin, and the ALS-gene mutants encode resistance to the sulfonylurea herbicides including chlorsulfuron, metsulfuron, sulfometuron, nicosulfuron, rimsulfuron, flazasulfuron, sulfosulfuron, and triasulfuron, and the imadizolinone herbicides including imazethapyr, imazaquin, imazapyr, and imazamethabenz.

To identify and produce a modified population of bacterial strains through selection, the bacterial strains are grown in the presence of the herbicide, fungicide, pesticide, or other crop protection chemical as the selection pressure. Susceptible agents are killed while resistant agents survive to reproduce without competition. As the bacterial strains are grown in the presence of the herbicide, fungicide, pesticide, or other crop protection chemical, resistant bacterial strains successfully reproduce and become dominant in the population, becoming a modified population of bacterial strains. Methods for selecting resistant strains are known and include U.S. Pat. Nos. 4,306,027 and 4,094,097, herein incorporated by reference. The active variant of the bacterial strain comprising a modified population of bacterial strains will have the same identification characteristics as the original sensitive strain except they are significantly more tolerant to the particular herbicide, fungicide, pesticide, or other crop protection chemical. Thus, their identification is readily possible by comparison with characteristics of the known sensitive strain.

Further active variants of the various bacteria provide herein can be identified employing, for example, methods that determine the sequence identity relatedness between the 16S ribosomal RNA, methods to identify groups of derived and functionally identical or nearly identical strains include Multi-locus sequence typing (MLST), concatenated shared genes trees, Whole Genome Alignment (WGA), Average Nucleotide Identity, and MinHash (Mash) distance metric.

In one aspect, the active variants of the bacterial strain(s) AIP1620, AIP050999, and CGA267356 include strains that are closely related to any of the disclosed strains by employing the Bishop MLST method of organism classification as defined in Bishop et al. (2009) BMC Biology 7(1)1741-7007-7-3. Thus, in specific embodiments, an active variant of a bacterial strain disclosed herein includes a bacterial strain that falls within at least a 80%, 85%, 86%, 87%, 88%, 89%, 90%, 91%, 92%, 93%. 94%, 95%, 96%, 97%, 98%, 98.5%, 98.8%, 99%, 99.1%, 99.2%, 99.3%, 99.4%, 99.5%, 99.6%, 99.7%, 99.8%, or 99.9% sequence cut off employing the Bishop method of organism classification as set forth in Bishop et al. (2009) BMC Biology 7(1)1741-7007-7-3, which is herein incorporated by reference in its entirety. Active variants of the bacteria identified by such methods will retain the ability to improve at least one agronomic trait when applied with at least one synthetic fungicide selected from the group consisting of tetraconazole, triflumizole, azoxystrobin, flutriafol, tebuconazole, chlorothalonil, and difenoconazole to a plant, plant part, or an area of cultivation, including for example, reducing plant disease severity and/or reducing plant disease development.

In another aspect, the active variant of the bacterial strain(s) disclosed herein include strains that are closely related to any of the disclosed strains on the basis of the Average Nucleotide Identity (ANI) method of organism classification. ANI (see, for example, Konstantinidis, K. T., et al., (2005) PNAS USA 102(7):2567-72; and Richter, M., et al., (2009) PNAS 106(45):19126-31) and variants (see, for example, Varghese, N.J., et al., Nucleic Acids Research (Jul. 6, 2015): gkv657) are based on summarizing the average nucleotides shared between the genomes of strains that align in WGAs. Thus, in specific embodiments, an active variant of bacterial strain AIP1620, AIP050999. and CGA267356 disclosed herein includes a bacterial stain that falls within at least a 90%, 95%, 96%, 97%, 97.5%, 98%, 98.5%, 98.8%, 99%, 99.5%, or 99.8% sequence cut off employing the ANI method of organism classification as set forth in Konstantinidis, K. T., et al., (2005) PNAS USA 102(7):2567-72, which is herein incorporated by reference in its entirety. Active variants of the bacteria identified by such methods will retain the ability to improve at least one agronomic trait when applied (simultaneously or sequentially) with at least one synthetic fungicide selected from the group consisting of tetraconazole, triflumizole, azoxystrobin, flutriafol, tebuconazole, chlorothalonil, and difenoconazole to a plant, plant part, or an area of cultivation, including for example, reducing plant disease severity and/or reducing plant disease development.

In another aspect, the active variants of the isolated bacterial strain(s) disclosed herein include strain(s) that are closely related to any of the above strains (for example, closely related to AIP1620, AIP050999, and CGA267356) on the basis of 16S rDNA sequence identity. See Stackebrandt E, et al., “Report of the ad hoc committee for the re-evaluation of the species definition in bacteriology,” Int J Syst Evol Microbiol. 52(3):1043-7 (2002) regarding use of 16S rDNA sequence identity for determining relatedness in bacteria. In an embodiment, the at least one strain is at least 95% identical to any of the above strains on the basis of 16S rDNA sequence identity, at least 96% identical to any of the above strains on the basis of 16S rDNA sequence identity, at least 97% identical to any of the above strains on the basis of 16S rDNA sequence identity, at least 98% to any of the above strains on the basis of 16S rDNA sequence identity, at least 98.5% identical to any of the above strains on the basis of 16S rDNA sequence identity, at least 99% identical to any of the above strains on the basis of 16S rDNA sequence identity, at least 99.5% to any of the above strains on the basis of 16S rDNA sequence identity or at least 100% to any of the above strains on the basis of 16S rDNA sequence identity. Active variants of the bacteria identified by such methods will retain the ability to improve at least one agronomic trait when applied (simultaneously or sequentially) with at least one synthetic fungicide selected from the group consisting of tetraconazole, triflumizole, azoxystrobin, flutriafol, tebuconazole, chlorothalonil, and difenoconazole in an effective amount to a plant, plant part, or an area of cultivation, including for example, reducing plant disease severity and/or reducing plant disease development.

The MinHash (Mash) distance metric is a comparison method that defines thresholds for hierarchical classification of microorganisms at high resolution and requires few parameters and steps (Ondov et al. (2016) Genome Biology 17:132). Mash distance strongly corresponds to Average Nucleotide Identity method (ANI) for hierarchical classification (See, Konstantinidis, K. T. et al. (2005) PNAS USA 102(7):2567-72, herein incorporated by reference in its entirety). That is, an ANI of 97% is approximately equal to a Mash distance of 0.03, such that values put forth as useful classification thresholds in the ANI literature can be directly applied with the Mash distance.

Active variants of the bacterial strain(s) disclosed herein include strains that are closely related to any of AIP1620, AIP050999, and CGA267356 on the basis of the Minhash (Mash) distance between complete genome DNA sequences. Thus, in specific embodiments, an active variant of a bacterial strain disclosed herein includes bacterial strains having a genome within a Mash distance of less than about 0.015 to the disclosed strains. In other embodiments, an active variant of a bacterial strain disclosed herein includes a distance metric of less than about 0.005, 0.010, 0.015, 0.020, 0.025, or 0.030. A genome, as it relates to the Mash distance includes both bacterial chromosomal DNA and bacterial plasmid DNA. In other embodiments, the active variant of a bacterial strain has a genome that is above a Mash distance threshold to the disclosed strains that is greater than dissimilarity caused by technical variance. In further instances, the active variant of a bacterial strain has a genome that is above a Mash distance threshold to the disclosed strains that is greater than dissimilarity caused by technical variance and has a Mash distance of less than about 0.015. In other instances, the active variant of a bacterial strain has a genome that is above a Mash distance threshold to the disclosed strains that is greater than dissimilarity caused by technical variance and has a Mash distance of less than about 0.005, 0.010, 0.015, 0.020, 0.025, or 0.030.

As used herein, “above technical variation” means above the Mash distance between two strains caused by errors in the genome assemblies provided the genomes being compared were each DNA sequenced with at least 20× coverage with the Illumina HiSeq 2500 DNA sequencing technology and the genomes are at least 99% complete with evidence for contamination of less than 2%. While 20× coverage is an art recognized term, for clarity, an example of 20× coverage is as follows: for a genome size of 5 megabases (MB), 100 MB of DNA sequencing from the given genome is required to have 20× sequencing coverage on average at each position along the genome. There are many suitable collections of marker genes to use for genome completeness calculations including the sets found in Campbell et al. (2013) PNAS USA 110(14):5540-45, Dupont et al. (2012) ISMEJ 6:1625-1628, and the CheckM framework (Parks et al. (2015) Genome Research 25:1043-1055); each of these references is herein incorporated in their entirety. Contamination is defined as the percentage of typically single copy marker genes that are found in multiple copies in the given genome sequence (e.g. Parks et al. (2015) Genome Research 25:1043-1055); each of these references is herein incorporated in their entirety. Completeness and contamination are calculated using the same collection of marker genes. Unless otherwise stated, the set of collection markers employed in the completeness and contamination assay is the set forth in Campbell et al. (2013) PNAS USA 110(14):5540-45, herein incorporated by reference.

Exemplary steps to obtain a distance estimate between the genomes in question are as follows: (1) Genomes of sufficient quality for comparison must be produced. A genome of sufficient quality is defined as a genome assembly created with enough DNA sequence to amount to at least 20× genome coverage using Illumina HiSeq 2500 technology. The genome must be at least 99% complete with contamination of less than 2% to be compared to the claimed microbe's genome. (2) Genomes are to be compared using the Minhash workflow as demonstrated in Ondov et al. (2016) Genome Biology 17:132, herein incorporated by reference in its entirety. Unless otherwise stated, parameters employed are as follows: “sketch” size of 1000, and “k-mer length” of 21. (3) Confirm that the Mash distance between the 2 genomes is less than 0.005, 0.010, 0.015, 0.020, 0.025, or 0.030. Active variants of the bacteria identified by such methods will retain the ability to improve at least one agronomic trait when applied with at least one synthetic fungicide selected from the group consisting of tetraconazole, triflumizole, azoxystrobin, flutriafol, tebuconazole, chlorothalonil, and difenoconazole in an effective amount to a plant, plant part, or an area of cultivation, including for example, reducing plant disease severity and/or reducing plant disease development.

### III. Formulations

The bacterial strains provided herein (i.e., AIP1620, AIP050999, and CGA267356, or active variant of any thereof) can be formulated as a cell paste, wettable powders, a cell pellet, dusts, granules, a slurry, a dry powder, a spray dried formulation, an agglomerated formulation, a fluidized bed agglomerated formulation, aqueous or oil based liquid products, and the like. Such formulations will comprise the bacteria provided herein or an active variant thereof in addition to carriers and other agents. In specific embodiments, the formulation will further comprise at least one synthetic fungicide selected from the group consisting of tetraconazole, triflumizole, azoxystrobin, flutriafol, tebuconazole, chlorothalonil, and difenoconazole and any carrier or other agent necessary to formulate the synthetic fungicide with the bacterial strains provided herein (i.e., AIP1620, AIP050999, and CGA267356). As noted elsewhere herein, the bacterial/synthetic chemistry formulation can comprise a co-pack, a blended formulation or a pre-mix formulation. The formulations can be used in a variety of methods as disclosed elsewhere herein.

The bacterial strains disclosed herein and the active variants thereof can be formulated to include at least one or more of an extender, a solvent, spontaneity promoters, carriers, emulsifiers, dispersants, frost protectants, thickeners, and/or adjuvants. Likewise, the synthetic fungicide (i.e., tetraconazole, triflumizole, azoxystrobin, flutriafol, tebuconazole, chlorothalonil, or difenoconazole) can be formulated to include at least one or more of an extender, a solvent, spontaneity promoters, carriers, emulsifiers, dispersants, frost protectants, thickeners, and/or adjuvants.

Examples of typical formulations include water-soluble liquids (SL), emulsifiable concentrates (EC), emulsions in water (EW), flowable liquid formulations (F; a formulation wherein the active ingredient is a solid that does not dissolve in either water or oil), cell pastes, dry flowable formulations, suspension concentrates (SC, SE, FS, OD), water-dispersible granules (WDG), granules (GR), spray dried formulation, wettable powders, agglomerated formulation, fluidized bed agglomeration formulation, and capsule concentrates (CS); WDG; GR; BB; SG; ZC these and other possible types of formulation are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations may comprise active agrochemical compounds other than one or more active compounds of the invention.

The formulations or application forms of the various bacterial strains or active variants thereof and/or synthetic fungicidal chemistries can comprise, but are not limited to, auxiliaries, such as extenders, solvents, spontaneity promoters, carriers, emulsifiers, dispersants, frost protectants, biocides, solid carriers, surfactants, thickeners and/or other auxiliaries, such as adjuvants. An adjuvant in this context is a component which enhances the biological effect of the formulation, without the component itself having a biological effect. Examples of adjuvants are agents which promote the retention, spreading, attachment to the leaf surface, or penetration.

Non-limiting extenders are, for example, water, polar and nonpolar organic chemical liquids, for example from the classes of the aromatic and non-aromatic hydrocarbons (such as paraffins, alkyl benzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide). If the extender used is water, it is also possible to employ, for example, organic solvents as auxiliary solvents. Essentially, non-limiting liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water. In principle it is possible to use any suitable solvent. Non-limiting solvents are, for example, aromatic hydrocarbons, such as xylene, toluene or alkylnaphthalenes, for example, chlorinated aromatic or aliphatic hydrocarbons, such as chlorobenzene, chloroethylene or methylene chloride, for example, aliphatic hydrocarbons, such as cyclohexane, for example, paraffins, petroleum fractions, mineral and vegetable oils, alcohols, such as methanol, ethanol, isopropanol, butanol or glycol, for example, and also their ethers and esters, ketones such as acetone, methyl ethyl ketone, methyl isobutyl ketone or cyclohexanone, for example, strongly polar solvents, such as dimethyl sulphoxide, and water.

Non-limiting examples of suitable carriers include, for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs, and tobacco stalks.

Liquefied gaseous extenders or solvents may also be used. Non-limiting examples are those extenders or carriers which at standard temperature and under standard pressure are gaseous, examples being aerosol propellants, such as halogenated hydrocarbons, and also butane, propane, nitrogen and carbon dioxide. Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkylta urates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum, and zinc.

Stabilizers, such as low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers such as carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipids. Further possible auxiliaries include mineral and vegetable oils.

There may possibly be further auxiliaries present in the formulations and the application forms derived from them. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, such as dioctyl sulphosuccinate, or increase the viscoelasticity, such as hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur et al., 1997, Pesticide Science 51: 131-152). Examples include alcohol alkoxylates such as coconut fatty ethoxylate (10) or isotridecyl ethoxylate (12), fatty acid esters such as rapeseed or soybean oil methyl esters, fatty amine alkoxylates such as tallowamine ethoxylate (15), or ammonium and/or phosphonium salts such as ammonium sulphate or diammonium hydrogen phosphate, for example.

The various compositions and formulations disclosed herein can comprise an amount of a bacterial strain, such as AIP1620, AIP050999, and CGA267356, or active variant of any thereof, or a combination of cells from any one of AIP1620, AIP050999, and CGA267356, or an active variant of any thereof. The bacterial strain can occur in any formulation type of interest, including, for example in a wettable powder, spray dried formulation, dry flowable formulation, agglomerated formulation, fluidized bed agglomerated formulation, or in a cell paste. In specific embodiments, the bacterial strain and the synthetic chemistry are formulated separately and packaged as a co-pack or a blend, while in other embodiments, the bacterial strain and the synthetic chemistry are formulated as a pre-mix formulation.

The various compositions and formulations disclosed herein comprise an amount of a bacterial strain, such as AIP1620, AIP050999, and CGA267356, or active variant of any thereof, and at least one synthetic fungicide at various active ingredient weight ratios. The phrase “active ingredient weight ratio” refers to the quantitative relation between the weights of each of two active ingredients within a composition. The active ingredients of the presently disclosed compositions are those that have the ability to improve at least one agronomic trait when applied in an effective amount to a plant, plant part, or an area of cultivation, including for example, reducing plant disease severity and/or reducing plant disease development. Specifically, the active ingredients of the presently disclosed compositions are at least one synthetic fungicide (i.e., tetraconazole, triflumizole, azoxystrobin, flutriafol, tebuconazole, chlorothalonil, or difenoconazole) and/or a bacterial strain, such as AIP1620, AIP050999, and CGA267356, or active variant of any thereof. When calculating the active ingredient weight ratio of a composition comprising a bacterial strain, such as AIP1620, AIP050999, and CGA267356, or active variant of any thereof, the total weight of the bacterial strain, regardless of viability or culturability, can be used to calculate the active ingredient weight ratio.

The active ingredient weight ratio can be measured using any method known in the art, including weighing the amount of a dry formulation comprising one or both of the active ingredients to obtain the formulation weight and then calculating the weight of each active ingredient based on the reported, known, or calculated percentage of the active ingredient to the total formulation weight (w/w). For example, 2 pounds of a dry formulation that is 50% w/w of the active ingredient chlorothalonil comprises 1 pound of chlorothalonil. Alternatively, if the composition is a liquid composition, the weight of each active ingredient can be calculated by measuring the total volume of the formulation and then calculating the weight of each active ingredient based on the reported, known, or calculated percentage of the active ingredient to the total formulation volume (w/v). Percent weight per volume is defined as the grams of solute in 100 ml of a solution. For example, 100 ml of a liquid composition that is 50% w/v of the active ingredient azoxystrobin comprises 50 g of azoxystrobin. One non-limiting method that can be used to measure the weight of a bacterial strain (cells, spores, etc.) or an active variant thereof in liquid culture includes pelleting the cells using, for example, a centrifuge, in order to remove any liquid and then weighing the pelleted cells. The effectiveness of a given bacterial cell weight can be expressed by measuring the culturability, viability or activity (e.g., measuring a reporter metabolite such as pyrrolnitrin), as discussed elsewhere herein. In certain embodiments, the culturability of a bacterial strain, such as AIP1620, AIP050999, and CGA267356, or active variant of any thereof, in a composition or formulation can be quantitated by measuring the number of colony forming units per gram or per ml of the formulation. In some embodiments, the composition or formulation comprises a concentration of the bacterial strain of at least about 10⁴ to about 10¹² CFU/gram, 10⁴ to about 10¹⁰ CFU/gram at least about 10⁵ CFU/gram to about 10¹¹ CFU/gram, about 10⁵ CFU/gram to about 10¹⁰ CFU/gram, about 10⁵ CFU/gram to about 10¹² CFU/gram, about 10⁵ CFU/gram to about 10⁶ CFU/gram, about 10⁶ CFU/gram to about 10⁷ CFU/gram, about 10⁷ CFU/gram to about 10⁸ CFU/gram, about 10⁸ CFU/gram to about 10⁹ CFU/gram, about 10⁹ CFU/gram to about 10¹⁰ CFU/gram, about 10¹⁰ CFU/gram to about 10¹¹ CFU/gram, or about 10¹¹ CFU/gram to about 10¹² CFU/gram. In other embodiments, the concentration of the bacterial strain comprises at least about 10⁴ CFU/gram, at least about 10⁵ CFU/gram, at least about 10⁶ CFU/gram, at least about 10⁷ CFU/gram, at least about 10⁸ CFU/gram, at least about 10⁹ CFU/gram, at least about 10¹⁰ CFU/gram, at least about 10¹¹ CFU/gram, or at least about 10¹² CFU/gram, or equivalent measure of bacterial concentration. In some embodiments, the composition or formulation comprises a concentration of the bacterial strain of at least about 10⁴ to about 10¹² CFU/mL, 10⁴ to about 10¹⁰ CFU/mL at least about 10⁵ CFU/mL to about 10¹¹ CFU/mL, about 10⁵ CFU/mL to about 10¹⁰ CFU/mL, about 10⁵ CFU/mL to about 10¹² CFU/mL, about 10⁵ CFU/mL to about 10⁶ CFU/mL, about 10⁶ CFU/mL to about 10⁷ CFU/mL, about 10⁷ CFU/mL to about 10⁸ CFU/mL, about 10⁸ CFU/mL to about 10⁹ CFU/mL, about 10⁹ CFU/mL to about 10¹⁰ CFU/mL, about 10¹⁰ CFU/mL to about 10¹¹ CFU/mL, or about 10¹¹ CFU/mL to about 10¹² CFU/mL. In other embodiments, the concentration of the bacterial strain comprises at least about 10⁴ CFU/mL, at least about 10⁵ CFU/mL, at least about 10⁶ CFU/mL, at least about 10⁷ CFU/mL, at least about 10⁸ CFU/mL, at least about 10⁹ CFU/mL, at least about 10¹⁰ CFU/mL, at least about 10¹¹ CFU/mL, or at least about 10¹² CFU/mL, or equivalent measure of bacterial concentration.

In other embodiments, the viability of a bacterial strain, such as AIP1620, AIP050999, and CGA267356, or active variant of any thereof, in a composition or formulation can be quantitated using an epifluorescence assay in which fluorescent dyes that are specific for cells with intact membranes or disrupted membranes are utilized, such as those assays that use a SYTO 9 nucleic acid stain that fluoresces green indicating a cell has an intact membrane and propidium iodide that fluoresces red indicating a cell with a disrupted membrane that is not viable (see, for example, LIVE/DEAD® BacLight™ Bacterial Viability and Counting Kit from Molecular Probes; and Ivanova et al. (2010) Biotechnology & Biotechnological Equipment 24:sup1, 567-570). It is known that following desiccation, some Pseudomonas strains enter a metabolically active state in which the cells are viable but not culturable (VBNC) (Pazos-Rojas et al. (2019) PLoS ONE 14(7):e0219554). Cells in a VBNC state retain the ability to be cultured if reconstituted, for example, in water or root exudates, when exposed to particular metals or ions, or any other reconstitution method that is specific for the individual VBNC bacterial strain.

In some embodiments, the composition or formulation comprises a concentration (e.g., as measured by viability) of the bacterial strain of at least about 10¹ cells/gram to about 10⁶ cells/gram, 10² cells/gram to about 10⁵ cells/gram, 10² cells/gram to about 10⁴ cells/gram, 10³ cells/gram to about 10⁶ cells/gram, 10⁴ cells/gram to about 10⁸ cells/gram, at least about 10⁵ cells/gram to about 10¹¹ cells/gram, about 10⁷ cells/gram to about 10¹⁰ cells/gram, about 10⁷ cells/gram to about 10¹¹ cells/gram, about 10⁶ cells/gram to about 10¹⁰ cells/gram, about 10⁶ cells/gram to about 10¹¹ cells/gram, about 10¹¹ cells/gram to about 10¹² cells/gram, about 10⁵ cells/gram to about 10¹⁰ cells/gram, about 10⁵ cells/gram to about 10¹² cells/gram, about 10⁵ cells/gram to about 10⁶ cells/gram, about 10⁶ cells/gram to about 10⁷ cells/gram, about 10⁷ cells/gram to about 10⁸ cells/gram, about 10⁸ cells/gram to about 10⁹ cells/gram, about 10⁹ cells/gram to about 10¹⁰ cells/gram, about 10¹⁰ cells/gram to about 10¹¹ cells/gram, or about 10¹¹ cells/gram to about 10¹² cells/gram. In some embodiments, the concentration of the bacterial strain comprises at least about 10² cells/gram, at least about 10³ cells/gram, at least about 10⁴ cells/gram, at least about 10⁵ cells/gram, at least about 10⁶ cells/gram, at least about 10⁷ cells/gram, at least about 10⁸ cells/gram, at least about 10⁹ cells/gram, at least about 10¹⁰ cells/gram, at least about 10¹¹ cells/gram, at least about 10¹² cells/gram, or at least about 10¹³ cells/gram of viable cells as measured with an epifluorescence assay.

In liquid compositions and formulations, the amount of bacterial strain, or active variant thereof, disclosed herein can comprise a concentration of at least about 10¹ cells/mL to about 10⁶ cells/mL, 10² cells/mL to about 10⁵ cells/mL, 10² cells/mL to about 10⁴ cells/mL, 10³ cells/mL to about 10⁶ cells/mL, 10⁴ cells/mL to about 10⁸ cells/mL, at least about 10³ to about 10⁹ cells/mL, at least about 10³ to about 10⁶ cells/mL, at least about 10⁴ to about 10¹¹ cells/mL, at least about 10⁵ cells/mL to about 10¹¹ cells/mL, about 10⁵ cells/mL to about 10¹⁰ cells/mL, about 10⁵ cells/mL to about 10¹² cells/mL, about 10⁵ cells/mL to about 10⁶ cells/mL, about 10⁶ cells/mL to about 10⁷ cells/mL, about 10⁷ cells/mL to about 10⁸ cells/mL, about 10⁸ cells/mL to about 10⁹ cells/mL, about 10⁹ cells/mL to about 10¹⁰ cells/mL, about 10¹⁰ cells/mL to about 10¹¹ cells/mL, or about 10¹¹ cells/mL to about 10¹² cells/mL or at least about 10³ cells/mL, at least about 10⁴ cells/mL, at least about 10⁵ cells/mL, at least about 10⁶ cells/mL, at least about 10⁷ cells/mL, at least about 10⁸ cells/mL, at least about 10⁹ cells/mL, at least about 10¹⁰ cells/mL, at least about 10¹¹ cells/mL, at least about 10¹² cells/mL of viable cells as measured with an epifluorescence assay.

In still other embodiments, the concentration of pyrrolnitrin within a composition or formulation comprising a bacterial strain, such as AIP1620, AIP050999, and CGA267356, or active variant of any thereof can be measured as a surrogate of the viability and/or antifungal activity of the bacterial strain in the composition or formulation. Pyrrolnitrin can be measured as a reporter metabolite for antifungal activity as it is co-regulated with other antifungal metabolites that are active in AIP1620, AIP050999, and CGA267356, or active variants of any thereof. The presence of pyrrolnitrin is a measure of intact cells and cell concentration within a composition or formulation. Pyrrolnitrin and other antifungal metabolites are retained within cells and not secreted, so measurement first requires cell lysis. Pyrrolnitrin can then be measured using any analytical chemistry method known in the art, including but not limited to, high performance liquid chromatography with ultraviolet detection (HPLC-UV) of a composition or formulation, such as that described in Hill et al. (1994) Appl Env Micro 60(1) 78-85, which is herein incorporated by reference in its entirety. In some embodiments, the presently disclosed compositions or formulations comprise between about 100 μg/g to 2000 μg/g, 200 μg/g to 1800 μg/g, 300 μg/g to 1500 μg/g, 300 μg/g to 1300 μg/g, 400 μg/g to 1500 μg/g, 400 μg/g to 1300 μg/g, 300 μg/g to 1000 μg/g, 400 μg/g to 1000 μg/g, 500 μg/g to 1000 μg/g, 500 μg/g to 1300 μg/g, 600 μg/g to 1000 μg/g, 600 μg/g to 1300 μg/g, 600 μg/g to 1500 μg/g, or about 300 μg/g, about 400 μg/g, about 500 μg/g, about 600 μg/g, about 700 μg/g, about 800 μg/g, about 900 μg/g, about 1000 μg/g, about 1100 μg/g, about 1200 μg/g, about 1300 μg/g, about 1400 μg/g, about 1500 μg/g, about 1500 μg/g, about 1600 μg/g, about 1700 μg/g, about 1800 μg/g, about 1900 μg/g, and about 2000 μg/g expressed as μg of pyrrolnitrin per g of bacteria.

The bacterial strain and at least one synthetic fungicide selected from the group consisting of tetraconazole, triflumizole, azoxystrobin, flutriafol, tebuconazole, chlorothalonil, and difenoconazole in the formulations can be mixed or applied (simultaneously or sequentially) in an active ingredient weight ratio that results in at least an additive effect when applied to a plant, plant part, or area of plant cultivation. For example, the bacterial strain, or active variant thereof, can be combined with tetraconazole or flutriafol in an active ingredient weight ratio (lb/lb) of about 1:10 (bacterial strain:synthetic fungicide) to about 1000:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 300:1, about 400:1, about 500:1, about 600:1, about 700:1, about 800:1, about 900:1 or about 1000:1.

In particular embodiments, the bacterial strain, or active variant thereof, can be combined (in a formulation or applied in combination, simultaneously or sequentially) with tetraconazole or flutriafol in an active ingredient weight ratio (lb/lb) of about 1:1 (bacterial strain:synthetic fungicide) to about 100:1, including but not limited to about 1:1, about 2:1, about 5:1, about 10:1, about 15:1, about 20:1, about 25:1, about 30:1, about 35:1, about 40:1, about 45:1, about 50:1, about 55:1, about 60:1, about 61:1, about 62:1, about 62.5:1, about 63:1, about 64:1, about 65:1, about 66:1, about 67:1, about 68:1, about 69:1, about 70:1, about 75:1, about 80:1, about 85:1, about 90:1, about 95:1, and about 100:1.

In other embodiments, the bacterial strain, or active variant thereof, can be combined (in a formulation or applied in combination, simultaneously or sequentially) with azoxystrobin, tebuconazole, or difenoconazole in an active ingredient weight ratio (lb/lb) of about 1:10 (bacterial strain:synthetic fungicide) to about 500:1, about 1:5 to about 100:1, about 1:5 to about 75:1, about 1:5 to about 50:1, about 1:5 to about 20:1, about 1:1 to about 100:1, about 1:1 to about 75:1, about 1:1 to about 50:1, about 1:1 to about 20:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 250:1, about 300:1, about 350:1, about 400:1, about 450:1, or about 500:1.

In particular embodiments, the bacterial strain, or active variant thereof, can be combined (in a formulation or applied in combination, simultaneously or sequentially) with azoxystrobin in an active ingredient weight ratio (lb/lb) of about 1:1 (bacterial strain:synthetic fungicide) to about 25:1 or about 1:1 to about 20:1 combined (in a formulation or applied in combination, simultaneously or sequentially) with tebuconazole in an active ingredient weight ratio (lb/lb) of about 1:1 (bacterial strain:synthetic fungicide) to about 50:1, including but not limited to about 1:1, about 3:1, about 5:1, about 7:1, about 9:1, about 11:1, about 13:1, about 15:1, about 17:1, about 17.5:1, about 18:1, about 18.5:1, about 19:1, about 19.5:1, about 20:1, about 16:1, about 17:1, about 18:1, about 19:1, about 19.1:1, about 19.2:1, about 19.3:1, about 19.4:1, about 19.5:1, about 19.6:1, about 19.7:1, about 19.8:1, about 19.9:1, about 20:1, about 20.25:1, about 20.5:1, about 20.75:1, about 21:1, about 21.25:1, about 21.5:1, about 21.75:1, about 22:1, about 22.2:1, about 22.22:1, about 22.25:1, about 22.5:1, about 22.75:1, about 23:1, about 23.25:1, about 23.5:1, about 23.75:1, about 24:1, about 24.25:1, about 24.5:1, about 24.75:1, about 25:1, about 25.5:1, about 26:1, about 26.5:1, about 27:1, about 27.5:1, about 28:1, about 29:1, about 30:1, about 32:1, about 34:1, about 36:1, about 38:1, about 40:1, about 45:1, and about 50:1.

In certain embodiments, the bacterial strain, or active variant thereof, can be combined (in a formulation or applied in combination, simultaneously or sequentially) with difenoconazole in an active ingredient weight ratio (lb/lb) of about 1:1 (bacterial strain:synthetic fungicide) to about 50:1, about 1:1 to about 40:1, about 10:1 to about 40:1, or about 10:1 to about 30:1, including but not limited to, about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1, about 31:1, about 32:1, about 33:1, about 34:1, about 35.1:1, about 36:1, about 37:1, about 38:1, about 39:1, about 40:1, about 41:1, about 42:1, about 43:1, about 44:1, about 45:1, about 46:1, about 47:1, about 48:1, about 49:1, and about 50:1.

In other embodiments, the bacterial strain, or active variant thereof, can be combined (in a formulation or applied in combination, simultaneously or sequentially) with chlorothalonil in an active ingredient weight ratio (lb/lb) of about 1:100 and about 500:1, including but not limited to about 1:100, about 1:50, about 1:10, about 1:1, about 10:1, about 50:1, about 100:1, about 150:1, about 200:1, about 250:1, about 300:1, about 350:1, about 400:1, about 450:1, and about 500:1.

In certain embodiments, the bacterial strain, or active variant thereof, can be combined (in a formulation or applied in combination, simultaneously or sequentially) with chlorothalonil in an active ingredient weight ratio (lb/lb) of about 1:10 (bacterial strain:synthetic fungicide) to about 10:1, including but not limited to, about 1:10, about 1:9, about 1:8, about 1:7, about 1:6, about 1:5, about 1:4, about 1:3, about 1:2, about 1:1.9, about 1:1.8, about 1:1.75, about 1:1.7, about 1:1.65, about 1:1.6, about 1:1.55, about 1:1.5, about 1:1.45, about 1:4, about 1:1.35, about 1:1.3, about 1:1.275, about 1:1.25, about 1:1.24, about 1:1.23, about 1:1.22, about 1:1.21, about 1:1.2, about 1:1.19, about 1:1.18, about 1:1.17, about 1:1.16, about 1:1.15, about 1:1.15, about 1:1.1, about 1:1, about 1.1:1, about 1.2:1, about 1.3:1, about 1.4:1, about 1.5:1, about 1.6:1, about 1.7:1, about 1.8:1, about 1.9:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, and about 10:1.

In other embodiments, the bacterial strain, or active variant thereof, can be combined with (in a formulation or applied in combination, simultaneously or sequentially) triflumizole in an active ingredient weight ratio (lb/lb) of about 1:10 (bacterial strain: triflumizole) to about 100:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, or about 100:1.

In particular embodiments, the bacterial strain, or active variant thereof, can be combined with (in a formulation or applied in combination, simultaneously or sequentially) with triflumizole in an active ingredient weight ratio (lb/lb) of about 1:10 (bacterial strain: triflumizole) to about 25:1 or about 1:10 to about 20:1, including but not limited to about 1:10, about 1:9, about 1:8, about 1:7, about 1:6, about 1:5, about 1:4, about 1:3, about 1:2, about 1:1, about 1.1:1, about 1.2:1, about 1.3:1, about 1.4:1, about 1.5:1, about 1.6:1, about 1.61:1, about 1.62:1, about 1.63:1, about 1.64:1, about 1.65:1, about 1.66:1, about 1.67:1, about 1.68:1, about 1.69:1, about 1.7:1, about 1.8:1, about 1.9:1, about 2:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, about 10:1, about 15:1, about 20:1, and about 25:1. In particular embodiments, the formulations are in the form of a pre-mixture of the bacterial strain(s) and at least one synthetic fungicide selected from the group consisting of tetraconazole, triflumizole, azoxystrobin, flutriafol, tebuconazole, chlorothalonil, and difenoconazole, each supplied as a WDG. The bacterial strain and synthetic chemistry (i.e., tetraconazole, triflumizole, azoxystrobin, flutriafol, tebuconazole, chlorothalonil, or difenoconazole) in the form of WDG can be mixed in any weight ratio that results in at least an additive effect when applied to a plant, plant part, or area of plant cultivation.

For example, the bacterial strain, or active variant thereof, can be combined with tetraconazole or flutriafol in an active ingredient weight ratio (lb/lb) of about 1:10 (bacterial strain:synthetic fungicide) to about 1000:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 300:1, about 400:1, about 500:1, about 600:1, about 700:1, about 800:1, about 900:1 or about 1000:1 as WDG in a single composition.

In particular embodiments, the bacterial strain, or active variant thereof, can be combined with tetraconazole or flutriafol in an active ingredient weight ratio (lb/lb) of about 1:1 (bacterial strain:synthetic fungicide) to about 100:1, including but not limited to about 1:1, about 2:1, about 5:1, about 10:1, about 15:1, about 20:1, about 25:1, about 30:1, about 35:1, about 40:1, about 45:1, about 50:1, about 55:1, about 60:1, about 61:1, about 62:1, about 62.5:1, about 63:1, about 64:1, about 65:1, about 66:1, about 67:1, about 68:1, about 69:1, about 70:1, about 75:1, about 80:1, about 85:1, about 90:1, about 95:1, and about 100:1 as WDG in a single composition.

In other embodiments, the bacterial strain, or active variant thereof, can be combined with azoxystrobin, tebuconazole, or difenoconazole in an active ingredient weight ratio (lb/lb) of about 1:10 (bacterial strain:synthetic fungicide) to about 500:1, about 1:5 to about 100:1, about 1:5 to about 75:1, about 1:5 to about 50:1, about 1:5 to about 20:1, about 1:1 to about 100:1, about 1:1 to about 75:1, about 1:1 to about 50:1, or about 1:1 to about 20:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 250:1, about 300:1, about 350:1, about 400:1, about 450:1, or about 500:1 as WDG in a single composition.

In particular embodiments, the bacterial strain, or active variant thereof, can be combined with azoxystrobin in an active ingredient weight ratio (lb/lb) of about 1:1 (bacterial strain:synthetic fungicide) to about 25:1 or about 1:10 to about 20:1, including but not limited to about 1:1, about 1.5:1, about 2:1, about 2.5:1, about 3:1, about 3.5:1, about 4:1, about 4.5:1, about 5:1, about 5.5:1, about 6:1, about 6.1:1, about 6.2:1, about 6.3:1, about 6.4:1, about 6.5:1, about 6.6:1, about 6.7:1, about 6.8:1, about 6.9:1, about 7:1, about 7.1:1, about 7.2:1, about 7.3:1, about 7.4:1, about 7.5:1, about 7.6:1, about 7.7:1, about 7.8:1, about 7.9:1, about 8:1, about 8.5:1, about 9:1, about 9.5:1, about 10:1, about 10.25:1, about 10.4:1, about 10.5:1, about 10.75:1, about 11:1, about 11.5:1, about 12:1, about 12.5:1, about 13:1, about 13.5:1, about 14:1, about 14.5:1, about 15:1, about 16:1, about 17:1, about 18:1, about 19:1, about 20:1, about 21:1, about 22:1, about 23:1, about 24:1, and about 25:1 as WDG in a single composition.

In particular embodiments, the bacterial strain, or active variant thereof, can be combined with tebuconazole in an active ingredient weight ratio (lb/lb) of about 1:1 (bacterial strain:synthetic fungicide) to about 50:1, including but not limited to about 1:1, about 3:1, about 5:1, about 7:1, about 9:1, about 11:1, about 13:1, about 15:1, about 17:1, about 17.5:1, about 18:1, about 18.5:1, about 19:1, about 19.5:1, about 20:1, about 16:1, about 17:1, about 18:1, about 19:1, about 19.1:1, about 19.2:1, about 19.3:1, about 19.4:1, about 19.5:1, about 19.6:1, about 19.7:1, about 19.8:1, about 19.9:1, about 20:1, about 20.25:1, about 20.5:1, about 20.75:1, about 21:1, about 21.25:1, about 21.5:1, about 21.75:1, about 22:1, about 22.2:1, about 22.22:1, about 22.25:1, about 22.5:1, about 22.75:1, about 23:1, about 23.25:1, about 23.5:1, about 23.75:1, about 24:1, about 24.25:1, about 24.5:1, about 24.75:1, about 25:1, about 25.5:1, about 26:1, about 26.5:1, about 27:1, about 27.5:1, about 28:1, about 29:1, about 30:1, about 32:1, about 34:1, about 36:1, about 38:1, about 40:1, about 45:1, and about 50:1 as WDG in a single composition.

In certain embodiments, the bacterial strain, or active variant thereof, can be combined with difenoconazole in an active ingredient weight ratio (lb/lb) of about 1:1 (bacterial strain:synthetic fungicide) to about 50:1, about 1:1 to about 40:1, about 10:1 to about 40:1, or about 10:1 to about 30:1, including but not limited to, about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1, about 31:1, about 32:1, about 33:1, about 34:1, about 35.1:1, about 36:1, about 37:1, about 38:1, about 39:1, about 40:1, about 41:1, about 42:1, about 43:1, about 44:1, about 45:1, about 46:1, about 47:1, about 48:1, about 49:1, and about 50:1 as WDG in a single composition.

In other embodiments, the bacterial strain, or active variant thereof, can be combined with chlorothalonil in an active ingredient weight ratio (lb/lb) of about 1:100 to about 500:1, including but not limited to, about 1:100, about 1:50, about 1:10, about 1:1, about 10:1, about 50:1, about 100:1, about 150:1, about 200:1, about 250:1, about 300:1, about 350:1, about 400:1, about 450:1, and about 500:1 as WDG in a single composition.

In certain embodiments, the bacterial strain, or active variant thereof, can be combined with chlorothalonil in an active ingredient weight ratio (lb/lb) of about 1:10 (bacterial strain:synthetic fungicide) to about 10:1, including but not limited to, about 1:10, about 1:9, about 1:8, about 1:7, about 1:6, about 1:5, about 1:4, about 1:3, about 1:2, about 1:1.9, about 1:1.8, about 1:1.75, about 1:1.7, about 1:1.65, about 1:1.6, about 1:1.55, about 1:1.5, about 1:1.45, about 1:4, about 1:1.35, about 1:1.3, about 1:1.275, about 1:1.25, about 1:1.24, about 1:1.23, about 1:1.22, about 1:1.21, about 1:1.2, about 1:1.19, about 1:1.18, about 1:1.17, about 1:1.16, about 1:1.15, about 1:1.15, about 1:1.1, about 1:1, about 1.1:1, about 1.2:1, about 1.3:1, about 1.4:1, about 1.5:1, about 1.6:1, about 1.7:1, about 1.8:1, about 1.9:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, and about 10:1 as WDG in a single composition.

In other embodiments, the bacterial strain, or active variant thereof, can be combined with triflumizole in an active ingredient weight ratio (lb/lb) of about 1:10 (bacterial strain: triflumizole) to about 100:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, or about 100:1 as WDG in a single composition.

In other embodiments, the bacterial strain, or active variant thereof, can be combined with triflumizole in an active ingredient weight ratio (lb/lb) of about 1:10 (bacterial strain: triflumizole) to about 25:1 or about 1:10 to about 20:1, including but not limited to about 1:10, about 1:9, about 1:8, about 1:7, about 1:6, about 1:5, about 1:4, about 1:3, about 1:2, about 1:1, about 1.1:1, about 1.2:1, about 1.3:1, about 1.4:1, about 1.5:1, about 1.6:1, about 1.66:1, about 1.7:1, about 1.8:1, about 1.9:1, about 2:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, about 10:1, about 15:1, about 20:1, and about 25:1 as WDG in a single composition.

Water-soluble liquids, emulsifiable concentrates, emulsions in water, flowable liquid formulations, dry flowable formulations, suspension concentrates (SC, SE, FS, OD), water-dispersible granules, granules, wettable powders, spray dried formulation, agglomerated formulation, fluidized bed agglomeration formulation, cell pastes, and capsule concentrates can comprise a bacterial strain, such as AIP1620, AIP050999, and CGA267356, or active variant of any thereof. The amount of the bacterial strain can comprise a concentration of the bacterial strain of at least about 10⁴ to about 10¹³ CFU/gram, at least about 10⁵ CFU/gram to about 10¹¹ CFU/gram, about 10⁷ CFU/gram to about 10¹⁰ CFU/gram, about 10⁷ CFU/gram to about 10¹¹ CFU/gram, about 10⁶ CFU/gram to about 10¹⁰ CFU/gram, about 10⁶ CFU/gram to about 10¹¹ CFU/gram, about 10¹¹ CFU/gram to about 10¹² CFU/gram, about 10⁵ CFU/gram to about 10¹⁰ CFU/gram, about 10⁵ CFU/gram to about 10¹² CFU/gram, about 10⁵ CFU/gram to about 10⁶ CFU/gram, about 10⁶ CFU/gram to about 10⁷ CFU/gram, about 10⁷ CFU/gram to about 10⁸ CFU/gram, about 10⁸ CFU/gram to about 10⁹ CFU/gram, about 10⁹ CFU/gram to about 10¹⁰ CFU/gram, about 10¹⁰ CFU/gram to about 10¹¹ CFU/gram, or about 10¹¹ CFU/gram to about 10¹² CFU/gram. In some embodiments, the concentration of the bacterial strain comprises at least about 10⁵ CFU/gram, at least about 10⁶ CFU/gram, at least about 10⁷ CFU/gram, at least about 10⁸ CFU/gram, at least about 10⁹ CFU/gram, at least about 10¹⁰ CFU/gram, at least about 10¹¹ CFU/gram, at least about 10¹² CFU/gram, or at least about 10¹³ CFU/gram. As used herein, a “cell paste” comprises a population of cells that has been centrifuged and/or filtered or otherwise concentrated.

Further provided is a coated seed which comprises a seed and a coating on the seed. The coating comprises a combination of at least one synthetic fungicide selected from the group consisting of tetraconazole, triflumizole, azoxystrobin, flutriafol, tebuconazole, chlorothalonil, and difenoconazole and at least one bacterial strain, such as AIP1620, AIP050999, and CGA267356, or active variant of any thereof. The coating can comprise the combination of synthetic fungicide and bacterial strain in any weight ratio disclosed herein, wherein the combination comprises at least about 400 μg pyrrolnitrin per gram of bacterial cells. The seed coating can be applied to any seed of interest (i.e., for a monocot or a dicot). Various plants of interest are disclosed elsewhere herein.

A seed coating can further comprise at least at least one nutrient, at least one herbicide or at least one pesticide, or at least one biocide. See, for example, US App Pub. 20040336049, 20140173979, and 20150033811. In specific embodiments, the seed coating can comprise a bacterial strain, such as AIP1620, AIP050999, and CGA267356, or active variant of any thereof, along with at least one synthetic fungicide selected from the group consisting of tetraconazole, triflumizole, azoxystrobin, flutriafol, tebuconazole, chlorothalonil, and difenoconazole. In other embodiments, at least one synthetic fungicide selected from the group consisting of tetraconazole, triflumizole, azoxystrobin, flutriafol, tebuconazole, chlorothalonil, and difenoconazole can be provided in the cultivation area of the planted seed having a seed coat comprising a bacterial strain described herein.

The various compositions and formulations disclosed herein can comprise an amount of a bacterial strain, such as AIP1620, AIP050999, and CGA267356, or active variant of any thereof, along with an amount of at least one synthetic fungicide selected from the group consisting of tetraconazole, triflumizole, azoxystrobin, flutriafol, tebuconazole, chlorothalonil, and difenoconazole. The bacterial strain can be mixed with the synthetic fungicide in any amount that results in an improvement in plant health or control of a plant disease or plant pathogen, and/or improvement of an agronomic trait of interest in a plant. In particular embodiments, the bacterial strain is mixed with the synthetic fungicide (i.e., tetraconazole, triflumizole, azoxystrobin, flutriafol, tebuconazole, chlorothalonil, or difenoconazole) in an amount that results in at least an additive improvement in plant health or control of a plant disease or plant pathogen, and/or improvement of an agronomic trait of interest in a plant. In still other embodiments, the bacterial strain is mixed with the synthetic fungicide (i.e., tetraconazole, triflumizole, azoxystrobin, flutriafol, tebuconazole, chlorothalonil, or difenoconazole) in an amount that results in a synergistic improvement in plant health or control of a plant disease or plant pathogen, and/or improvement of an agronomic trait of interest in a plant.

In specific embodiments, the compositions and formulations disclosed herein include a bacterial strain and/or at least one synthetic fungicide selected from the group consisting of tetraconazole, triflumizole, azoxystrobin, flutriafol, tebuconazole, chlorothalonil, and difenoconazole that comprises less than the suggested amount of the bacterial strain and/or the synthetic fungicide selected from the group consisting of tetraconazole, triflumizole, azoxystrobin, flutriafol, tebuconazole, chlorothalonil, and difenoconazole when applied alone. The term “suggested amount,” “standard amount,” “suggested rate,” or “standard rate” in reference to a synthetic fungicide or bacteria refers to an amount or rate that is the amount or rate that effectively controls a plant pathogen, treats or prevents a plant disease, or improves an agronomic trait of interest in a plant when used alone (i.e., not in conjunction with an additional fungicide). The suggested or standard amount or rate can be the amount or rate approved for use by an applicable government agency or the amount or rate suggested by the manufacturer or listed on the label of a commercial product comprising the synthetic fungicide or bacteria. The suggested amount can differ based on the particular plant pathogen being targeted or plant disease being treated or prevented or the particular agronomic trait of interest that is desired to be improved or the particular plant that the bacteria and synthetic fungicide is being applied thereto, the particular type of application (e.g., foliar, field inoculation), or the like. For example, the compositions and formulations comprising at least one synthetic fungicide can comprise a bacterial strain for application at about 20%, 25%, 30%, 35%, 40%, 45%, 50%, 55%, 60%, 65%, 70%, 75%, 80%, 85%, 90%, 95%, or about 20-70%, about 30-60%, about 30-70%, about 40-80%, about 40-70%, about 40-60%, about 40-50%, about 50-90%, about 50-80%, about 50-70%, about 50-60%, about 60-90%, about 60-80%, about 60-70%, about 70-90%, about 70-90%, or about 80-90% of the suggested amount for application when used alone (i.e., not in conjunction with an additional fungicide). The suggested amount for application of the bacterial strain can be about 1 lb/acre, about 1.25 lb/acre, about 1.5 lb/acre, about 1.75 lb/acre, about 2 lb/acre, about 2.25 lb/acre, about 2.5 lb/acre, about 2.75 lb/acre, about 3 lb/acre, about 3.5 lb/acre, about 4 lb/acre, about 5 lb/acre, about 6 lb/acre, about 7 lb/acre, about 8 lb/acre, about 1-10 lb/acre, or about 1-8 lb/acre. A formulated product comprising AIP1620 may have 50% AIP1620 by weight or be provided in any weight ratio relative to the selected synthetic fungicide disclosed elsewhere herein. The application rate of the synthetic fungicide disclosed herein can be calculated based on the rate of the bacterial strain, or active variant thereof, according to the selected active ingredient weight ratio as disclosed elsewhere herein for each selected synthetic fungicide. Application of 5 lbs/acre of the 50% formulated product comprises 2.5 lbs/acre of the bacterial strain AIP1620.

The compositions and formulation comprising a bacterial strain can comprise at least one synthetic fungicide selected from the group consisting of tetraconazole, triflumizole, azoxystrobin, flutriafol, tebuconazole, chlorothalonil, and difenoconazole at about 20%, 25%, 30%, 35%, 40%, 45%, 50%, 55%, 60%, 65%, 70%, 75%, 80%, 85%, 90%, 95%, or about 20-70%, about 30-60%, about 30-70%, about 40-80%, about 40-70%, about 40-60%, about 40-50%, about 50-90%, about 50-80%, about 50-70%, about 50-60%, about 60-90%, about 60-80%, about 60-70%, about 70-90%, about 70-90%, or about 80-90% of the suggested amount for application when used alone.

In specific embodiments the standard use of bacterial strain AIP1620 is 5 lb/acre of a 50% formulation, wherein the combination comprises at least about 400 μg pyrrolnitrin per gram of bacterial cells.

The bacterial strain, or active fragment thereof, and the synthetic chemistry (i.e., tetraconazole, triflumizole, azoxystrobin, flutriafol, tebuconazole, chlorothalonil, or difenoconazole) can be formulated together in the same composition or formulated separately for mixing in a tank for application to a plant, plant part, or cultivation area of a plant. In particular embodiments, formulations for mixing in a tank for application are formulated for dilution 1:1 with water.

The various formulations disclosed herein can be stable for at least 30, 40, 50, 60, 70, 80, 90, 100, 125, 150, 200, 225, 250, 275, 300, 325, 350 days, 1.5 years, 2 years or longer. By stable is intended that the formulation retains viable bacteria and/or retains an effective amount of a biologically active bacteria. In one embodiment, the stable formulation retains at least about 1%, about 10%, about 20%, about 30% about 40%, about 50%, about 60%, about 70%, about 80%, or about 90% of the viability or culturability in the formulation at a given storage time point when compared to the viability or culturability produced after immediate preparation of the formulation. In another embodiment, the stable formulation retains at least about 30% to 80%, about 50% to about 80%, about 60% to about 70%, about 70% to about 80%, about 40% to about 50%, about 50% to about 60%, about 60% to about 70% of biological activity (e.g., antifungal activity as calculated using a reporter metabolite such as pyrrolnitrin) in the formulation at a given storage time point when compared to the biological activity found in the formulation immediately after production. In another embodiment, the stable formulation at a given storage time point retains at least about 30%, 45%, 50%, 60%, 70%, 80%, 90% of biological activity when compared to the biological activity found in the formulation immediately after production. In still another embodiment, the stable formation retains any combination of the viability and biological activity noted above.

The formulations preferably comprise between 0.00000001% and 98% by weight of each active compound or, with particular preference, between 0.01% and 95% by weight of each active compound, more preferably between 0.5% and 90% by weight of each active compound, based on the weight of the formulation.

The active compounds content of the application forms prepared from the formulations may vary within wide ranges. The active compounds concentration of the application forms may be situated typically between 0.00000001% and 95% by weight of each active compound, preferably between 0.00001% and 1% by weight, based on the weight of the application form. Application takes place in a customary manner adapted to the application forms.

Moreover, the bacterial strain provided herein or an active variant thereof can be mixed or applied with a biocide in addition to at least one synthetic fungicide selected from the group consisting of tetraconazole, triflumizole, azoxystrobin, flutriafol, tebuconazole, chlorothalonil, and difenoconazole, such as a fungicide, insecticide, or herbicide to enhance its activity or the activity of the chemical to which it has been added.

In some cases, the combination (simultaneous or sequential application to a plant or an area of cultivation) of the bacterial strain and synthetic fungicide may exhibit an additive effect on controlling a plant pathogen or treating or preventing a plant disease or improving an agronomic trait of interest. In other embodiments, the combination of the bacterial strain and synthetic fungicide may show synergistic activity where the mixture of the two exceeds that expected from their simple additive effect. In particular embodiments, the simultaneous or sequential application of the bacterial strain and synthetic fungicide to a plant or an area of cultivation results in the controlling of a plant pathogen or treatment or prevention of a plant disease or an improvement of an agronomic trait of interest wherein no such effect results when either the bacterial strain or synthetic fungicide are used alone.

In specific embodiments, the bacterial strain or active variant thereof is compatible with agricultural chemicals used to improve performance of biocides. Such agricultural chemicals include safeners, surfactants, stickers, spreaders, UV protectants, and suspension and dispersal aids. Safeners are chemicals that improve or modify the performance of herbicides. Surfactants, spreaders, and stickers are chemicals included in agricultural spray preparations that change the mechanical properties of the spray (for example, by altering surface tension or improving leaf cuticle penetration). UV protectants improve the performance of agricultural biocides by reducing degradation by ultraviolet light. Suspension and dispersal aids improve the performance of biocides by altering their behavior in a spray tank. In instances where the bacterial strain or active variant is not compatible with an agricultural chemical of interest, if desired, methods can be undertaken to modify the bacterial strain to impart the compatibility of interest. Such methods to produce modified bacterial strains include both selection techniques and/or transformation techniques.

The combination of at least one synthetic fungicide selected from the group consisting of tetraconazole, triflumizole, azoxystrobin, flutriafol, tebuconazole, chlorothalonil, and difenoconazole and a bacterial strain, or active variant thereof, provided herein can be used to improve at least one agronomic trait of interest (e.g., reduce disease such as ASR or another fungal or fungal-like pathogen of interest). The compositions and formulations including at least one synthetic fungicide selected from the group consisting of tetraconazole, triflumizole, azoxystrobin, flutriafol, tebuconazole, chlorothalonil, and difenoconazole and a bacterial strain, or active variant thereof, provided herein can be used with other pesticides for an effective integrated pest management program. In one embodiment, the biocontrol populations can be mixed with known pesticides in a manner described in WO 94/10845, herein incorporated by reference.

Non-limiting examples of compounds and compositions that can be added to the formulation, include but are not limited to, Acetyl tributyl citrate [Citric acid, 2-(acetyloxy)-, tributyl ester]; Agar; Almond hulls; Almond shells; alpha-Cyclodextrin; Aluminatesilicate; Aluminum magnesium silicate [Silicic acid, aluminum magnesium salt]; Aluminum potassium sodium silicate [Silicic acid, aluminum potassium sodium salt]; Aluminum silicate; Aluminum sodium silicate [Silicic acid, aluminum sodium salt]; Aluminum sodium silicate (1:1:1)[Silicic acid (H4SiO4), aluminum sodium salt (1:1:1)]; Ammonium benzoate [Benzoic acid, ammonium salt]; Ammonium stearate [Octadecanoic acid, ammonium salt]; Amylopectin, acid-hydrolyzed, 1-octenylbutanedioate; Amylopectin, hydrogen 1-octadecenylbutanedioate; Animal glue; Ascorbyl palmitate; Attapulgite-type clay; Beeswax; Bentonite; Bentonite, sodian; beta-Cyclodextrin; Bone meal; Bran; Bread crumbs; (+)-Butyl lactate; [Lactic acid, n-butyl ester, (S)]; Butyl lactate [Lactic acid, n-butyl ester]; Butyl stearate [Octadecanoic acid, butyl ester]; Calcareous shale; Calcite (Ca(Co₃)); Calcium acetate; Calcium acetate monohydrate [Acetic acid, calcium salt, monohydrate]; Calcium benzoate [Benzoic acid, calcium salt]; Calcium carbonate; Calcium citrate [Citric acid, calcium salt]; Calcium octanoate; Calcium oxide silicate (Ca₃O(SiO₄)); Calcium silicate [Silicic acid, calcium salt]; Calcium stearate [Octadecanoic acid, calcium salt]; Calcium sulfate; Calcium sulfate dehydrate; Calcium sulfate hemihydrate; Canary seed; Carbon; Carbon dioxide; Carboxymethyl cellulose [Cellulose, carboxymethyl ether]; Cardboard; Carnauba wax; Carob gum [Locust bean gum]; Carrageenan; Caseins; Castor oil; Castor oil, hydrogenated; Cat food; Cellulose; Cellulose acetate; Cellulose, mixture with cellulose carboxymethyl ether, sodium salt; Cellulose, pulp; Cellulose, regenerated; Cheese; Chlorophyll a; Chlorophyll b; Citrus meal; Citric acid; Citric acid, monohydrate; Citrus pectin; Citrus pulp; Clam shells; Cocoa; Cocoa shell flour; Cocoa shells; Cod-liver oil; Coffee grounds; Cookies; Cork; Corn cobs; Cotton; Cottonseed meal; Cracked wheat; Decanoic acid, monoester with 1,2,3-propanetriol; Dextrins; Diglyceryl monooleate [9-Octadecenoic acid, ester with 1,2,3-propanetriol]; Diglyceryl monostearate [9-Octadecanoic acid, monoester with xybis(propanediol)]; Dilaurin [Dodecanoic acid, diester with 1,2,3-propanetriol]; Dipalmitin [Hexadecanoic acid, diester with 1,2,3-propanetriol]; Dipotassium citrate [Citric acid, dipotassium salt]; Disodium citrate [Citric acid, disodium salt]; Disodium sulfate decahydrate; Diatomaceous earth (less than 1% crystalline silica); Dodecanoic acid, monoester with 1,2,3-propanetriol; Dolomite; Douglas fir bark; Egg shells; Eggs; (+)-Ethyl lactate [Lactic acid, ethyl ester, (S)]; Ethyl lactate [Lactic acid, ethyl ester]; Feldspar; Fish meal; Fish oil (not conforming to 40 CFR 180.950); Fuller's earth; Fumaric acid; gamma-Cyclodextrin; Gelatins; Gellan gum; Glue (as depolymd. animal collagen); Glycerin [1,2,3-Propanetriol]; Glycerol monooleate [9-Octadecenoic acid (Z)—, 2,3-dihydroxypropyl ester]; Glyceryl dicaprylate [Octanoic acid, diester with 1,2,3-propanetriol]; Glyceryl dimyristate [Tetradecanoic acid, diester with 1,2,3-propanetriol]; Glyceryl dioleate [9-Octadecenoic acid (9Z)—, diester with 1,2,3-propanetriol]; Glyceryl distearate; Glyceryl monomyristate [Tetradecanoic acid, monoester with 1,2,3-propanetriol]; Glyceryl monooctanoate [Octanoic acid, monoester with 1,2,3-propanetriol]; Glyceryl monooleate [9-Octadecenoic acid (9Z)—, monoester with 1,2,3-propanetriol]; Glyceryl monostearate [Octadecanoic acid, monoester with 1,2,3-propanetriol]; Glyceryl stearate [Octadecanoic acid, ester with 1,2,3-propanetriol]; Granite; Graphite; Guar gum; Gum Arabic; Gum tragacanth; Gypsum; Hematite (Fe₂O₃); Humic acid; Hydrogenated cottonseed oil; Hydrogenated rapeseed oil; Hydrogenated soybean oil; Hydroxyethyl cellulose [Cellulose, 2-hydroxyethyl ether]; Hydroxypropyl cellulose [Cellulose, 2-hydroxypropyl ether]; Hydroxypropyl methyl cellulose [Cellulose, 2-hydroxypropyl methyl ether]; Iron magnesium oxide (Fe₂MgO₄); Iron oxide (Fe₂O₃); Iron oxide (Fe₂O₃); Iron oxide (Fe₃O₄); Iron oxide (FeO); Isopropyl alcohol [2-Propanol]; Isopropyl myristate; Kaolin; Lactose; Lactose monohydrate; Lanolin; Latex rubber; Lauric acid; Lecithins; Licorice extract; Lime (chemical) dolomitic; Limestone; Linseed oil; Magnesium carbonate [Carbonic acid, magnesium salt (1:1); Magnesium benzoate; Magnesium oxide; Magnesium oxide silicate (Mg₃O(Si₂O₅)₂), monohydrate; Magnesium silicate; Magnesium silicate hydrate; Magnesium silicon oxide (Mg₂Si₃O₈); Magnesium stearate [Octadecanoic acid, magnesium salt]; Magnesium sulfate; Magnesium sulfate heptahydrate; Malic acid; Malt extract; Malt flavor; Maltodextrin; Methylcellulose [Cellulose, methyl ether]; Mica; Mica-group minerals; Milk; N/A Millet seed; Mineral oil (U.S.P.); 1-Monolaurin [Dodecanoic acid, 2,3-dihydroxypropyl ester]; 1-Monomyristin [Tetradecanoic acid, 2,3-dihydroxypropyl ester]; Monomyristin [Decanoic acid, diester with 1,2,3-propanetriol]; Monopalmitin [Hexadecanoic acid, monoester with 1,2,3-propanetriol]; Monopotassium citrate [Citric acid, monopotassium salt; Monosodium citrate [Citric acid, monosodium salt]; Montmorillonite; Myristic acid; Nepheline syenite; Nitrogen; Nutria meat; Nylon; Octanoic acid, potassium salt; Octanoic acid, sodium salt; Oils, almond; Oils, wheat; Oleic acid; Oyster shells; Palm oil; Palm oil, hydrogenated; Palmitic acid [Hexadecanoic acid]; Paraffin wax; Peanut butter; Peanut shells; Peanuts; Peat moss; Pectin; Perlite; Perlite, expanded; Plaster of paris; Polyethylene; Polyglyceryl oleate; Polyglyceryl stearate; Potassium acetate [Acetic acid, potassium salt]; Potassium aluminum silicate, anhydrous; Potassium benzoate [Benzoic acid, potassium salt]; Potassium bicarbonate [Carbonic acid, monopotassium salt]; Potassium chloride; Potassium citrate [Citric acid, potassium salt]; Potassium humate [Humic acids, potassium salts]; Potassium myristate [Tetradecanoic acid, potassium salt]; Potassium oleate [9-Octadecenoic acid (9Z)—, potassium salt; Potassium ricinoleate [9-Octadecenoic acid, 12-hydroxy-, monopotassium salt, (9Z,12R)—]; Potassium sorbate [Sorbic acid, potassium salt]; Potassium stearate [Octadecanoic acid, potassium salt]; Potassium sulfate; Potassium sulfate [Sulfuric acid, monopotassium salt]; 1,2-Propylene carbonate [1,3-Dioxolan-2-one, 4-methyl-]; Pumice; Red cabbage color (expressed from edible red cabbage heads via a pressing process using only acidified water); Red cedar chips; Red dog flour; Rubber; Sawdust; Shale; Silica, amorphous, fumed (crystalline free); Silica, amorphous, precipitated and gel; Silica (crystalline free); Silica gel; Silica gel, precipitated, crystalline-free; Silica, hydrate; Silica, vitreous; Silicic acid (H₂SiO₃), magnesium salt (1:1); Soap (The water soluble sodium or potassium salts of fatty acids produced by either the saponification of fats and oils, or the neutralization of fatty acid); Soapbark [Quillaja saponin]; Soapstone; Sodium acetate [Acetic acid, sodium salt]; Sodium alginate; Sodium benzoate [Benzoic acid, sodium salt]; Sodium bicarbonate; Sodium carboxymethyl cellulose [Cellulose, carboxymethyl ether, sodium salt]; Sodium chloride; Sodium citrate; Sodium humate [Humic acids, sodium salts]; Sodium oleate; Sodium ricinoleate [9-Octadecenoic acid, 12-hydroxy-, monosodium salt, (9Z,12R)—]; Sodium stearate [Octadecanoic acid, sodium salt]; Sodium sulfate; Sorbitol [D-glucitol]; Soy protein; Soya lecithins [Lecithins, soya]; Soybean hulls; Soybean meal; Soybean, flour; Stearic acid [Octadecanoic acid]; Sulfur; Syrups, hydrolyzed starch, hydrogenated; Tetragylceryl monooleate [9-Octadecenoic acid (9Z)—, monoester with tetraglycerol]; Tricalcium citrate [Citric acid, calcium salt (2:3)]; Triethyl citrate [Citric acid, triethyl ester; Tripotassium citrate [Citric acid, tripotassium salt]; Tripotassium citrate monohydrate [Citric acid, tripotassium salt, monohydrate]; Trisodium citrate [Citric acid, trisodium salt]; Trisodium citrate dehydrate [Citric acid, trisodium salt, dehydrate]; Trisodium citrate pentahydrate [Citric acid, trisodium salt, pentahydrate]; Ultramarine blue [C.I. Pigment Blue 29]; Urea; Vanilla; Vermiculite; Vinegar (maximum 8% acetic acid in solution); Vitamin C [L-Ascorbic acid]; Vitamin; Walnut flour; Walnut shells; Wheat; Wheat flour; Wheat germ oil; Whey; White mineral oil (petroleum); Wintergreen oil; Wollastonite (Ca(SiO3)); Wool; Xanthan gum; Yeast; Zeolites (excluding erionite (CAS Reg. No. 66733-21-9)); Zeolites, NaA; Zinc iron oxide; Zinc oxide (ZnO); and Zinc stearate [Octadecanoic acid, zinc salt].

A. Kits

The bacterial strains or active variants thereof provided herein can be combined with at least one synthetic fungicide selected from the group consisting of tetraconazole, triflumizole, azoxystrobin, flutriafol, tebuconazole, chlorothalonil, and difenoconazole into kits, wherein the kits can comprise instructions for use. In some embodiments, the kit comprises a bacterial strain, such as AIP1620, AIP050999, and CGA267356, or an active variant of any thereof, and at least one synthetic fungicide selected from the group consisting of tetraconazole, triflumizole, azoxystrobin, flutriafol, tebuconazole, chlorothalonil, and difenoconazole, wherein both active ingredients are combined. In some of these embodiments, the premixed composition is a water dispersible granule.

In other embodiments, the kit provides at least one synthetic fungicide selected from the group consisting of tetraconazole, triflumizole, azoxystrobin, flutriafol, tebuconazole, chlorothalonil, and difenoconazole in a spatially separated arrangement from the bacterial strain, such as AIP1620, AIP050999, and CGA267356, or an active variant of any thereof. In some of these embodiments, the bacterial strain or active variants thereof are provided as a wettable powder. In particular embodiments, the synthetic fungicide selected from the group consisting of tetraconazole, triflumizole, azoxystrobin, flutriafol, tebuconazole, chlorothalonil, and difenoconazole is provided as a water dispersible granule. In other embodiments, tebuconazole is provided as a dry flowable (DF). In certain embodiments, azoxystrobin, flutriafol, chlorothalonil, triflumazole, and difenoconazole is provided as a flowable liquid formulation (F).

In some embodiments, the bacterial strain and/or the synthetic fungicide (i.e., tetraconazole, triflumizole, azoxystrobin, flutriafol, tebuconazole, chlorothalonil, or difenoconazole) are comprised within a vessel(s), such as a box, bag, or bottle. In particular embodiments, the kit comprises the synthetic fungicide (i.e., tetraconazole, triflumizole, azoxystrobin, flutriafol, tebuconazole, chlorothalonil, or difenoconazole) and the bacterial strain, such as AIP1620, AIP050999, and CGA267356, or an active variant of any thereof in a single vessel (e.g., box, bag, or bottle) with a partition between two compartments of the vessel, wherein the synthetic fungicide (i.e., tetraconazole, triflumizole, azoxystrobin, flutriafol, tebuconazole, chlorothalonil, or difenoconazole) is in one compartment and the bacterial strain is in the other compartment. The two compartments can each have a lid that can be opened or closed independently of the other. In some embodiments, the partition between the two compartments is removable to allow mixing of the two active ingredients.

### IV. Methods of Use

The bacterial strains or modified bacterial strains or active variants thereof provided herein can be applied (simultaneously or sequentially) with at least one synthetic fungicide selected from the group consisting of tetraconazole, triflumizole, azoxystrobin, flutriafol, tebuconazole, chlorothalonil, and difenoconazole to any plant species in order to improve an agronomic trait of interest. In specific embodiments, the bacterial strains disclosed herein and/or the synthetic fungicide (i.e., tetraconazole, triflumizole, azoxystrobin, flutriafol, tebuconazole, chlorothalonil, or difenoconazole) can be applied to a plant species at a lower application amount when used in combination than the application amount suggested by the manufacturer or commonly used when the bacterial strain and/or synthetic fungicide (i.e., tetraconazole, triflumizole, azoxystrobin, flutriafol, tebuconazole, chlorothalonil, or difenoconazole) is used separately. Agronomic traits of interest include any trait that improves plant health or commercial value.

Non-limiting examples of agronomic traits of interest include increase in biomass, increase in drought tolerance, thermal tolerance, herbicide tolerance, drought resistance, insect resistance, fungus resistance, virus resistance, bacteria resistance, male sterility, cold tolerance, salt tolerance, increased yield, enhanced nutrient use efficiency, increased nitrogen use efficiency, increased tolerance to nitrogen stress, increased fermentable carbohydrate content, reduced lignin content, increased antioxidant content, enhanced water use efficiency, increased vigor, increased germination efficiency, earlier or increased flowering, increased biomass, altered root-to-shoot biomass ratio, enhanced soil water retention, or a combination thereof. In another instance, the agronomic trait of interest includes an altered oil content, altered protein content, altered seed carbohydrate composition, altered seed oil composition, and altered seed protein composition, chemical tolerance, cold tolerance, delayed senescence, disease resistance, drought tolerance, ear weight, growth improvement, health enhancement, heat tolerance, herbicide tolerance, herbivore resistance, improved nitrogen fixation, improved nitrogen utilization, improved root architecture, improved water use efficiency, increased biomass, increased root length, increased seed weight, increased shoot length, increased yield, increased yield under water-limited conditions, kernel mass, kernel moisture content, metal tolerance, number of ears, number of kernels per ear, number of pods, nutrition enhancement, pathogen resistance, pest resistance, photosynthetic capability improvement, salinity tolerance, stay-green, vigor improvement, increased dry weight of mature seeds, increased fresh weight of mature seeds, increased number of mature seeds per plant, increased chlorophyll content, increased number of pods per plant, increased length of pods per plant, reduced number of wilted leaves per plant, reduced number of severely wilted leaves per plant, increased number of non-wilted leaves per plant, a detectable modulation in the level of a metabolite, a detectable modulation in the level of a transcript, or a detectable modulation in the proteome relative to a reference plant.

In one non-limiting embodiment, the bacterial strain or active variant thereof provided herein can be applied (simultaneously or sequentially) with at least one synthetic fungicide selected from the group consisting of tetraconazole, triflumizole, azoxystrobin, flutriafol, tebuconazole, chlorothalonil, and difenoconazole to decrease or reduce the level of a plant pest. “Pests” include but are not limited to, insects, fungi, bacteria, nematodes, acarids, protozoan pathogens, animal-parasitic liver flukes, and the like. In one non-limiting embodiment, the bacterial strain or active variant thereof provided herein can be applied with at least one synthetic fungicide selected from the group consisting of tetraconazole, triflumizole, azoxystrobin, flutriafol, tebuconazole, chlorothalonil, and difenoconazole to any plant species susceptible to a plant disease. By “a plant susceptible to a plant disease” is meant that the causative pathogen(s) of the plant disease are able to infect the plant.

Examples of plant species of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), grape (Vitus spp.), strawberry (Fragaria x ananassa), cherry (Prunus spp.), apple (Malus domestica), orange (Citrus x sinensis) cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and Chrysanthemum.

Conifers that may be employed in practicing the present invention include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). In specific embodiments, plants treated with the present combinations and methods are crop plants (for example, corn, alfalfa, sunflower, Brassica, soybean, cotton, safflower, peanut, sorghum, wheat, millet, tobacco, etc.). In particular embodiments, plants treated with the present combinations and methods are corn (maize), sorghum, wheat, sunflower, tomato, crucifers, peppers, potato, cotton, rice, soybean, sugarbeet, sugarcane, tobacco, barley, oilseed rape, Brassica sp., alfalfa, rye, millet, safflower, peanuts, sweet potato, cassava, coffee, coconut, pineapple, citrus trees, cocoa, tea, banana, avocado, fig, guava, mango, olive, papaya, cashew, macadamia, almond, oats, vegetables, ornaments, and conifers. In other embodiments, corn and soybean plants are optimal, and in yet other embodiments corn plants are optimal.

Other plants of interest include grain plants that provide seeds of interest, oil-seed plants, and leguminous plants. Seeds of interest include grain seeds, such as corn, wheat, barley, rice, sorghum, rye, etc. Oil-seed plants include cotton, soybean, safflower, sunflower, Brassica, maize, alfalfa, palm, coconut, etc. Leguminous plants include beans, peas, and dry pulses. Beans include guar, locust bean, fenugreek, soybean, garden beans, cowpea, mungbean, lima bean, fava bean, lentils, chickpea, etc.

In specific embodiments, the bacterial strain or active variant thereof provided herein can be applied (simultaneously or sequentially) with at least one synthetic fungicide selected from the group consisting of tetraconazole, triflumizole, azoxystrobin, flutriafol, tebuconazole, chlorothalonil, and difenoconazole to grapes (bloom to harvest), asparagus, stone fruits (bloom to harvest), and small fruits such as strawberry, blueberry, caneberry.

In specific embodiments, the bacterial strain and/or the at least one synthetic fungicide selected from the group consisting of tetraconazole, triflumizole, azoxystrobin, flutriafol, tebuconazole, chlorothalonil, and difenoconazole are applied (simultaneously or sequentially) at less than the suggested amount of the bacterial strain and the synthetic fungicide selected from the group consisting of tetraconazole, triflumizole, azoxystrobin, flutriafol, tebuconazole, chlorothalonil, and difenoconazole when applied alone. For example, the bacterial strain can be applied at about 20%, 25%, 30%, 35%, 40%, 45%, 50%, 55%, 60%, 65%, 70%, 75%, 80%, 85%, 90%, 95%, or about 20-70%, about 30-60%, about 30-70%, about 40-80%, about 40-70%, about 40-60%, about 40-50%, about 50-90%, about 50-80%, about 50-70%, about 50-60%, about 60-90%, about 60-80%, about 60-70%, about 70-90%, about 70-90%, or about 80-90% of the suggested amount for application when used alone (i.e., not in conjunction with an additional fungicide). The suggested amount for application of the bacterial strain can be about 1 lb/acre, about 1.25 lb/acre, about 1.5 lb/acre, about 1.75 lb/acre, about 2 lb/acre, about 2.25 lb/acre, about 2.5 lb/acre, about 2.75 lb/acre, about 3 lb/acre, about 3.5 lb/acre, about 4 lb/acre, about 5 lb/acre, about 6 lb/acre, about 7 lb/acre, about 8 lb/acre, about 1-10 lb/acre, or about 1-8 lb/acre. In specific embodiments, the suggested amount for application of bacterial strain AIP1620, or an active variant thereof, can be about 2.5 lb/acre. A formulated product comprising AIP1620 may have 50% AIP1620 by weight, where AIP1620 comprises at least about 400 μg of pyrrolnitrin per gram of cells. The application rate of the synthetic fungicide disclosed herein can be calculated based on the application rate of the bacterial strain, or active variant thereof, according to the selected active ingredient weight ratio as disclosed elsewhere herein for each selected synthetic fungicide. Application of 5 lbs/acre of the 50% formulated product comprises 2.5 lbs/acre of the bacterial strain AIP1620.

The synthetic fungicide selected from the group consisting of tetraconazole, triflumizole, azoxystrobin, flutriafol, tebuconazole, chlorothalonil, and difenoconazole can be applied at about 20%, 25%, 30%, 35%, 40%, 45%, 50%, 55%, 60%, 65%, 70%, 75%, 80%, 85%, 90%, 95%, or about 20-70%, about 30-60%, about 30-70%, about 40-80%, about 40-70%, about 40-60%, about 40-50%, about 50-90%, about 50-80%, about 50-70%, about 50-60%, about 60-90%, about 60-80%, about 60-70%, about 70-90%, about 70-90%, or about 80-90% of the suggested amount for application when used alone.

A. Non-limiting Plant Pests

Examples of plant diseases which can be treated or reduced or prevented include, but are not limited to, plant diseases caused by fungi, viruses or viroids, bacteria, insects, nematodes, protozoa, and the like. Examples of fungal plant diseases include, but are not limited to, Asian Soybean Rust (ASR), gray mold, leaf spot, Frogeye Leaf Spot, Early Blight, Damping off complex, Brown Patch, black scurf, root rot, belly rot, sheath blight, Powdery Mildew, Anthracnose leaf spot, Downy Mildew, Aerial Blight, Botrytis Blight, Dollar Spot, Fusarium Patch, Pythium Root Rot, Pythium Crown Rot, Stem and Root Rot, Pythium Blight, Late Blight, Fusarium Head Blight, sudden death syndrome (SDS), Fusarium Wilt, Corn Stalk Rot, Brown Rust, Black Rust, Yellow Rust, Wheat Rust, Rust, Apple Scab, Verticillium Wilt, Fire Blight, and Brown Rot, to name a few. In specific embodiments, the bacterial strain or active variant thereof provided herein can be combined (in a composition or applied simultaneously or sequentially) with at least one synthetic fungicide selected from the group consisting of tetraconazole, triflumizole, azoxystrobin, flutriafol, tebuconazole, chlorothalonil, and difenoconazole to target Monilinia, botrytis, powdery mildew, Phytophthora, Rhizoctonia, Corynespora, Alternaria, Sclerotinia, Bremia, Pseudoperonospora, Podosphaera, gleocercospora, and/or Fusarium.

Plant pathogens of the invention include, but are not limited to, viruses or viroids, bacteria, insects, nematodes, fungi, and the like.

In specific embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the bacterial strains provided herein target one or more plant pathogens. For example, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the various bacterial strains provided herein target one or more fungal or fungal-like pathogens that cause plant disease. For example, the combination (applied simultaneously or sequentially) of the synthetic fungicide (i.e., tetraconazole, triflumizole, azoxystrobin, flutriafol, tebuconazole, chlorothalonil, or difenoconazole) with the bacterial strains provided herein or active variants thereof can have antifungal activity against one, two, three, four, five, or more fungal or fungal-like pathogens and/or fungal or fungal-like diseases described herein.

The methods and compositions disclosed herein can be used to control one or more fungal pathogen, fungal-like pathogen, or combination thereof. A fungal pathogen or fungal-like pathogen can be, but is not limited to, a fungus or fungal-like organism selected from the group consisting of Botrytis spp., Botrytis cinerea, Cersospora spp., Cercospora sojina, Cercospora beticola, Corynespora spp., Corynespora cassiicola, Alternaria spp., Alternaria dauci, Alternaria solani, Blumeria graminis, Rhizoctonia spp., Rhizoctonia solani, Blumeria graminis f sp. Tritici, Erysiphe necator, Podosphaera spp., Podosphaera xanthii, Golovinomyces cichoracearum, Erysiphe lagerstroemiae, Sphaerotheca pannosa, Colletotrichum cereale, Apiognomonia errabunda, Apiognomonia veneta, Ascomycota spp., Colletotrichum spp., Colletotrichum gloeosporiodes, Discula fraxinea, Gleocercospora spp., Gleocercospora sorghi, Leveillula taurica, Mycosphaerella spp., Phomopsis spp., Plasmopara viticola, Pseudoperonospora spp., Pseudoperonospora cubensis, Peronospora belbahrii, Bremia spp., Bremia lactucae, Peronospora lamii, Plasmopara obduscens, Pythium spp., Pythium cryptoirregulare, Pythium aphanidermatum, Pythium irregulare, Pythium sylvaticum, Pythium myriotylum, Pythium ultimum, Phytophthora spp., Phytophthora capsici, Phytophthora nicotianae, Phytophthora infestans, Phytophthora tropicalis, Phytophthora sojae, Podosphaera leucotricha, Fusarium spp., Fusarium graminearum, Fusarium nivale, Fusarium solani, Fusarium oxysporum, Fusarium graminicola, Gibberella zeae, Colletotrichum graminicola, Microsphaera diffusa, Penicillium spp., Phakopsora sp., Phakopsora meibomiae, Phakopsora pachyrizi, Puccinia triticina, Puccinia recondita, Puccinia striiformis, Puccinia graminis, Puccinia spp., Sclerotium spp., Sclerotinia spp., Sclerotinia minor, Uncimula necator, Venturia inaequalis, Verticillium spp., Erwinia amylovora, Monilinia spp., Monilinia fructicola, Monilinia lax, and Monilinia fructigena.

In some embodiments, the fungal pathogen or fungal-like pathogen is selected from the group consisting of Ascomycota spp., Botrytis spp., Botrytis cinerea, Blumeria graminis, Bremia lactucae, Corynespora cassiicola, Cercospora sojina, Alternaria dauci, Alternaria solani, Rhizoctonia solani, Erysiphe necator, Gleocercospora sorghi, Podosphaera xanthii, Colletotrichum cereal, Leveillula taurica, Microsphaera diffusa, Plasmopara viticola, Peronospora belbahrii, Pseudoperonospora cubensis, Pythium aphanidermatum, Pythium sylvaticum, Pythium myriotylum, Pythium ultimum, Phytophthora nicotianae, Phytophthora infestans, Phytophthora tropicalis, Phytophthora sojae, Podosphaera leucotricha, Podosphaera xanthii, Uncimula necator, Fusarium graminearum, Fusarium solani, Phakopsora pachyrizi, Sclerotinia minor, and Venturia inaequalis

In further embodiments, the fungal pathogen is Phakopsora sp., including Phakopsora pachyrhizi and/or Phakopsora meibomiae. In other embodiments, the presently disclosed combinations do not control Phakopsora sp., such as Phakopsora pachyrhizi.

In specific embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with at least one bacterial strain provided herein target one or more insect or insect pests. The term “insects” or “insect pests” as used herein refers to insects and other similar pests such as, for example, those of the order Acari including, but not limited to, mites and ticks. Insect pests of the present invention include, but are not limited to, insects of the order Lepidoptera, e.g. Achoroia grisella, Acleris gloverana, Acleris variana, Adoxophyes orana, Agrotis ipsilon, Alabama argillacea, Alsophilapometaria, Amyelois transitella, Anagasta kuehniella, Anarsia lineatella, Anisota senatoria, Antheraea pernyi, Anticarsia gemmatalis, Archips sp., Argyrotaenia sp., Athetis mindara, Bombyx mori, Bucculatrix thurberiella, Cadra cautella, Choristoneura sp., Cochylls hospes, Colias eurytheme, Corcyra cephalonica, Cydia latiferreanus, Cydia pomonella, Datana integerrima, Dendrolimus sibericus, Desmia feneralis, Diaphania hyalinata, Diaphania nitidalis, Diatraea grandiosella, Diatraea saccharalis, Ennomos subsignaria, Eoreuma loftini, Esphestia elutella, Erannis tilaria, Estigmene acrea, Eulia salubricola, Eupocoellia ambiguella, Eupoecilia ambiguella, Euproctis chrysorrhoea, Euxoa messoria, Galleria mellonella, Grapholita molesta, Harrisina americana, Helicoverpa subflexa, Helicoverpa zea, Heliothis virescens, Hemileuca oliviae, Homoeosoma electellum, Hyphantia cunea, Keiferia lycopersicella, Lambdina fiscellaria fscellaria, Lambdina fiscellaria lugubrosa, Leucoma salicis, Lobesia botrana, Loxostege sticticalis, Lymantria dispar, Macalla thyrisalis, Malacosoma sp., Mamestra brassicae, Mamestra confjgurata, Manduca quinquemaculata, Manduca sexta, Maruca testulalis, Melanchra picta, Operophtera brumata, Orgyia sp., Ostrinia nubilalis, Paleacrita vernata, Papilio cresphontes, Pectinophora gossypiella, Phryganidia californica, Phyllonorycter blancardella, Pieris napi, Pieris rapae, Plathypena scabra, Platynota flouendana, Platynota stultana, Platyptilia carduidactyla, Plodia interpunctella, Plutella xylostella, Pontia protodice, Pseudaletia unipuncta, Pseudoplasia includens, Sabulodes aegrotata, Schizura concinna, Sitotroga cerealella, Spilonta ocellana, Spodoptera sp., Thaurnstopoea pityocampa, Tinsola bisselliella, Trichoplusia hi, Udea rubigalis, Xylomyges curiails, and Yponomeuta padella.

Insect pests also include insects selected from the orders Diptera, Hymenoptera, Lepidoptera, Mallophaga, Homoptera, Hemiptera, Orthroptera, Thysanoptera, Dermaptera, Isoptera, Anoplura, Siphonaptera, Trichoptera, Coleoptera, etc.; particularly Lepidoptera. Insect pests of the invention for the major crops include, but are not limited to: Maize: Ostrinia nubilalis, European corn borer; Agrotis ipsilon, black cutworm; Helicoverpa zeae, corn earworm; Spodoptera frugiperda, fall armyworm; Diatraea grandiosella, southwestern corn borer; Elasmopalpus lignosellus, lesser cornstalk borer; Diatraea saccharalis, surgarcane borer; western corn rootworm, e.g., Diabrotica virgifera virgifera; northern corn rootworm, e.g., Diabrotica longicornis barberi; southern corn rootworm, e.g., Diabrotica undecimpunctata howardi; Melanotus spp., wireworms; Cyclocephala borealis, northern masked chafer (white grub); Cyclocephala immaculata, southern masked chafer (white grub); Popilia japonica, Japanese beetle; Chaetocnema pulicaria, corn flea beetle; Sphenophorus maidis, maize billbug; Rhopalosiphum maidis, corn leaf aphid; Anuraphis maidiradicis, corn root aphid; Blissus leucopterus leucopterus, chinch bug; Melanoplus femurrubrum, redlegged grasshopper; Melanoplus sanguinipes, migratory grasshopper; Hylemya platura, seedcorn maggot; Agromyza parvicornis, corn blotch leafminer; Anaphothrips obscrurus, grass thrips; Solenopsis milesta, thief ant; Tetranychus urticae, two spotted spider mite; Sorghum: Chilo partellus, sorghum borer; Spodoptera frugiperda, fall armyworm; Helicoverpa zea, corn earworm; Elasmopalpus lignosellus, leser cornstalk borer; Feltia subterranea, granulate cutworm; Phyllophaga crinita, white grub; Eleodes, Conoderus, and Aeolus spp., wireworms; Oulema melanopus, cereal leaf beetle; Chaetocnema pulicaria, corn flea beetle; Sphenophorus maidis, maize billbug; Rhopalosiphum maidis; corn leaf aphid; Siphaflava, yellow sugarcane aphid; chinch bug, e.g., Blissus leucopterus leucopterus; Contarinia sorghicola, sorghum midge; Tetranychus cinnabarinus, carmine spider mite; Tetranychus urticae, two-spotted spider mite; Wheat: Pseudaletia unipunctata, army worm; Spodoptera frugiperda, fall armyworm; Elasmopalpus lignosellus, lesser cornstalk borer; Agrotis orthogonia, pale western cutworm; Elasmopalpus lignosellus, lesser cornstalk borer; Oulema melanopus, cereal leaf beetle; Hypera punctata, clover leaf weevil; southern corn rootworm, e.g., Diabrotica undecimpunctata howardi; Russian wheat aphid; Schizaphis graminum, greenbug; Macrosiphum avenae, English grain aphid; Melanoplus femurrubrum, redlegged grasshopper; Melanoplus differentialis, differential grasshopper; Melanoplus sanguinipes, migratory grasshopper; Mayetiola destructor, Hessian fly; Sitodiplosis mosellana, wheat midge; Meromyza americana, wheat stem maggot; Hylemya coarctata, wheat bulb fly; Frankliniella fusca, tobacco thrips; Cephus cinctus, wheat stem sawfly; Aceria tulipae, wheat curl mite; Sunflower: Cylindrocupturus adspersus, sunflower stem weevil; Smicronyx fulus, red sunflower seed weevil; Smicronyx sordidus, gray sunflower seed weevil; Suleima helianthana, sunflower bud moth; Homoeosoma electellum, sunflower moth; Zygogramma exclamationis, sunflower beetle; Bothyrus gibbosus, carrot beetle; Neolasioptera murtfeldtiana, sunflower seed midge; Cotton: Heliothis virescens, tobacco budworm; Helicoverpa zea, cotton bollworm; Spodoptera exigua, beet armyworm; Pectinophora gossypiella, pink bollworm; boll weevil, e.g., Anthonomus grandis; Aphis gossypii, cotton aphid; Pseudatomoscelis seriatus, cotton fleahopper; Trialeurodes abutilonea, bandedwinged whitefly; Lygus lineolaris, tarnished plant bug; Melanoplus femurrubrum, redlegged grasshopper; Melanoplus differentialis, differential grasshopper; Thrips tabaci, onion thrips; Franklinkiella fusca, tobacco thrips; Tetranychus cinnabarinus, carmine spider mite; Tetranychus urticae, two-spotted spider mite; Rice: Diatraea saccharalis, sugarcane borer; Spodoptera frugiperda, fall armyworm; Helicoverpa zea, corn earworm; Colaspis brunnea, grape colaspis; Lissorhoptrus oryzophilus, rice water weevil; Sitophilus oryzae, rice weevil; Nephotettix nigropictus, rice leafhoper; chinch bug, e.g., Blissus leucopterus leucopterus; Acrosternum hilare, green stink bug; Soybean: Pseudoplusia includens, soybean looper; Anticarsia gemmatalis, velvetbean caterpillar; Plathypena scabra, green cloverworm; Ostrinia nubilalis, European corn borer; Agrotis ipsilon, black cutworm; Spodoptera exigua, beet armyworm; Heliothis virescens, tobacco budworm; Helicoverpa zea, cotton bollworm; Epilachna varivestis, Mexican bean beetle; Myzus persicae, green peach aphid; Empoasca fabae, potato leafhopper; Acrosternum hilare, green stink bug; Melanoplus femurrubrum, redlegged grasshopper; Melanoplus differentialis, differential grasshopper; Hylemya platura, seedcorn maggot; Sericothrips variabilis, soybean thrips; Thrips tabaci, onion thrips; Tetranychus turkestani, strawberry spider mite; Tetranychus urticae, two-spotted spider mite; Barley: Ostrinia nubilalis, European corn borer; Agrotis ipsilon, black cutworm; Schizaphis graminum, greenbug; chinch bug, e.g., Blissus leucopterus leucopterus; Acrosternum hilare, green stink bug; Euschistus servus, brown stink bug; Jylemya platura, seedcorn maggot; Mayetiola destructor, Hessian fly; Petrobia latens, brown wheat mite; Oil Seed Rape: Vrevicoryne brassicae, cabbage aphid; Phyllotreta cruciferae, crucifer flea beetle; Phyllotreta striolata, striped flea beetle; Phyllotreta nemorum, striped turnip flea beetle; Meligethes aeneus, rapeseed beetle; and the pollen beetles Meligethes rufimanus, Meligethes nigrescens, Meligethes canadianus, and Meligethes viridescens; Potato: Leptinotarsa decemlineata, Colorado potato beetle.

The methods and compositions provided herein can also be used against Hemiptera such as Lygus hesperus, Lygus lineolaris, Lygus pratensis, Lygus rugulipennis Popp, Lygus pabulinus, Calocoris norvegicus, Orthops compestris, Plesiocoris rugicollis, Cyrtopeltis modestus, Cyrtopeltis notatus, Spanagonicus albofasciatus, Diaphnocoris chlorinonis, Labopidicola allii, Pseudatomoscelis seriatus, Adelphocoris rapidus, Poecilocapsus lineatus, Blissus leucopterus, Nysius ericae, Nysius raphanus, Euschistus servus, Nezara viridula, Eurygaster, Coreidae, Pyrrhocoridae, Tinidae, Blostomatidae, Reduviidae, and Cimicidae. Pests of interest also include Araecerus fasciculatus, coffee bean weevil; Acanthoscelides obtectus, bean weevil; Bruchus rufmanus, broadbean weevil; Bruchus pisorum, pea weevil; Zabrotes subfasciatus, Mexican bean weevil; Diabrotica balteata, banded cucumber beetle; Cerotoma trifurcata, bean leaf beetle; Diabrotica virgifera, Mexican corn rootworm; Epitrix cucumeris, potato flea beetle; Chaetocnema confinis, sweet potato flea beetle; Hypera postica, alfalfa weevil; Anthonomus quadrigibbus, apple curculio; Sternechus paludatus, bean stalk weevil; Hypera brunnipennis, Egyptian alfalfa weevil; Sitophilus granaries, granary weevil; Craponius inaequalis, grape curculio; Sitophilus zeamais, maize weevil; Conotrachelus nenuphar, plum curculio; Euscepes postfaciatus, West Indian sweet potato weevil; Maladera castanea, Asiatic garden beetle; Rhizotrogus majalis, European chafer; Macrodactylus subspinosus, rose chafer; Tribolium confusum, confused flour beetle; Tenebrio obscurus, dark mealworm; Tribolium castaneum, red flour beetle; Tenebrio molitor, yellow mealworm.

Nematodes include parasitic nematodes such as root-knot, cyst, and lesion nematodes, including Heterodera spp., Meloidogyne spp., and Globodera spp.; particularly members of the cyst nematodes, including, but not limited to, Heterodera glycines (soybean cyst nematode); Heterodera schachtii (beet cyst nematode); Heterodera avenae (cereal cyst nematode); and Globodera rostochiensis and Globodera pailida (potato cyst nematodes). Lesion nematodes include Pratylenchus spp.

Insect pests can be tested for pesticidal activity of compositions of the invention in early developmental stages, e.g., as larvae or other immature forms. The insects may be reared in total darkness at from about 20 degrees C. to about 30 degrees C. and from about 30% to about 70% relative humidity. Bioassays may be performed as described in Czapla and Lang (1990) J. Econ. Entomol. 83 (6): 2480-2485. Methods of rearing insect larvae and performing bioassays are well known to one of ordinary skill in the art.

In further embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the bacterial strains or active variants thereof (i.e., AIP1620, AIP050999, and CGA267356, or an active variant of any thereof, or a combination of cells from any one of AIP1620, AIP050999, and CGA267356, or an active variant of any thereof) control at least one, two, three, four, five, or more of the fungal and/or fungal-like diseases and/or fungal and/or fungal-like pathogens described herein.

In further embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with bacterial strains or active variants thereof (i.e., AIP1620, AIP050999, and CGA267356, or an active variant of any thereof, or a combination of cells from any one of AIP1620, AIP050999, and CGA267356, or an active variant of any thereof) control at least one, two, three, four, five, or more fungal and/or fungal-like diseases selected from the group consisting of Asian Soybean Rust, gray mold, leaf spot, Frogeye Leaf Spot, Early Blight, Damping off complex, Brown Patch, black scurf, root rot, belly rot, sheath blight, Powdery Mildew, Anthracnose leaf spot, zonate leaf spot, Downy Mildew, Pythium Blight, Late Blight, Fusarium Head Blight, head drop, SDS, Fusarium Wilt, Corn Stalk Rot, Brown Rust, Black Rust, Yellow Rust, Wheat Rust, Rust, Apple Scab, Verticillium Wilt, Fire Blight, target spot, and Brown Rot.

In further embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the bacterial strain or active variant thereof (i.e., AIP1620, AIP050999, and CGA267356, or an active variant of any thereof, or a combination of cells from any one of AIP1620, AIP050999, and CGA267356, or an active variant of any thereof) control at least one, two, three, four, five, or more fungal and/or fungal-like diseases selected from the group consisting of Asian Soybean Rust, gray mold, Frogeye Leaf Spot, Early Blight, Damping off complex, Brown Patch, Powdery Mildew, Anthracnose leaf spot, zonate leaf spot, Downy Mildew, Pythium Blight, Late Blight, Fusarium Head Blight, head drop, SDS, target spot, and Apple Scab.

In further embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with bacterial strains or active variants thereof (i.e., AIP1620, AIP050999, and CGA267356, or an active variant of any thereof, or a combination of cells from any one of AIP1620, AIP050999, and CGA267356, or an active variant of any thereof) control at least one, two, three, four, five, or more fungal and/or fungal-like pathogens selected from the group consisting of Botrytis spp., Botrytis cinerea, Cersospora spp., Cercospora sojina, Cercospora beticola, Corynespora spp., Corynespora cassiicola, Alternaria spp., Alternaria solani, Alternaria dauci, Bremia spp., Bremia lactucae, Rhizoctonia solani, Blumeria graminis f sp. Tritici, Erysiphe necator, Podosphaera spp., Podosphaera xanthii, Golovinomyces cichoracearum, Erysiphe lagerstroemiae, Gleocercospora spp., Gleocercospora sorghi, Sphaerotheca pannosa, Colletotrichum cereale, Apiognomonia errabunda, Apiognomonia veneta, Colletotrichum gloeosporiodes, Discula fraxinea, Plasmopara viticola, Pseudoperonospora spp., Pseudoperonospora cubensis, Peronospora belbahrii, Bremia lactucae, Peronospora lamii, Plasmopara obduscens, Pythium cryptoirregulare, Pythium aphanidermatum, Pythium irregulare, Pythium sylvaticum, Pythium myriotylum, Pythium ultimum, Phytophthora capsici, Phytophthora nicotianae, Phytophthora infestans, Phytophthora tropicalis, Phytophthora sojae, Sclerotinia spp., Sclerotinia minor, Fusarium graminearum, Fusarium solani, Fusarium oxysporum, Fusarium graminicola, Gibberella zeae, Colletotrichum graminicola, Phakopsora sp., Phakopsora meibomiae, Phakopsora pachyrizi, Puccinia triticina, Puccinia recondita, Puccinia striiformis, Puccinia graminis, Puccinia spp., Venturia inaequalis, Verticillium spp., Erwinia amylovora, Monilinia fructicola, Monilinia lax, and Monilinia fructigena.

In further embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with bacterial strains or active variants thereof (i.e., AIP1620, AIP050999, and CGA267356, or an active variant of any from any one of AIP1620, AIP050999, and CGA267356, or an active variant of any thereof) control at least one, two, three, four, five, or more fungal and/or fungal-like pathogens selected from the group consisting of Botrytis spp., Botrytis cinerea, Cercospora sojina, Corynespora cassiicola, Alternaria solani, Alternaria dauci, Bremia lactucae, Gleocercospora sorghi, Rhizoctonia solani, Erysiphe necator, Podosphaera xanthii, Colletotrichum cereal, Plasmopara viticola, Peronospora belbahrii, Pythium aphanidermatum, Pythium sylvaticum, Pythium myriotylum, Pythium ultimum, Phytophthora nicotianae, Phytophthora infestans, Phytophthora tropicalis, Phytophthora sojae, Pseudoperonospora cubensis, Fusarium graminearum, Fusarium solani, Phakopsora pachyrizi, Sclerotinia minor, and Venturia inaequalisa.

In further embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the bacterial strains or active variants thereof (i.e., AIP1620, AIP050999, and CGA267356, or an active variant of any thereof, or a combination of cells from any one of AIP1620, AIP050999, and CGA267356, or an active variant of any thereof) control at least one, two, or all of Phakopsora. In further embodiments, the synthetic fungicide and the bacterial strain or modified biological agents disclosed herein (i.e., AIP1620, AIP050999, and CGA267356, or an active variant of any thereof, or a combination of cells from any one of AIP1620, AIP050999, and CGA267356, or an active variant of any thereof) control at least one, or all of Phakopsora pachyrhizi and/or Phakopsora meibomiae. In other methods, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the bacterial strains or modified bacterial strains disclosed herein (i.e., AIP1620, AIP050999, and CGA267356, or an active variant of any thereof or a combination of cells from any one of AIP1620, AIP050999, and CGA267356, or an active variant of any thereof) control Phakopsora pachyrhizi.

B. Methods of Treating or Preventing Plant Disease

Provided herein are methods of treating or preventing a plant disease comprising applying to a plant or plant part having a plant disease or at risk of developing a plant disease an effective amount of at least one synthetic fungicide selected from the group consisting of tetraconazole, triflumizole, azoxystrobin, flutriafol, tebuconazole, chlorothalonil, and difenoconazole in combination (applied simultaneously or sequentially) with at least one bacterial strain provided herein or an active variant thereof, wherein the combination controls a plant pathogen that causes the plant disease. In certain embodiments, the bacterial strain provided herein or active variant thereof may comprise at least one of AIP1620, AIP050999, and CGA267356, or an active variant of any thereof, or a combination of cells from any one of AIP1620, AIP050999, and CGA267356, or an active variant or any thereof.

In some embodiments, the effective amount of the presently disclosed combination (applied simultaneously or sequentially) comprises an active ingredient weight ratio of the bacterial strain or active variant thereof to the synthetic fungicide as disclosed herein for the selected synthetic fungicide wherein the combination controls a plant pathogen, treats or prevents a plant disease, or improves an agronomic trait of interest in a plant. The effective amount of the combination can comprise at least about 4.4×10⁵ μg of pyrrolnitrin per acre or least about 1×10⁴ to 1×10⁶ μg of pyrrolnitrin per acre of the bacterial strain or active variant thereof.

In some embodiments, AIP1620 is applied at 2.5 lb/acre wherein the formulation comprises at least about 400 μg of pyrrolnitrin per gram of cells. Applying AIP1620, or active variant thereof, in the presence of at least one synthetic fungicide selected from the group consisting of tetraconazole, triflumizole, azoxystrobin, flutriafol, tebuconazole, chlorothalonil, and difenoconazole can reduce the amount of synthetic fungicide or bacterial strain required for a given result. For example, when applying (simultaneously or sequentially) at least one synthetic fungicide selected from the group consisting of tetraconazole, triflumizole, azoxystrobin, flutriafol, tebuconazole, chlorothalonil, and difenoconazole with AIP1620, or an active variant thereof, the amount of the bacterial strain can be less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising at least 10⁶ CFU/g. Alternatively, when applying (simultaneously or sequentially) at least one bacterial strain such as AIP1620, AIP050999, and CGA267356, or active variant thereof, with a synthetic fungicide selected from the group consisting of tetraconazole, triflumizole, azoxystrobin, flutriafol, tebuconazole, chlorothalonil, and difenoconazole, the amount of the synthetic fungicide can be reduced by at least about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99% or more, or about 1-5%, about 5-10%, about 5-15%, about 5-20%, about 1-10%, about 1-15%, about 1-20%, about 1-25%, about 5-25%, about 10-20%, about 10-30%, about 20-25%, about 20-30%, about 20-40%, about 30-40%, about 30-50%, about 40-50%, about 50-60%, about 60-70%, about 70-80%, about 80-90%, about 90-99% when compared to the effective administration rate of the synthetic fungicide in the absence of the bacterial strain, or active variant thereof. The application rate of the synthetic fungicide disclosed herein can be calculated based on the rate of the bacterial strain, or active variant thereof, according to the selected active ingredient weight ratio as disclosed elsewhere herein for each selected synthetic fungicide. The formulated product that is applied that comprises AIP1620 may have about 50% AIP1620 by weight, where AIP1620 comprises at least about 400 μg of pyrrolnitrin per gram of cells. Application of 5 lbs/acre of the 50% formulated product comprises 2.5 lbs/acre of the bacterial strain AIP1620.

The bacterial strain and at least one synthetic fungicide selected from the group consisting of tetraconazole, triflumizole, azoxystrobin, flutriafol, tebuconazole, chlorothalonil, and difenoconazole can be applied (simultaneously or sequentially) to a plant, plant part, or area of plant cultivation in a weight ratio that results in at least an additive effect when applied to a plant, plant part, or area of plant cultivation.

For example, the bacterial strain, or active variant thereof, can be applied (simultaneously or sequentially) with tetraconazole or flutriafol in an active ingredient weight ratio (lb/lb) of about 1:10 (bacterial strain:synthetic fungicide) to about 1000:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 300:1, about 400:1, about 500:1, about 600:1, about 700:1, about 800:1, about 900:1 or about 1000:1.

In particular embodiments, the bacterial strain, or active variant thereof, can be applied (simultaneously or sequentially) with tetraconazole or flutriafol in an active ingredient weight ratio (lb/lb) of about 1:1 (bacterial strain:synthetic fungicide) to about 100:1, including but not limited to about 1:1, about 2:1, about 5:1, about 10:1, about 15:1, about 20:1, about 25:1, about 30:1, about 35:1, about 40:1, about 45:1, about 50:1, about 55:1, about 60:1, about 61:1, about 62:1, about 62.5:1, about 63:1, about 64:1, about 65:1, about 66:1, about 67:1, about 68:1, about 69:1, about 70:1, about 75:1, about 80:1, about 85:1, about 90:1, about 95:1, and about 100:1.

In other embodiments, the bacterial strain, or active variant thereof, can be applied (simultaneously or sequentially) with azoxystrobin, tebuconazole, or difenoconazole in an active ingredient weight ratio (lb/lb) of about 1:10 (bacterial strain:synthetic fungicide) to about 500:1, about 1:5 to about 100:1, about 1:5 to about 75:1, about 1:5 to about 50:1, about 1:5 to about 20:1, about 1:1 to about 100:1, about 1:1 to about 75:1, about 1:1 to about 50:1, or about 1:1 to about 20:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 250:1, about 300:1, about 350:1, about 400:1, about 450:1, or about 500:1.

In particular embodiments, the bacterial strain, or active variant thereof, can be applied (simultaneously or sequentially) with azoxystrobin in an active ingredient weight ratio (lb/lb) of about 1:1 (bacterial strain:synthetic fungicide) to about 25:1 or about 1:1 to about 20:1, including but not limited to about 1:1, about 1.5:1, about 2:1, about 2.5:1, about 3:1, about 3.5:1, about 4:1, about 4.5:1, about 5:1, about 5.5:1, about 6:1, about 6.1:1, about 6.2:1, about 6.3:1, about 6.4:1, about 6.5:1, about 6.6:1, about 6.7:1, about 6.8:1, about 6.9:1, about 7:1, about 7.1:1, about 7.2:1, about 7.3:1, about 7.4:1, about 7.5:1, about 7.6:1, about 7.7:1, about 7.8:1, about 7.9:1, about 8:1, about 8.5:1, about 9:1, about 9.5:1, about 10:1, about 10.25:1, about 10.4:1, about 10.5:1, about 10.75:1, about 11:1, about 11.5:1, about 12:1, about 12.5:1, about 13:1, about 13.5:1, about 14:1, about 14.5:1, about 15:1, about 16:1, about 17:1, about 18:1, about 19:1, about 20:1, about 21:1, about 22:1, about 23:1, about 24:1, and about 25:1.

In particular embodiments, the bacterial strain, or active variant thereof, can be applied (simultaneously or sequentially) with tebuconazole in an active ingredient weight ratio (lb/lb) of about 1:1 (bacterial strain:synthetic fungicide) to about 50:1, including but not limited to about 1:1, about 3:1, about 5:1, about 7:1, about 9:1, about 11:1, about 13:1, about 15:1, about 17:1, about 17.5:1, about 18:1, about 18.5:1, about 19:1, about 19.5:1, about 20:1, about 16:1, about 17:1, about 18:1, about 19:1, about 19.1:1, about 19.2:1, about 19.3:1, about 19.4:1, about 19.5:1, about 19.6:1, about 19.7:1, about 19.8:1, about 19.9:1, about 20:1, about 20.25:1, about 20.5:1, about 20.75:1, about 21:1, about 21.25:1, about 21.5:1, about 21.75:1, about 22:1, about 22.2:1, about 22.22:1, about 22.25:1, about 22.5:1, about 22.75:1, about 23:1, about 23.25:1, about 23.5:1, about 23.75:1, about 24:1, about 24.25:1, about 24.5:1, about 24.75:1, about 25:1, about 25.5:1, about 26:1, about 26.5:1, about 27:1, about 27.5:1, about 28:1, about 29:1, about 30:1, about 32:1, about 34:1, about 36:1, about 38:1, about 40:1, about 45:1, and about 50:1. In certain embodiments, the bacterial strain, or active variant thereof, can be applied (simultaneously or sequentially) with difenoconazole in an active ingredient weight ratio (lb/lb) of about 1:1 (bacterial strain:synthetic fungicide) to about 50:1, about 1:1 to about 40:1, about 10:1 to about 40:1, or about 10:1 to about 30:1, including but not limited to, about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1, about 31:1, about 32:1, about 33:1, about 34:1, about 35.1:1, about 36:1, about 37:1, about 38:1, about 39:1, about 40:1, about 41:1, about 42:1, about 43:1, about 44:1, about 45:1, about 46:1, about 47:1, about 48:1, about 49:1, and about 50:1.

In other embodiments, the bacterial strain, or active variant thereof, can be applied (simultaneously or sequentially) with chlorothalonil in an active ingredient weight ration (lb/lb) of about 1:100 (bacterial strain:synthetic fungicide) to about 500:1, including but not limited to, about 1:100, about 1:50, about 1:10, about 1:5, about 1:4, about 1:3, about 1:2, about 1:1.5, about 1:1.3, about 1:1.2, about 1:1.1, about 1:1, about 1.1:1, about 1.12:1, about 1.125:1, about 1.13:1, about 1.15:1, about 1.2:1, about 1.3:1, about 1.4:1, about 1.5:1, about 1.8:1, about 2:1, about 2.5:1, about 3:1, about 4:1, about 5:1, about 10:1, about 50:1, about 100:1, about 150:1, about 200:1, about 250:1, about 300:1, about 350:1, about 400:1, about 450:1, and about 500:1.

In certain embodiments, the bacterial strain, or active variant thereof, can be applied (simultaneously or sequentially) with chlorothalonil in an active ingredient weight ratio (lb/lb) of about 1:10 (bacterial strain:synthetic fungicide) to about 10:1, including but not limited to, about 1:10, about 1:9, about 1:8, about 1:7, about 1:6, about 1:5, about 1:4, about 1:3, about 1:2, about 1:1.9, about 1:1.8, about 1:1.75, about 1:1.7, about 1:1.65, about 1:1.6, about 1:1.55, about 1:1.5, about 1:1.45, about 1:4, about 1:1.35, about 1:1.3, about 1:1.275, about 1:1.25, about 1:1.24, about 1:1.23, about 1:1.22, about 1:1.21, about 1:1.2, about 1:1.19, about 1:1.18, about 1:1.17, about 1:1.16, about 1:1.15, about 1:1.15, about 1:1.1, about 1:1, about 1.1:1, about 1.2:1, about 1.3:1, about 1.4:1, about 1.5:1, about 1.6:1, about 1.7:1, about 1.8:1, about 1.9:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, and about 10:1.

In other embodiments, the bacterial strain, or active variant thereof, can be applied (simultaneously or sequentially) with triflumizole in an active ingredient weight ratio (lb/lb) of about 1:10 (bacterial strain: triflumizole) to about 100:1, including but not limited to, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, or about 100:1 In certain embodiments, the bacterial strain, or active variant thereof, can be applied (simultaneously or sequentially) with triflumizole in an active ingredient weight ratio (lb/lb) of about 1:10 (bacterial strain: triflumizole) to about 25:1 or about 1:10 to about 20:1, including but not limited to about 1:10, about 1:9, about 1:8, about 1:7, about 1:6, about 1:5, about 1:4, about 1:3, about 1:2, about 1:1, about 1.1:1, about 1.2:1, about 1.3:1, about 1.4:1, about 1.5:1, about 1.6:1, about 1.66:1, about 1.7:1, about 1.8:1, about 1.9:1, about 2:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, about 10:1, about 15:1, about 20:1, and about 25:1.

In some methods, the combination (applied simultaneously or sequentially) of at least one synthetic fungicide selected from the group consisting of tetraconazole, triflumizole, azoxystrobin, flutriafol, tebuconazole, chlorothalonil, and difenoconazole with a bacterial strain provided herein or an active variant thereof treats or prevents one, two, three, four, five or more plant diseases. In other methods, the combination (applied simultaneously or sequentially) of at least one synthetic fungicide selected from the group consisting of tetraconazole, triflumizole, azoxystrobin, flutriafol, tebuconazole, chlorothalonil, and difenoconazole with a bacterial strain provided herein or an active variant thereof treats or prevents one, two, three, four, five or more fungal and/or fungal-like plant diseases. The combination (applied simultaneously or sequentially) of at least one synthetic fungicide selected from the group consisting of tetraconazole, triflumizole, azoxystrobin, flutriafol, tebuconazole, chlorothalonil, and difenoconazole with a bacterial strain provided herein or an active variant thereof can be employed with any plant species susceptible to a plant disease of interest.

Examples of diseases causes by the fungal or fungal-like pathogens described herein are provided in Table 1. Also provided are non-limiting exemplary crop species that are susceptible to the plant diseases caused by the pathogens. For example, Table 1 shows that Botrytis cinerea causes gray mold on all flowering crops. Therefore, a combination of a bacterial strain provided herein or active variant thereof and at least one synthetic fungicide selected from the group consisting of tetraconazole, triflumizole, azoxystrobin, flutriafol, tebuconazole, chlorothalonil, and difenoconazole that controls Botrytis cinerea can be applied (simultaneously or sequentially) to a plant having gray mold or at risk of developing gray mold in order to treat or prevent gray mold in the plant. Similarly, Table 1 shows that Rhizoctonia solani causes Damping off complex in corn, Damping off complex in soybean, Brown Patch in turf, and Damping off complex in ornamentals. Therefore, a combination of a bacterial strain provided herein or active variant thereof and at least one synthetic fungicide selected from the group consisting of tetraconazole, triflumizole, azoxystrobin, flutriafol, tebuconazole, chlorothalonil, and difenoconazole that controls Rhizoctonia solani can be applied (simultaneously or sequentially) to a plant having Damping off complex and/or brown patch or at risk of developing Damping off complex and/or brown patch in order to treat or prevent Damping off complex and/or brown patch in the plant. In yet another example, Table 1 shows that Colletotrichum cereal, Apiognomonia errabunda, Apiognomonia veneta, Colletotrichum gloeosporiodes, Discula fraxinea cause Anthracnose leaf spot. Therefore, a combination of a bacterial strain provided herein or active variant thereof and at least one synthetic fungicide selected from the group consisting of tetraconazole, triflumizole, azoxystrobin, flutriafol, tebuconazole, chlorothalonil, and difenoconazole that controls one or more of Colletotrichum cereal, Apiognomonia errabunda, Apiognomonia veneta, Colletotrichum gloeosporiodes, Discula fraxinea can be applied (simultaneously or sequentially) to a plant having Anthracnose leaf spot or at risk of developing Anthracnose leaf spot in order to treat or prevent Anthracnose leaf spot in the plant.

TABLE 1

| Causal Pathogen | Disease | Crop-species |
|---|---|---|
| Botrytis cinerea | gray mold | all flowering crops |
| Cercospora spp | Leaf Spot | Ornamentals |
| Cercospora sojina | Frogeye leaf spot | Soybeans |
| Cercospora beticola | | beets, spinach, chard |
| Alternaria solani | Early Blight | solanaceous plants |
| Rhizoctonia solani | Damping off complex | Corn |
| Rhizoctonia solani | Damping off complex | Soybean |
| Rhizoctonia solani | Brown Patch | Turf |
| Rhizoctonia solani | Damping off complex | Ornamentals |
| Rhizoctonia solani | black scurf | potato |
| Rhizoctonia solani | root rot | sugar beet |
| Rhizoctonia solani | belly rot | cucurbit |
| Rhizoctonia solani | sheath blight | rice |
| Blumeria graminis f. sp. Tritici | Powdery Mildew | Wheat |
| Erysiphe necator | Powdery Mildew | Grape |
| Podosphaera xanthii | Powdery Mildew | Cucurbit |
| Golovinomyces cichoracearum | Powdery Mildew | Ornamentals |
| Erysiphe lagerstroemiae | Powdery Mildew | Ornamentals |
| Sphaerotheca pannosa | Powdery Mildew | Ornamentals |
| Colletotrichum cereale | Anthracnose leaf spot | Turf/grasses/cereal |
| Apiognomonia errabunda | Anthracnose leaf spot | Turf/grasses/cereal |
| Apiognomonia veneta | Anthracnose leaf spot | Turf/grasses/cereal |
| Colletotrichum gloeosporiodes | Anthracnose leaf spot | Turf/grasses/cereal |
| Discula fraxinea | Anthracnose leaf spot | Turf/grasses/cereal |
| Plasmopara viticola | Downy Mildew | Grape |
| Pseudoperonospora cubensis | Downy Mildew | Cucurbit |
| Peronospora belbahrii | Downy Mildew | Basil |
| Bremia lactucae | Downy Mildew | Lettuce |
| Peronospora lamii | Downy Mildew | Coleus |
| Plasmopara obduscens | Downy Mildew | Impatiens |
| Pythium cryptoirregulare | Damping off complex | Ornamental Plants |
| Pythium aphanidermatum | Pythium Blight/ | turf/omamentals/row crop |
| | Damping off complex | |
| Pythium irregulare | Damping off complex | turf/omamentals/row crop |
| Pythium sylvaticum | Damping off complex | turf/omamentals/row crop |
| Pythium myriotylum | Damping off complex | turf/omamentals/row crop |
| Pythium ultimum | Pythium Blight/ | turf/omamentals/row crop |
| | Damping off complex | |
| Phytophthora capsici | | cucurbit/pepper |
| Phytophthora nicotianae | | ornamental plants |
| Phytophthora infestans | Late Blight | solanaceous plant |
| Phytophthora tropicalis | | ornamental plants/ |
| | | peppers/tropical nut |
| | | trees |
| Phytophthora sojae | | Soybean |
| Fusarium graminearum | Fusarium Head Blight | Cereals-Wheat |
| Fusarium solani | SDS | Soybean |
| Fusarium oxysporum | Fusarium Wilt | Herbaceous Plants |
| Fusarium graminicola | Com Stalk Rot | Maize |
| Gibberella zeae | Com Stalk Rot | Maize |
| Colletotrichum graminicola | Com Stalk Rot | Maize |
| Phakopsora pachyrizi | Asian Soybean Rust | Soybean |
| Puccinia triticina | Brown Rust | Cereals |
| Puccinia recondita | Black Rust | Cereals |
| Puccinia striiformis | Yellow Rust | Cereals |
| Puccinia graminis | Wheat Rust | Cereals |
| Puccinia spp. | Rust | Ornamentals |
| Venturia inaequalis | Apple Scab | Malus |
| Verticillium spp | Verticillium Wilt | All |
| Erwinia amylovora | Fire Blight | Rosacea family |
| Monilinia fructicola | Brown Rot | Stone Fruits |
| Monilinia laxa | Brown Rot | Stone Fruits |
| Monilinia fructigena | Brown Rot | Stone Fruits |

Also provided herein are methods of treating or preventing Asian Soybean Rust (ASR) comprising applying to a plant having ASR or at risk of developing ASR an effective amount of a combination (applied simultaneously or sequentially) of at least one bacterial strain provided herein or an active variant thereof comprising AIP1620, AIP050999, and CGA267356, or an active variant of any thereof, or a combination of cells from any one of AIP1620, AIP050999, and CGA267356, or an active variant of any thereof along with at least one synthetic fungicide selected from the group consisting of tetraconazole, triflumizole, azoxystrobin, flutriafol, tebuconazole, chlorothalonil, and difenoconazole. In certain embodiments, the effective amount comprises applying the combination of the bacterial strain and synthetic fungicide at a weight ratio disclosed herein for the selected synthetic fungicide, wherein the combination comprises at least about 400 μg pyrrolnitrin per gram of bacterial cells, wherein the bacterial strain provided herein or active variant thereof in combination with at least one synthetic fungicide selected from the group consisting of tetraconazole, triflumizole, azoxystrobin, flutriafol, tebuconazole, chlorothalonil, and difenoconazole controls a plant pathogen that causes ASR. In one embodiment, at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof provided herein is used as a foliar application on a plant to treat or prevent ASR. The application rate of the synthetic fungicide disclosed herein can be calculated based on the rate of the bacterial strain, or active variant thereof, according to the selected active ingredient weight ratio as disclosed elsewhere herein for each selected synthetic fungicide.

The combination (applied simultaneously or sequentially) of at least one synthetic fungicide selected from the group consisting of tetraconazole, triflumizole, azoxystrobin, flutriafol, tebuconazole, chlorothalonil, and difenoconazole with a bacterial strain provided herein or an active variant thereof or modified bacterial strain provided herein can be employed with any plant species susceptible to ASR. By “a plant susceptible to Asian Soybean Rust (ASR)” is meant that the causative pathogen(s) of ASR are able to infect the plant. Examples of plant species susceptible to ASR include, but are not limited to, soybean (Glycine max), common bean (Phaseolus vulgaris), such as green beans and kidney beans, lima beans (Phaseolus limensis), butter beans (Phaseolus lunatus), cowpeas (Vigna unguiculata), pigeon peas (Cajanus cajan), yam beans such as jicama (Pachyrhizus erosus). In a specific embodiment, a soybean plant is employed.

As outlined in further detail herein, in specific embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with a bacterial strain provided herein or an active variant thereof controls one or more fungi that causes ASR (such as, for example, Phakopsora). ASR is caused by one or more fungal pathogens of the genus Phakopsora. In non-limiting embodiments, the fungal pathogens that cause ASR are Phakopsora pachyrhizi or Phakopsora meibomiae. The ASR pathogen is well adapted for long-distance dispersal, because the spores can be readily carried by the wind, making it an ideal means for introduction to new, rust-free regions. The primary means of dissemination are spores, which can be carried by wind or splashed rain. These pathogens are obligate pathogens surviving and reproducing only on live hosts. In cultivated soybean, the first symptoms are light-brown polygonal lesions of 2 to 5 mm on the adaxial leaf surface. These lesions develop into volcano-shaped lesions known as pustules that appear on the abaxial surface of the leaf, where uredospores are produced.

In further embodiments, a combination (applied simultaneously or sequentially) of a bacterial strain provided herein or an active variant thereof and at least one synthetic fungicide selected from the group consisting of tetraconazole, triflumizole, azoxystrobin, flutriafol, tebuconazole, chlorothalonil, and difenoconazole controls Phakopsora pachyrhizi. In yet further embodiments, a combination (applied simultaneously or sequentially) of a bacterial strain provided herein or active variant thereof and at least one synthetic fungicide selected from the group consisting of tetraconazole, triflumizole, azoxystrobin, flutriafol, tebuconazole, chlorothalonil, and difenoconazole controls Phakopsora meibomiae. Various assays to measure such activity are disclosed elsewhere herein.

The term “treat” or “treating” or its derivatives includes substantially inhibiting, slowing, or reversing the progression of a condition, substantially ameliorating symptoms of a condition or substantially preventing the appearance of symptoms or conditions brought about by the pathogen that causes the plant disease.

The terms “controlling” and “protecting a plant from a pathogen” refers to one or more of inhibiting or reducing the growth, germination, reproduction, and/or proliferation of a pathogen of interest; and/or killing, removing, destroying, or otherwise diminishing the occurrence, and/or activity of a pathogen of interest. As such, a plant treated with the bacterial strain provided herein and synthetic fungicide may show a reduced disease severity or reduced disease development in the presence of plant pathogens by a statistically significant amount.

The term “prevent” and its variations means the countering in advance of bacterial, fungal, viral, insect or other pest growth, proliferation, infestation, spore germination, and hyphae growth. In this instance, the composition is applied before exposure to the pathogens.

The term “ameliorate” and “amelioration” relate to the improvement in the treated plant condition brought about by the compositions and methods provided herein. The improvement can be manifested in the forms of a decrease in pathogen growth and/or an improvement in the diseased plant height, weight, number of leaves, root system, or yield. In general, the term refers to the improvement in a diseased plant physiological state.

The term “inhibit” and all variations of this term is intended to encompass the restriction or prohibition of bacterial, fungal, viral, nematode, insect, or any other pest growth, as well as spore germination.

The term “eliminate” relates to the substantial eradication or removal of bacteria, fungi, viruses, nematodes, insects, or any other pests by contacting them with the composition of the invention, optionally, according to the methods of the invention described below.

The terms “delay”, “retard” and all variations thereof are intended to encompass the slowing of the progress of bacterial, fungal, viral, nematode, insect, or any other pest growth, and spore germination. The expression “delaying the onset” is interpreted as preventing or slowing the progression of bacterial, fungal, viral, nematodes, insect, or any other pest growth, infestation, infection, spore germination and hyphae growth for a period of time, such that said bacterial, fungal, viral, nematode, insect, or any other pest growth, infestation, infection, spore germination and hyphae growth do not progress as far along in development, or appear later than in the absence of the treatment according to the invention.

A plant, plant part, or area of cultivation treated with a combination (applied simultaneously or sequentially) of a bacterial strain provided herein or an active variant thereof and at least one synthetic fungicide selected from the group consisting of tetraconazole, triflumizole, azoxystrobin, flutriafol, tebuconazole, chlorothalonil, and difenoconazole may show a reduced disease severity or reduced disease development in the presence of plant pathogens by a statistically significant amount. A reduced disease severity or reduced disease development can be a reduction of about 10% to about 20%, about 20% to about 30%, about 30% to about 40%, about 40% to about 50%, about 50% to about 60%, about 60% to about 70%, about 70% to about 80%, about 80% to about 90%, or about 90% to about 100% when compared to non-treated control plants. In other instances, the plant treated with a combination (applied simultaneously or sequentially) of a bacterial strain provided herein or an active variant thereof and at least one synthetic fungicide selected from the group consisting of tetraconazole, triflumizole, azoxystrobin, flutriafol, tebuconazole, chlorothalonil, and difenoconazole may show a reduced disease severity or reduced disease development in the presence of plant pathogen at least about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or about 100% greater when compared to non-treated control plants. Methods for assessing plant disease severity are known, and include, measuring percentage of diseased leaf area (Godoy et al. (2006) Fitopatol. Bras. 31(1) 63-68) or by measuring uredinia counts (see Example 1).

By “synergy” or “synergistically” is intended that the combination (applied simultaneously or sequentially) of a bacterial strain provided herein, or an active variant thereof, and a synthetic fungicide selected from the group consisting of tetraconazole, triflumizole, azoxystrobin, flutriafol, tebuconazole, chlorothalonil, and difenoconazole can (in some embodiments) provide a greater control of plant disease or a plant pathogen and/or improvement of at least one agronomic trait of interest than the additive effect of the bacterial strain and the synthetic fungicide applied individually (i.e., in the absence of the other). This synergy can be an increase of 2%, 5%, 7%, 10%, 12%, 15%, 17%, 20%, 25%, 30%, 35%, 40%, 45%, 50%, 55%, 60%, 65%, 70%, 75%, 80%, 85%, 90%, 100%, or more above the additive effect of the application of the bacterial strain and the synthetic fungicide alone (i.e., in the absence of the other). In other embodiments, the application (simultaneous or sequential) of a bacterial strain provided herein, or an active variant thereof, and a synthetic fungicide selected from the group consisting of tetraconazole, triflumizole, azoxystrobin, flutriafol, tebuconazole, chlorothalonil, and difenoconazole function synergistically when no control of a plant pathogen or treatment or prevention of a plant disease or improvement of at least one agronomic trait of interest is exhibited when the bacterial strain or synthetic fungicide is used alone, but the application (simultaneous or sequential) of the two results in control of a plant pathogen or treatment or prevention of a plant disease or improvement of at least one agronomic trait of interest.

By “antipathogenic compositions” or “antipathogenic” is intended that the compositions are capable of suppressing, controlling, preventing and/or killing the invading pathogenic organism. In specific embodiments, an antipathogenic composition reduces the disease symptoms resulting from pathogen challenge by a statistically significant amount, including for example, at least about 10% to at least about 20%, at least about 20% to about 50%, at least about 10% to about 60%, at least about 30% to about 70%, at least about 40% to about 80%, or at least about 50% to about 90% or greater. Hence, the methods of the invention can be utilized to protect plants from disease, particularly those diseases that are caused by plant pathogens.

Assays that measure antipathogenic activity are commonly known in the art, as are methods to quantitate disease resistance in plants following pathogen infection. See, for example, U.S. Pat. No. 5,614,395, herein incorporated by reference. Such techniques include, measuring over time, the average lesion diameter, the pathogen biomass, and the overall percentage of decayed plant tissues. For example, a plant having an antipathogenic composition applied to its surface shows a decrease in tissue necrosis (i.e., lesion diameter) or a decrease in plant death following pathogen challenge when compared to a control plant that was not exposed to the antipathogenic composition. Alternatively, antipathogenic activity can be measured by a decrease in pathogen biomass. For example, a plant exposed to an antipathogenic composition is challenged with a pathogen of interest. Over time, tissue samples from the pathogen-inoculated tissues are obtained and RNA is extracted. The percent of a specific pathogen RNA transcript relative to the level of a plant specific transcript allows the level of pathogen biomass to be determined. See, for example, Thomma et al. (1998) Plant Biology 95:15107-15111, herein incorporated by reference.

Furthermore, in vitro antipathogenic assays include, for example, the addition of varying concentrations of the antipathogenic composition to paper disks and placing the disks on agar containing a suspension of the pathogen of interest. Following incubation, clear inhibition zones develop around the discs that contain an effective concentration of the antipathogenic composition (Liu et al. (1994) Plant Biology 91:1888-1892, herein incorporated by reference). Additionally, microspectrophotometrical analysis can be used to measure the in vitro antipathogenic properties of a composition (Hu et al. (1997) Plant Mol. Biol. 34:949-959 and Cammue et al. (1992) J. Biol. Chem. 267: 2228-2233, both of which are herein incorporated by reference).

C. Methods of Inducing Disease Resistance in Plants and/or for Improving Plant Health and/or Improving an Agronomic Trait of Interest

Compositions and methods for inducing disease resistance in a plant to plant pathogens are also provided. Accordingly, the compositions and methods are also useful in protecting plants against fungal and/or fungal-like pathogens, viruses, nematodes, and insects. Provided herein are methods of inducing disease resistance against a plant pathogen comprising applying to a plant that is susceptible to a plant disease caused by the plant pathogen an effective amount of a combination (applied simultaneously or sequentially) of at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof. In certain embodiments, the bacterial strain provided herein or active variant thereof may comprise at least one of AIP1620, AIP050999, and CGA267356, or an active variant of any thereof; or a combination of cells from any one of AIP1620, AIP050999, and CGA267356, or an active variant of any thereof. In certain embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole with the bacterial strain provided herein or active variant thereof promotes at least an additive defensive response to the pathogen that causes the plant disease. In some embodiments, the effective amount of the combination comprises a bacterial strain provided herein or active variant thereof in combination with a synthetic fungicide selected from the group consisting of tetraconazole, triflumizole, azoxystrobin, flutriafol, tebuconazole, chlorothalonil, and difenoconazole in a weight ratio (lb/lb) disclosed herein for the selected synthetic fungicide. The application rate of the synthetic fungicide disclosed herein can be calculated based on the rate of the bacterial strain, or active variant thereof, according to the selected active ingredient weight ratio as disclosed elsewhere herein for each selected synthetic fungicide. In particular embodiments, the combination comprises at least about 400 μg pyrrolnitrin per gram of bacterial cells.

A defensive response in the plant can be triggered after applying the combination (applied simultaneously or sequentially) of at least one synthetic fungicide selected from the group consisting of tetraconazole, triflumizole, azoxystrobin, flutriafol, tebuconazole, chlorothalonil, and difenoconazole and a bacterial strain provided herein or active variant thereof to the plant, but prior to pathogen challenge and/or after pathogen challenge of the plant treated with the combination of at least one synthetic fungicide selected from the group consisting of tetraconazole, triflumizole, azoxystrobin, flutriafol, tebuconazole, chlorothalonil, and difenoconazole and a bacterial strain provided herein or active variant thereof.

In some methods, the combination (applied simultaneously or sequentially) of at least one synthetic fungicide selected from the group consisting of tetraconazole, triflumizole, azoxystrobin, flutriafol, tebuconazole, chlorothalonil, and difenoconazole with a bacterial strain provided herein or active variant thereof induces resistance to one, two, three, four, five or more plant pathogens described herein. In other methods, the bacterial strain provided herein or active variant thereof and at least one synthetic fungicide selected from the group consisting of tetraconazole, triflumizole, azoxystrobin, flutriafol, tebuconazole, chlorothalonil, and difenoconazole (applied simultaneously or sequentially) induces resistance to one, two, three, four, five or more fungal and/or fungal-like plant pathogens described herein.

By “disease resistance” is intended that the plants avoid the disease symptoms that result from plant-pathogen interactions. That is, pathogens are prevented from causing plant diseases and the associated disease symptoms, or alternatively, the disease symptoms caused by the pathogen are minimized or lessened as compared to a control. Further provided are methods of improving plant health and/or improving an agronomic trait of interest comprising applying to a plant an effective amount of a combination (applied simultaneously or sequentially) of at least one synthetic fungicide selected from the group consisting of tetraconazole, triflumizole, azoxystrobin, flutriafol, tebuconazole, chlorothalonil, and difenoconazole and at least one bacterial strain provided herein or an active variant thereof or an active derivative thereof. In certain embodiments, the bacterial strain provided herein or active variant thereof may comprise at least one of AIP1620, AIP050999, and CGA267356, or an active variant of any thereof, or a combination of cells from any one of AIP1620, AIP050999, and CGA267356, or an active variant of any thereof. In some embodiments, the effective amount of the combination (applied simultaneously or sequentially) comprises a bacterial strain provided herein or active variant thereof in combination with a synthetic fungicide selected from the group consisting of tetraconazole, triflumizole, azoxystrobin, flutriafol, tebuconazole, chlorothalonil, and difenoconazole in a weight ratio (lb/lb) disclosed herein for the selected synthetic fungicide. The application rate of the synthetic fungicide disclosed herein can be calculated based on the rate of the bacterial strain, or active variant thereof, according to the selected active ingredient weight ratio as disclosed elsewhere herein for each selected synthetic fungicide. In particular embodiments, the combination comprises at least about 400 μg pyrrolnitrin per gram of bacterial cells.

By “improved plant health” is meant increased growth and/or yield of a plant, increased stress tolerance and/or decreased herbicide resistance, to name a few. Increased stress tolerance refers to an increase in the ability of a plant to decrease or prevent symptoms associated with one or more stresses. The stress can be a biotic stress that occurs as a result of damage done to plants by other living organisms such as a pathogen (for example, bacteria, viruses, fungi, parasites), insects, nematodes, weeds, cultivated or native plants. The stress can also be an abiotic stress such as extreme temperatures (high or low), high winds, drought, salinity, chemical toxicity, oxidative stress, flood, tornadoes, wildfires, radiation and exposure to heavy metals. Non-limiting examples of improved agronomic traits are disclosed elsewhere herein. In specific embodiments, an effective amount of the combination (applied simultaneously or sequentially) of at least one synthetic fungicide selected from the group consisting of tetraconazole, triflumizole, azoxystrobin, flutriafol, tebuconazole, chlorothalonil, and difenoconazole, and the bacterial strain or active variant thereof improves plant health or improves an agronomic trait of interest by at least an additive amount. In other embodiments, an effective amount of the combination (applied simultaneously or sequentially) of a synthetic fungicide selected from the group consisting of tetraconazole, triflumizole, azoxystrobin, flutriafol, tebuconazole, chlorothalonil, and difenoconazole and the bacterial strain or active variant thereof improves plant health or improves an agronomic trait of interest by a synergistic amount, including for example, at least about 10% to at least about 20%, at least about 20% to about 50%, at least about 10% to about 60%, at least about 30% to about 70%, at least about 40% to about 80%, or at least about 50% to about 90% or greater than the additive effect of the synthetic fungicide (i.e., tetraconazole, triflumizole, azoxystrobin, flutriafol, tebuconazole, chlorothalonil, or difenoconazole) and the bacterial strain applied alone.

D. Methods of Application to a Plant or Plant Part

The combination of a bacterial strain provided herein or active variant thereof and at least one synthetic fungicide selected from the group consisting of tetraconazole, triflumizole, azoxystrobin, flutriafol, tebuconazole, chlorothalonil, and difenoconazole is applied (simultaneously or sequentially) in an effective amount. In specific embodiments, the effective amount of the combination comprises an amount of the synthetic fungicide (i.e., tetraconazole, triflumizole, azoxystrobin, flutriafol, tebuconazole, chlorothalonil, or difenoconazole) and/or the bacterial strain provided herein that is lower than the suggested use or standard use in the art. An effective amount of a combination (applied simultaneously or sequentially) of at least one synthetic fungicide selected from the group consisting of tetraconazole, triflumizole, azoxystrobin, flutriafol, tebuconazole, chlorothalonil, and difenoconazole and bacterial strain provided herein or active variant thereof is an amount sufficient to control, treat, prevent, inhibit the pathogen that causes a plant disease, and/or reduce plant disease severity or reduce plant disease development when applied at an application rate lower than the suggested use or standard use. In other embodiments, the effective amount of a combination (applied simultaneously or sequentially) of at least one synthetic fungicide selected from the group consisting of tetraconazole, triflumizole, azoxystrobin, flutriafol, tebuconazole, chlorothalonil, and difenoconazole and a bacterial strain provided herein or active variant thereof is an amount sufficient to improve an agronomic trait of interest and/or to promote or increase plant health, growth or yield of a plant susceptible to a disease when used at an effective amount lower than the suggested use or standard use. The rate of application or amount of at least one synthetic fungicide selected from the group consisting of tetraconazole, triflumizole, azoxystrobin, flutriafol, tebuconazole, chlorothalonil, and difenoconazole and/or the bacterial strain provided herein or active variant thereof may vary according to the pathogen being targeted, the crop or plant to be protected, the efficacy of the bacterial strain provided herein or active variant thereof, the severity of the disease, the climate conditions, the agronomic trait of interest to improve, and the like.

In specific embodiments, for a field inoculation, the standard or suggested use of bacterial strain AIP1620 is about 2.5 lb/acre wherein the composition. In specific embodiments, when applying a bacterial strain or an active variant thereof in combination (simultaneously or sequentially) with at least one synthetic fungicide selected from the group consisting of tetraconazole, triflumizole, azoxystrobin, flutriafol, tebuconazole, chlorothalonil, and difenoconazole, the combination comprises at least about 400 μg pyrrolnitrin per gram of bacterial cells, or about 1.8×10⁵ μg pyrrolnitrin per pound of bacterial cells. In particular embodiments, when applying a bacterial strain or an active variant thereof in combination (simultaneously or sequentially) with at least one synthetic fungicide selected from the group consisting of tetraconazole, triflumizole, azoxystrobin, flutriafol, tebuconazole, chlorothalonil, and difenoconazole, the application amount of AIP1620, or an active variant thereof, can be less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising at least about 400 μg pyrrolnitrin per gram of bacterial cells, or about 1.8×10⁵ μg pyrrolnitrin per pound of bacterial cells. The application rate of the synthetic fungicide disclosed herein can be calculated based on the rate of the bacterial strain, or active variant thereof, according to the selected active ingredient weight ratio as disclosed elsewhere herein for each selected synthetic fungicide.

In specific embodiments, for a field inoculation, the combination of a bacterial strain provided herein or active variant thereof and tetraconazole is applied (simultaneously or sequentially) in an effective amount, wherein the standard or suggested use of bacterial strain AIP1620 is about 2.5 lb/acre in the combination. In some embodiments, when applying a bacterial strain or an active variant thereof in combination (simultaneously or sequentially) with tetraconazole, the application amount of AIP1620, or an active variant thereof, can be less than 8 lb/acre, less than 7 lb/acre, less than 6 lb/acre, less than 5 lb/acre, less than 4 lb/acre, 3 lb/acre, or less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising. In specific embodiments, the combination of a bacterial strain provided herein or active variant thereof and tetraconazole comprises at least about 400 μg pyrrolnitrin per gram of bacterial cells, or about 1.8×10⁵ μg pyrrolnitrin per pound of bacterial cells.

In specific embodiments, for a field inoculation, the combination of a bacterial strain provided herein or active variant thereof and triflumizole is applied (simultaneously or sequentially) in an effective amount, wherein the standard or suggested use of bacterial strain AIP1620 is about 2.5 lb/acre in the combination. In some embodiments, when applying a bacterial strain or an active variant thereof in combination (simultaneously or sequentially) with triflumizole, the application amount of AIP1620, or an active variant thereof, can be less than 8 lb/acre, less than 7 lb/acre, less than 6 lb/acre, less than 5 lb/acre, less than 4 lb/acre, 3 lb/acre, or less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising. In specific embodiments, the combination of a bacterial strain provided herein or active variant thereof and triflumizole comprises at least about 400 μg pyrrolnitrin per gram of bacterial cells, or about 1.8×10⁵ μg pyrrolnitrin per pound of bacterial cells.

In specific embodiments, for a field inoculation, the combination of a bacterial strain provided herein or active variant thereof and azoxystrobin is applied (simultaneously or sequentially) in an effective amount, wherein the standard or suggested use of bacterial strain AIP1620 is about 2.5 lb/acre in the combination. In some embodiments, when applying a bacterial strain or an active variant thereof in combination (simultaneously or sequentially) with azoxystrobin, the application amount of AIP1620, or an active variant thereof, can be less than 8 lb/acre, less than 7 lb/acre, less than 6 lb/acre, less than 5 lb/acre, less than 4 lb/acre, 3 lb/acre, or less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising. In specific embodiments, the combination of a bacterial strain provided herein or active variant thereof and azoxystrobin comprises at least about 400 μg pyrrolnitrin per gram of bacterial cells, or about 1.8×10⁵ μg pyrrolnitrin per pound of bacterial cells.

In specific embodiments, for a field inoculation, the combination of a bacterial strain provided herein or active variant thereof and flutriafol is applied (simultaneously or sequentially) in an effective amount, wherein the standard or suggested use of bacterial strain AIP1620 is about 2.5 lb/acre in the combination. In some embodiments, when applying a bacterial strain or an active variant thereof in combination (simultaneously or sequentially) with flutriafol, the application amount of AIP1620, or an active variant thereof, can be less than 8 lb/acre, less than 7 lb/acre, less than 6 lb/acre, less than 5 lb/acre, less than 4 lb/acre, 3 lb/acre, or less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising. In specific embodiments, the combination of a bacterial strain provided herein or active variant thereof and flutriafol comprises at least about 400 μg pyrrolnitrin per gram of bacterial cells, or about 1.8×10⁵ μg pyrrolnitrin per pound of bacterial cells.

In specific embodiments, for a field inoculation, the combination of a bacterial strain provided herein or active variant thereof and tebuconazole is applied (simultaneously or sequentially) in an effective amount, wherein the standard or suggested use of bacterial strain AIP1620 is about 2.5 lb/acre in the combination. In some embodiments, when applying a bacterial strain or an active variant thereof in combination (simultaneously or sequentially) with tebuconazole, the application amount of AIP1620, or an active variant thereof, can be less than 8 lb/acre, less than 7 lb/acre, less than 6 lb/acre, less than 5 lb/acre, less than 4 lb/acre, 3 lb/acre, or less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising. In specific embodiments, the combination of a bacterial strain provided herein or active variant thereof and tebuconazole comprises at least about 400 μg pyrrolnitrin per gram of bacterial cells, or about 1.8×10⁵ μg pyrrolnitrin per pound of bacterial cells.

In specific embodiments, for a field inoculation, the combination of a bacterial strain provided herein or active variant thereof and chlorothalonil is applied (simultaneously or sequentially) in an effective amount, wherein the standard or suggested use of bacterial strain AIP1620 is about 2.5 lb/acre in the combination. In some embodiments, when applying a bacterial strain or an active variant thereof in combination (simultaneously or sequentially) with chlorothalonil, the application amount of AIP1620, or an active variant thereof, can be less than 8 lb/acre, less than 7 lb/acre, less than 6 lb/acre, less than 5 lb/acre, less than 4 lb/acre, 3 lb/acre, or less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising. In specific embodiments, the combination of a bacterial strain provided herein or active variant thereof and chlorothalonil comprises at least about 400 μg pyrrolnitrin per gram of bacterial cells, or about 1.8×10⁵ μg pyrrolnitrin per pound of bacterial cells.

In specific embodiments, for a field inoculation, the combination of a bacterial strain provided herein or active variant thereof and difenoconazole is applied (simultaneously or sequentially) in an effective amount, wherein the standard or suggested use of bacterial strain AIP1620 is about 2.5 lb/acre in the combination. In some embodiments, when applying a bacterial strain or an active variant thereof in combination (simultaneously or sequentially) with difenoconazole, the application amount of AIP1620, or an active variant thereof, can be less than 8 lb/acre, less than 7 lb/acre, less than 6 lb/acre, less than 5 lb/acre, less than 4 lb/acre, 3 lb/acre, or less than 2.5 lb/acre, such as between about 0.1 lb/acre and 2.49 lb/acre, including but not limited to about 2.49 lb/acre, about 2.45 lb/acre, about 2.4 lb/acre, about 2.3 lb/acre, about 2.2 lb/acre, about 2.1 lb/acre, about 2.0 lb/acre, about 1.9 lb/acre, about 1.8 lb/acre, about 1.7 lb/acre, about 1.6 lb/acre, about 1.5 lb/acre, about 1.4 lb/acre, about 1.3 lb/acre, about 1.2 lb/acre, about 1.1 lb/acre, about 1.0 lb/acre, about 0.9 lb/acre, about 0.8 lb/acre, about 0.7 lb/acre, about 0.6 lb/acre, about 0.5 lb/acre, about 0.4 lb/acre, about 0.3 lb/acre, about 0.2 lb/acre, and about 0.1 lb/acre of a formulation comprising. In specific embodiments, the combination of a bacterial strain provided herein or active variant thereof and difenoconazole comprises at least about 400 μg pyrrolnitrin per gram of bacterial cells, or about 1.8×10⁵ μg pyrrolnitrin per pound of bacterial cells.

The bacterial strain and at least one synthetic fungicide selected from the group consisting of tetraconazole, triflumizole, azoxystrobin, flutriafol, tebuconazole, chlorothalonil, and difenoconazole can be applied (simultaneously or sequentially) as a field inoculation in a weight ratio that results in at least an additive effect.

For example, the bacterial strain, or active variant thereof, can be applied (simultaneously or sequentially) with tetraconazole or flutriafol in an active ingredient weight ratio (lb/lb) of about 1:10 (bacterial strain:synthetic fungicide) to about 1000:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 300:1, about 400:1, about 500:1, about 600:1, about 700:1, about 800:1, about 900:1 or about 1000:1.

In particular embodiments, the bacterial strain, or active variant thereof, can be applied (simultaneously or sequentially) with tetraconazole or flutriafol in an active ingredient weight ratio (lb/lb) of about 1:1 (bacterial strain:synthetic fungicide) to about 100:1, including but not limited to about 1:1, about 2:1, about 5:1, about 10:1, about 15:1, about 20:1, about 25:1, about 30:1, about 35:1, about 40:1, about 45:1, about 50:1, about 55:1, about 60:1, about 61:1, about 62:1, about 62.5:1, about 63:1, about 64:1, about 65:1, about 66:1, about 67:1, about 68:1, about 69:1, about 70:1, about 75:1, about 80:1, about 85:1, about 90:1, about 95:1, and about 100:1.

In other embodiments, the bacterial strain, or active variant thereof, can be applied (simultaneously or sequentially) with azoxystrobin, tebuconazole, or difenoconazole in an active ingredient weight ratio (lb/lb) of about 1:10 (bacterial strain:synthetic fungicide) to about 500:1, about 1:5 to about 100:1, about 1:5 to about 75:1, about 1:5 to about 50:1, about 1:5 to about 20:1, about 1:1 to about 100:1, about 1:1 to about 75:1, about 1:1 to about 50:1, or about 1:1 to about 20:1, including but not limited to about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 40:1, about 50:1, about 60:1, about 70:1, about 80:1, about 90:1, about 100:1, about 150:1, about 200:1, about 250:1, about 300:1, about 350:1, about 400:1, about 450:1, or about 500:1.

In particular embodiments, the bacterial strain, or active variant thereof, can be applied (simultaneously or sequentially) with azoxystrobin in an active ingredient weight ratio (lb/lb) of about 1:1 (bacterial strain:synthetic fungicide) to about 25:1 or about 1:1 to about 20:1, including but not limited to about 1:1, about 1.5:1, about 2:1, about 2.5:1, about 3:1, about 3.5:1, about 4:1, about 4.5:1, about 5:1, about 5.5:1, about 6:1, about 6.1:1, about 6.2:1, about 6.3:1, about 6.4:1, about 6.5:1, about 6.6:1, about 6.7:1, about 6.8:1, about 6.9:1, about 7:1, about 7.1:1, about 7.2:1, about 7.3:1, about 7.4:1, about 7.5:1, about 7.6:1, about 7.7:1, about 7.8:1, about 7.9:1, about 8:1, about 8.5:1, about 9:1, about 9.5:1, about 10:1, about 10.5:1, about 11:1, about 11.5:1, about 12:1, about 12.5:1, about 13:1, about 13.5:1, about 14:1, about 14.5:1, about 15:1, about 16:1, about 17:1, about 18:1, about 19:1, about 20:1, about 21:1, about 22:1, about 23:1, about 24:1, and about 25:1.

In particular embodiments, the bacterial strain, or active variant thereof, can be applied (simultaneously or sequentially) with tebuconazole in an active ingredient weight ratio (lb/lb) of about 1:1 (bacterial strain:synthetic fungicide) to about 50:1, including but not limited to about 1:1, about 3:1, about 5:1, about 7:1, about 9:1, about 11:1, about 13:1, about 15:1, about 17:1, about 17.5:1, about 18:1, about 18.5:1, about 19:1, about 19.5:1, about 20:1, about 16:1, about 17:1, about 18:1, about 19:1, about 19.1:1, about 19.2:1, about 19.3:1, about 19.4:1, about 19.5:1, about 19.6:1, about 19.7:1, about 19.8:1, about 19.9:1, about 20:1, about 20.25:1, about 20.5:1, about 20.75:1, about 21:1, about 21.25:1, about 21.5:1, about 21.75:1, about 22:1, about 22.2:1, about 22.22:1, about 22.25:1, about 22.5:1, about 22.75:1, about 23:1, about 23.25:1, about 23.5:1, about 23.75:1, about 24:1, about 24.25:1, about 24.5:1, about 24.75:1, about 25:1, about 25.5:1, about 26:1, about 26.5:1, about 27:1, about 27.5:1, about 28:1, about 29:1, about 30:1, about 32:1, about 34:1, about 36:1, about 38:1, about 40:1, about 45:1, and about 50:1. In certain embodiments, the bacterial strain, or active variant thereof, can be applied (simultaneously or sequentially) with difenoconazole in an active ingredient weight ratio (lb/lb) of about 1:1 (bacterial strain:synthetic fungicide) to about 50:1, about 1:1 to about 40:1, about 10:1 to about 40:1, or about 10:1 to about 30:1, including but not limited to, about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1, about 31:1, about 32:1, about 33:1, about 34:1, about 35.1:1, about 36:1, about 37:1, about 38:1, about 39:1, about 40:1, about 41:1, about 42:1, about 43:1, about 44:1, about 45:1, about 46:1, about 47:1, about 48:1, about 49:1, and about 50:1.

In other embodiments, the bacterial strain, or active variant thereof, can be applied (simultaneously or sequentially) with chlorothalonil in an active ingredient weight ratio (lb/lb) of about 1:100 to about 500:1, including but not limited to, about 1:100, about 1:50, about 1:10, about 1:1, about 10:1, about 50:1, about 100:1, about 150:1, about 200:1, about 250:1, about 300:1, about 350:1, about 400:1, about 450:1, and about 500:1.

In certain embodiments, the bacterial strain, or active variant thereof, can be applied (simultaneously or sequentially) with chlorothalonil in an active ingredient weight ratio (lb/lb) of about 1:10 (bacterial strain:synthetic fungicide) to about 10:1, including but not limited to, about 1:10, about 1:9, about 1:8, about 1:7, about 1:6, about 1:5, about 1:4, about 1:3, about 1:2, about 1:1.9, about 1:1.8, about 1:1.75, about 1:1.7, about 1:1.65, about 1:1.6, about 1:1.55, about 1:1.5, about 1:1.45, about 1:4, about 1:1.35, about 1:1.3, about 1:1.275, about 1:1.25, about 1:1.24, about 1:1.23, about 1:1.22, about 1:1.21, about 1:1.2, about 1:1.19, about 1:1.18, about 1:1.17, about 1:1.16, about 1:1.15, about 1:1.15, about 1:1.1, about 1:1, about 1.1:1, about 1.2:1, about 1.3:1, about 1.4:1, about 1.5:1, about 1.6:1, about 1.7:1, about 1.8:1, about 1.9:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, and about 10:1.

In other embodiments, the bacterial strain, or active variant thereof, can be applied (simultaneously or sequentially) with triflumizole in an active ingredient weight ratio (lb/lb) of about 1:10 (bacterial strain: triflumizole) to about 100:1, including but not limited to, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, or about 100:1 In certain embodiments, the bacterial strain, or active variant thereof, can be applied (simultaneously or sequentially) with triflumizole in an active ingredient weight ratio (lb/lb) of about 1:10 (bacterial strain: triflumizole) to about 25:1 or about 1:10 to about 1:20, including but not limited to about 1:10, about 1:9, about 1:8, about 1:7, about 1:6, about 1:5, about 1:4, about 1:3, about 1:2, about 1:1, about 1.1:1, about 1.2:1, about 1.3:1, about 1.4:1, about 1.5:1, about 1.6:1, about 1.66:1, about 1.7:1, about 1.8:1, about 1.9:1, about 2:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, about 10:1, about 15:1, about 20:1, and about 25:1.

Any appropriate agricultural application rate for a biocide can be applied (simultaneously or sequentially) with the combination of at least one synthetic fungicide selected from the group consisting of tetraconazole, triflumizole, azoxystrobin, flutriafol, tebuconazole, chlorothalonil, and difenoconazole and bacterial strain provided herein or active variant thereof disclosed herein. Methods to assay for the effective amount of the synthetic fungicide (i.e., tetraconazole, triflumizole, azoxystrobin, flutriafol, tebuconazole, chlorothalonil, or difenoconazole) and bacterial strain provided herein or active variant thereof include, for example, the control of the pathogen or pest targeted by the synthetic fungicide (i.e., tetraconazole, triflumizole, azoxystrobin, flutriafol, tebuconazole, chlorothalonil, or difenoconazole) and bacterial strain combination. Methods to assay for such control are known. Moreover, a control of plant health, yield and/or growth that occurs upon application of an effective amount of the synthetic fungicide (i.e., tetraconazole, triflumizole, azoxystrobin, flutriafol, tebuconazole, chlorothalonil, or difenoconazole) and a bacterial strain provided herein or active variant thereof.

Further provided is a method for controlling or inhibiting the growth of a plant pathogen that causes plant disease by applying (simultaneously or sequentially) at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof provided herein (i.e., AIP1620, AIP050999, and CGA267356, or an active variant or any thereof, or a combination of cells from any one of AIP1620, AIP050999, and CGA267356, or an active variant any of thereof). By “applying” is intended contacting an effective amount of the synthetic fungicide and a bacterial strain provided herein or active variant thereof to a plant, area of cultivation, seed and/or weed with one or more of the bacterial strains provided herein or active variant thereof so that a desired effect is achieved. Furthermore, the application of at least one synthetic fungicide selected from the group consisting of tetraconazole, triflumizole, azoxystrobin, flutriafol, tebuconazole, chlorothalonil, and difenoconazole and/or the bacterial strain provided herein or active variant thereof can occur prior to the planting of the crop (for example, to the soil, the seed, or the plant). In a specific embodiment, the application of at least one synthetic fungicide selected from the group consisting of tetraconazole, triflumizole, azoxystrobin, flutriafol, tebuconazole, chlorothalonil, and difenoconazole and/or the bacterial strain provided herein or active variant thereof is a foliar application. Therefore, a further embodiment of the invention provides a method for controlling or inhibiting the growth of a plant pathogen by applying (simultaneously or sequentially) at least one synthetic fungicide selected from the group consisting of tetraconazole, triflumizole, azoxystrobin, flutriafol, tebuconazole, chlorothalonil, and difenoconazole and the population of bacterial strain provided herein or active variant thereof to an environment in which the plant pathogen may grow. The application may be to the plant, to parts of the plant, to the seeds of the plants to be protected, or to the soil in which the plant to be protected are growing or will grow. Application to the plant or plant parts may be before or after harvest. Application to the seeds will be prior to planting of the seeds.

Application (simultaneous or sequential) of at least one synthetic fungicide selected from the group consisting of tetraconazole, triflumizole, azoxystrobin, flutriafol, tebuconazole, chlorothalonil, and difenoconazole can occur before, during, or after application of a bacterial strain provided herein, or active variant thereof. In specific embodiments, application of at least one synthetic fungicide selected from the group consisting of tetraconazole, triflumizole, azoxystrobin, flutriafol, tebuconazole, chlorothalonil, and difenoconazole is alternated with application of a bacterial strain provided herein, or active variant thereof. Application of at least one synthetic fungicide selected from the group consisting of tetraconazole, triflumizole, azoxystrobin, flutriafol, tebuconazole, chlorothalonil, and difenoconazole can alternate with application of a bacterial strain provided herein, or active variant thereof, by 0.5 days, 1 day, 1.5 days, 2 days, 3 days, 4 days, 5 days, 6 days, 7 days, 10 days, 14 days or more. In some embodiments, at least one synthetic fungicide selected from the group consisting of tetraconazole, triflumizole, azoxystrobin, flutriafol, tebuconazole, chlorothalonil, and difenoconazole is applied to a plant, plant part, or cultivation area of a plant, simultaneously with a bacterial strain provided herein, or active variant thereof. Simultaneous application of at least one synthetic fungicide selected from the group consisting of tetraconazole, triflumizole, azoxystrobin, flutriafol, tebuconazole, chlorothalonil, and difenoconazole and a bacterial strain provided herein, or active variant thereof, can occur in the same formulation or simultaneously from separate formulations. In specific embodiments, at least one synthetic fungicide selected from the group consisting of tetraconazole, triflumizole, azoxystrobin, flutriafol, tebuconazole, chlorothalonil, and difenoconazole and a bacterial strain provided herein, or active variant thereof, are formulated in the same composition to be applied as a foliar treatment in the same formulation at an effective amount less than the standard rate of application used for the synthetic fungicide (i.e., tetraconazole, triflumizole, azoxystrobin, flutriafol, tebuconazole, chlorothalonil, or difenoconazole) or the bacterial strain AIP1620, or an active variant thereof, alone.

Sequential application of at least one synthetic fungicide selected from the group consisting of tetraconazole, triflumizole, azoxystrobin, flutriafol, tebuconazole, chlorothalonil, and difenoconazole and a bacterial strain provided herein, or active variant thereof refers to the application of each of the synthetic fungicide and bacterial strain that does not occur simultaneously. Sequential application of two components (in this case, at least one synthetic fungicide selected from the group consisting of tetraconazole, triflumizole, azoxystrobin, flutriafol, tebuconazole, chlorothalonil, and difenoconazole (component a)) and a bacterial strain provided herein, or active variant thereof (component b)) includes the application of component a) before or after component b), wherein the difference in time between application of components a) and b) is greater than 1 minute, including but not limited to 1 minute, 5 minutes, 30 minutes, 1 hour, 2 hours, 5 hours, 10 hours, 1 day, 2 days, 3 days, 4 days, 5 days, 6 days, 7 days, 8 days, 9 days, 10 days, 15 days, 20 days, 1 month, 2 months, 3 months, 4 months, 5 months, 6 months, 7 months, 8 months, 9 months, 10 months, 11 months, 1 year or greater, wherein the timing of the sequential application of the synthetic fungicide selected from the group consisting of tetraconazole, triflumizole, azoxystrobin, flutriafol, tebuconazole, chlorothalonil, and difenoconazole and the bacterial strain provided herein, or active variant thereof is such that an additive effect or synergistic effect (on the controlling of a plant pathogen or treatment or prevention of a plant disease, or an improvement of an agronomic trait) is observed.

In some embodiments, an effective amount of a combination (applied simultaneously or sequentially) of at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof provided herein is used as a foliar application to control or inhibit growth of one or more pathogens selected from the group consisting of Alternaria spp., Alternaria solani, Colletotrichum spp., Mycosphaerella spp., Phomopsis spp., Pseudoperonospora spp., Podosphaera spp., Cercospora spp., Corynespora spp., Gleocercospora spp., Sclerotinia spp., Bremia spp., Botrytis spp., and Botrytis cinerea.

In other embodiments, an effective amount of a combination of at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof provided herein is applied (simultaneously or sequentially) to the soil in which the plant to be protected are growing or will grow to control or inhibit growth of one or more pathogens selected from the group consisting of Rhizoctonia spp., Rhizoctonia solani, Fusarium spp., Sclerotium spp., Sclerotinia spp., Sclerotinia sclerotiorum, Phytophthora spp., and Pythium spp.

In some embodiments, an effective amount of a combination of at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof provided herein is applied (simultaneously or sequentially) to the plant after harvest to control or inhibit growth of one or more pathogens selected from the group consisting of Monolinia spp., Penicillium spp., Botrytis ssp., and Botrytis cinerea.

As used herein, the term plant includes plant cells, plant protoplasts, plant cell tissue cultures from which plants can be regenerated, plant calli, plant clumps, and plant cells that are intact in plants or parts of plants such as embryos, pollen, ovules, seeds, leaves, flowers, branches, fruit, kernels, ears, cobs, husks, stalks, roots, root tips, anthers, and the like. Grain is intended to mean the mature seed produced by commercial growers for purposes other than growing or reproducing the species.

A plant or plant part is provided having an effective amount of a combination of at least one synthetic fungicide selected from the group consisting of tetraconazole, triflumizole, azoxystrobin, flutriafol, tebuconazole, chlorothalonil, and difenoconazole and the bacterial strain provided herein or active variant thereof (i.e., AIP1620, AIP050999, and CGA267356, or an active variant of any thereof, or a combination of cells), applied to the surface of the plant or plant part. The combination of bacterial strain, or active variant thereof, and synthetic fungicide applied to the surface of the plant or plant part can be in the form a composition or formulation as disclosed elsewhere herein. In specific embodiments an effective amount of the combination is applied to a plant that has been removed from the field or area of cultivation or applied to a plant part that has been removed from a plant. In some embodiments, en effective amount of the combination disclosed herein can be applied to the surface of a seed of a plant. In some embodiments, the effective amount of the combination comprises a bacterial strain provided herein or active variant thereof in combination with a synthetic fungicide selected from the group consisting of tetraconazole, triflumizole, azoxystrobin, flutriafol, tebuconazole, chlorothalonil, and difenoconazole in a weight ratio (lb/lb) disclosed herein for the selected synthetic fungicide. In particular embodiments, the combination comprises at least about 400 μg pyrrolnitrin per gram of bacterial cells (e.g., bacterial cells in the combination) on the surface of the plant or plant part. In specific embodiments, a combination of at least one synthetic fungicide selected from the group consisting of tetraconazole, triflumizole, azoxystrobin, flutriafol, tebuconazole, chlorothalonil, and difenoconazole and the bacterial strain provided herein or active variant thereof (i.e., AIP1620, AIP050999, and CGA267356, or an active variant of any thereof, or a combination of cells, is applied (simultaneously or sequentially) to the leaves of a soybean plant. The timing of application can vary depending on the conditions and geographical location. In specific embodiments, the combination (applied simultaneously or sequentially) of at least one synthetic fungicide selected from the group consisting of tetraconazole, triflumizole, azoxystrobin, flutriafol, tebuconazole, chlorothalonil, and difenoconazole and the bacterial strain provided herein or active variant thereof is applied at the RI (beginning flowering stage) of soybean development or may be applied earlier depending on ASR onset and the disease severity.

Various methods are provided for controlling a plant pathogen that causes a plant disease in an area of cultivation containing a plant susceptible to the plant disease. Such methods can comprise controlling a plant pathogen or population thereof in an area of cultivation by contacting the plant pathogen or population thereof with a combination (applied simultaneously or sequentially) of at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof (i.e., AIP1620, AIP050999, and CGA267356, or an active derivative or any thereof, or a combination of cells from any one of AIP1620, AIP050999, and CGA267356, or an active variant thereof). A method for controlling a plant pathogen in an area of cultivation can comprise planting the area of cultivation with seeds or plants susceptible to the plant disease; and applying (simultaneously or sequentially) to the plant susceptible to the disease, the seed or the area of cultivation of the plant susceptible to the plant disease an effective amount of a combination of at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof (i.e., AIP1620, AIP050999, and CGA267356, or an active derivative or any thereof, or a combination of cells from any one of AIP1620, AIP050999, and CGA267356, or an active variant thereof), wherein the combination controls the plant disease without significantly affecting the crop or plant.

Further provided is a method for growing a plant susceptible to a plant disease. The method comprises applying (simultaneously or sequentially) to a plant susceptible to the disease, a seed, or an area of cultivation of the plant susceptible to the disease an effective amount of a combination of at least one synthetic fungicide selected from the group consisting of tetraconazole, triflumizole, azoxystrobin, flutriafol, tebuconazole, chlorothalonil, and difenoconazole and at least one bacterial strain provided herein or active variant thereof. In certain embodiments, the bacterial strain provided herein or active variant thereof may comprise at least one of AIP1620, AIP050999, and CGA267356, or an active variant of any thereof, or a combination of cells from any one of AIP1620, AIP050999, and CGA267356, or an active variant of any thereof. Various effective amounts of at least one synthetic fungicide selected from the group consisting of tetraconazole, triflumizole, azoxystrobin, flutriafol, tebuconazole, chlorothalonil, and difenoconazole and bacterial strains provided herein or active variants thereof are disclosed elsewhere herein and in one, non-limiting example, the effective amount of the combination comprises a weight ratio (lb/lb) disclosed herein for the selected synthetic fungicide. The application rate of the synthetic fungicide disclosed herein can be calculated based on the application rate of the bacterial strain, or active variant thereof, according to the selected active ingredient weight ratio as disclosed elsewhere herein for each selected synthetic fungicide. In particular embodiments, an effective amount of the combination comprises at least about 400 μg pyrrolnitrin per gram of bacterial cells (e.g., bacterial cells in the combination).

Methods are provided for controlling a plant pathogen or plant pest on a plant or plant part by applying to the plant or plant part an effective amount of a combination of at least one synthetic fungicide selected from the group consisting of tetraconazole, triflumizole, azoxystrobin, flutriafol, tebuconazole, chlorothalonil, and difenoconazole and the bacterial strain provided herein or active variant thereof (i.e., AIP1620, AIP050999, and CGA267356, or an active variant of any thereof, or a combination of cells). The composition comprising the bacterial strain or active variant thereof can be a solid or liquid composition or formulation. The plant or plant part need not be actively growing in order for the bacterial strain to effectively control the plant pathogen or plant pest. In specific embodiments, the plant or plant part has been harvested or otherwise removed from the field or area of cultivation. An effective amount of the combination of bacterial strain, or active variant thereof, and synthetic fungicide can be applied to a plant or plant part prior to harvesting or after the plant or plant part has been harvested. As used herein, the term harvesting refers to the removal of a plant or plant part from the ground or other area of cultivation and can also refer to removal of a plant part from a plant that remains in the ground or other area of cultivation. In some embodiments, the effective amount of the combination comprises a bacterial strain provided herein or active variant thereof in combination with a synthetic fungicide selected from the group consisting of tetraconazole, triflumizole, azoxystrobin, flutriafol, tebuconazole, chlorothalonil, and difenoconazole in a weight ratio (lb/lb) disclosed herein for the selected synthetic fungicide. In particular embodiments, an effective amount of the combination comprises at least about 400 μg pyrrolnitrin per gram of bacterial cells (e.g., bacterial cells in the combination).

Methods for increasing plant yield are provided. The “yield” of the plant refers to the quality and/or quantity of biomass produced by the plant. By “biomass” is intended any measured plant product. An increase in biomass production is any improvement in the yield of the measured plant product. An increase in yield can comprise any statistically significant increase including, but not limited to, at least a 1% increase, at least a 3% increase, at least a 5% increase, at least a 10% increase, at least a 20% increase, at least a 30%, at least a 50%, at least a 70%, at least a 100% or a greater increase in yield compared to a plant not exposed to the bacterial strain provided herein or active variant thereof. A method for increasing yield in a plant is also provided and comprises applying (simultaneously or sequentially) to a crop, a plant, or an area of cultivation an effective amount of a combination of at least one synthetic fungicide selected from the group consisting of tetraconazole, triflumizole, azoxystrobin, flutriafol, tebuconazole, chlorothalonil, and difenoconazole and at least one bacterial strain comprising AIP1620, AIP050999, and CGA267356, or an active variant of any thereof, or a combination of cells from any one of AIP1620, AIP050999, and CGA267356, or an active variant of any thereof, wherein said combination is provided in a weight ratio (lb/lb) disclosed herein for the selected synthetic fungicide and wherein said composition controls a plant pathogen, thereby increasing yield. In particular embodiments, an effective amount of the combination comprises at least about 400 μg pyrrolnitrin per gram of bacterial cells (e.g., bacterial cells in the combination).

As used herein, an “area of cultivation” comprises any region in which one desires to grow a plant. Such areas of cultivations include, but are not limited to, a field in which a plant is cultivated (such as a crop field, a plant field, a sod field, a tree field, a managed forest, a field for culturing fruits and vegetables, etc.), a greenhouse, a growth chamber, etc.

In particular embodiments, a plant of interest (i.e., plant susceptible to the plant disease) and/or the area of cultivation comprising the plant, can be treated with an effective amount of a combination (applied simultaneously or sequentially) of a bacterial strain provided herein or active variant thereof and at least one synthetic fungicide selected from the group consisting of tetraconazole, triflumizole, azoxystrobin, flutriafol, tebuconazole, chlorothalonil, and difenoconazole. By “treated with a combination of” or “applying a combination of” a bacterial strain provided herein or active variant thereof and a biocide to a plant, area of cultivation or field it is intended that one or more of a particular field, plant, and/or weed is treated (applied simultaneously or sequentially) with an effective amount of one or more of the bacterial strain provided herein or active variant thereof and one or more biocide so that a desired effect is achieved. Furthermore, the application of one or both of the bacterial strain provided herein or active variant thereof and the biocide can occur prior to the planting of the crop (for example, to the soil, or the plant). Moreover, the application of the bacterial strain provided herein or active variant thereof and the biocide may be simultaneous or the applications may be at different times (sequential), so long as the desired effect is achieved.

In one non-limiting embodiment, the active variant comprises a bacterial strain provided herein that is resistant to one or more biocide. In specific embodiments, the bacterial strain provided herein or active variant thereof (i.e., AIP1620, AIP050999, and CGA267356, or an active variant of any thereof, or a combination of cells from any one of AIP1620, AIP050999, and CGA267356, or an active variant of any thereof) is resistant to glyphosate. In such methods, a plant, crop, or area of cultivation is treated (simultaneously or sequentially) with an effective amount of a combination of at least one synthetic fungicide selected from the group consisting of tetraconazole, triflumizole, azoxystrobin, flutriafol, tebuconazole, chlorothalonil, and difenoconazole and a bacterial strain provided herein or active variant thereof that is resistant to glyphosate, and an effective amount of glyphosate, wherein the effective amount of glyphosate is such as to selectively control weeds while the crop or plant is not significantly damaged.

In another non-limiting embodiment, the active variant comprises a bacterial strain provided herein that is resistant to glufosinate. In such methods, a plant, crop, or area of cultivation is treated (simultaneously or sequentially) with an effective amount of a combination of at least one synthetic fungicide selected from the group consisting of tetraconazole, triflumizole, azoxystrobin, flutriafol, tebuconazole, chlorothalonil, and difenoconazole and a bacterial strain provided herein or active variant thereof that is resistant to glufosinate, and an effective amount of glufosinate, wherein the effective amount of glufosinate is such as to selectively control weeds while the crop or plant is not significantly damaged. In such embodiments, the effective amount of at least one synthetic fungicide selected from the group consisting of tetraconazole, triflumizole, azoxystrobin, flutriafol, tebuconazole, chlorothalonil, and difenoconazole and the bacterial strain provided herein or active variant thereof is sufficient to result in an improvement in plant health, yield, and/or growth when compared to the plant health, yield, and/or growth that occurs when the same concentration of the synthetic fungicide and bacterial strain provided herein or active variant thereof that was not modified to be resistant to glufosinate is applied in combination with the effective amount of the glufosinate or active derivative thereof. In a further embodiment, the effective amount comprises a bacterial strain provided herein or active variant thereof such as AIP1620, AIP050999, and CGA267356, or an active variant of any thereof, or a combination of cells from any one of AIP1620, AIP050999, and CGA267356, or an active variant of any thereof.

V. Biocides for Use in Combination with the Bacterial Strains Provided Herein or Active Variants Thereof

As discussed elsewhere herein, the bacterial strain provided herein or active variant thereof can be used in combination (applied simultaneously or sequentially) with at least one synthetic fungicide selected from the group consisting of tetraconazole, triflumizole, azoxystrobin, flutriafol, tebuconazole, chlorothalonil, and difenoconazole and another biocide (i.e., a herbicide, fungicide, pesticide, or other crop protection chemical). In such instances, the bacterial strain provided herein or active variant thereof is compatible with the additional biocide of interest.

By “herbicide, fungicide, pesticide, or other crop protection chemical tolerance or herbicide, fungicide, pesticide, or other crop protection chemical resistance” is intended the ability of an organism (i.e., the plant and/or the bacterial strain provided herein or active variant thereof etc.) to survive and reproduce following exposure to a dose of the herbicide, fungicide, pesticide, or other crop protection chemical that is normally lethal to the wild type organism.

Herbicides that can be used in the various methods and compositions disclosed herein include glyphosate, ACCase inhibitors (Arloxyphenoxy propionate (FOPS)); ALS inhibitors (Sulfonylurea (SU)), Imidazonlinone (IMI), Pyrimidines (PM)); microtubule protein inhibitor (Dinitroaniline (DNA)); synthetic auxins (Phenoxy (P)), Benzoic Acid (BA), Carboxylic acid (CA)); Photosystem II inhibitor (Triazine (TZ)), Triazinone (TN), Nitriles (NT), Benzothiadiazinones (BZ), Ureas (US)); EPSP Synthase inhibitor (glycines (GC)); Glutamine Synthesis inhibitor (Phosphinic Acid (PA)); DOXP synthase inhibitor (Isoxazolidinone (IA)); HPPD inhibitor (Pyrazole (PA)), Triketone (TE)); PPO inhibitors (Diphenylether (DE), N-phenylphthalimide (NP) (Ary triazinone (AT)); VLFA inhibitors (chloroacetamide (CA)), Oxyacetamide (OA)); Photosystem I inhibitor (Bipyridyliums (BP)); and the like.

Pesticides that can be used in the various methods and compositions disclosed herein include imidacloprid clothianidin, arylpyrazole compounds (WO2007103076); organophosphates, phenyl pyrazole, pyrethoids caramoyloximes, pyrazoles, amidines, halogenated hydrocarbons, carbamates and derivatives thereof, terbufos, chloropyrifos, fipronil, chlorethoxyfos, telfuthrin, carbofuran, imidacloprid, tebupirimfos (U.S. Pat. No. 5,849,320).

Additional fungicides that can be used in the various methods and compositions disclosed herein include aliphatic nitrogen fungicides (butylamine, cymoxanil, dodicin, dodine, guazatine, iminoctadine); amide fungicides (benzovindiflupyr, carpropamid, chloraniformethan, cyflufenamid, diclocymet, diclocymet, dimoxystrobin, fenaminstrobin, fenoxanil, flumetover, furametpyr, isofetamid, isopyrazam, mandestrobin, mandipropamid, metominostrobin, orysastrobin, penthiopyrad, prochloraz, quinazamid, silthiofam, triforine); acylamino acid fungicides (benalaxyl, benalaxyl-M, furalaxyl, metalaxyl, metalaxyl-M, pefurazoate, valifenalate); anilide fungicides (benalaxyl, benalaxyl-M, bixafen, boscalid, carboxin, fenhexamid, fluxapyroxad, isotianil, metalaxyl, metalaxyl-M, metsulfovax, ofurace, oxadixyl, oxycarboxin, penflufen, pyracarbolid, sedaxane, thifluzamide, tiadinil, vanguard); benzanilide fungicides (benodanil, flutolanil, mebenil, mepronil, salicylanilide, tecloftalam); furanilide fungicides (fenfuram, furalaxyl, furcarbanil, methfuroxam); sulfonanilide fungicides (flusulfamide); benzamide fungicides (benzohydroxamic acid, fluopicolide, fluopyram, tioxymid, trichlamide, zarilamid, zoxamide); furamide fungicides (cyclafuramid, furmecyclox); phenylsulfamide fungicides (dichlofluanid, tolylfluanid); sulfonamide fungicides (amisulbrom, cyazofamid); valinamide fungicides (benthiavalicarb, iprovalicarb); antibiotic fungicides (aureofungin, blasticidin-S, cycloheximide, griseofulvin, kasugamycin, moroxydine, natamycin, polyoxins, polyoxorim, streptomycin, validamycin); strobilurin fungicides (fluoxastrobin, mandestrobin); other methoxyacrylate strobilurin fungicides (bifujunzhi, coumoxystrobin, enoxastrobin, flufenoxystrobin, jiaxiangjunzhi, picoxystrobin, pyraoxystrobin); methoxycarbanilate strobilurin fungicides (pyraclostrobin, pyrametostrobin, triclopyricarb); methoxyiminoacetamide strobilurin fungicides (dimoxystrobin, fenaminstrobin, metominostrobin, orysastrobin); methoxyiminoacetate strobilurin fungicides (kresoxim-methyl, trifloxystrobin); other aromatic fungicides (biphenyl, chlorodinitronaphthalenes, chloroneb, cresol, dicloran, fenjuntong, hexachlorobenzene, pentachlorophenol, quintozene, sodium pentachlorophenoxide, tecnazene, trichlorotrinitrobenzenes); arsenical fungicides (asomate, urbacide); aryl phenyl ketone fungicides (metrafenone, pyriofenone); benzimidazole fungicides (albendazole, benomyl, carbendazim, chlorfenazole, cypendazole, debacarb, fuberidazole, mecarbinzid, rabenzazole, thiabendazole); benzimidazole precursor fungicides (furophanate, thiophanate, thiophanate-methyl); benzothiazole fungicides (bentaluron, benthiavalicarb, benthiazole, chlobenthiazone, probenazole); botanical fungicides (allicin, berberine, carvacrol, carvone, osthol, sanguinarine, santonin); bridged diphenyl fungicides (bithionol, dichlorophen, diphenylamine, hexachlorophene, parinol); carbamate fungicides (benthiavalicarb, furophanate, iodocarb, iprovalicarb, picarbutrazox, propamocarb, pyribencarb, thiophanate, thiophanate-methyl, tolprocarb); benzimidazolylcarbamate fungicides (albendazole, benomyl, carbendazim, cypendazole, debacarb, mecarbinzid); carbanilate fungicides (diethofencarb, pyraclostrobin, pyrametostrobin, triclopyricarb); other conazole fungicides, other conazole fungicides (imidazoles) (climbazole, clotrimazole, imazalil, oxpoconazole, prochloraz); other conazole fungicides (triazoles) (azaconazole, bromuconazole, cyproconazole, diclobutrazol, diniconazole, diniconazole-M, epoxiconazole, etaconazole, fenbuconazole, fluquinconazole, flusilazole, furconazole, furconazole-cis, hexaconazole, imibenconazole, ipconazole, metconazole, myclobutanil, penconazole, propiconazole, prothioconazole, quinconazole, simeconazole, triadimefon, triadimenol, triticonazole, uniconazole, uniconazole-P); copper fungicides (acypetacs-copper, Bordeaux mixture, Burgundy mixture, Cheshunt mixture, copper acetate, copper carbonate, basic, copper hydroxide, copper naphthenate, copper oleate, copper oxychloride, copper silicate, copper sulfate, copper sulfate, basic, copper zinc chromate, cufraneb, cuprobam, cuprous oxide, mancopper, oxine-copper, saisentong, thiodiazole-copper); cyanoacrylate fungicides (benzamacril, phenamacril); dicarboximide fungicides (famoxadone, fluoroimide); dichlorophenyl dicarboximide fungicides (chlozolinate, dichlozoline, iprodione, isovaledione, myclozolin, procymidone, vinclozolin); phthalimide fungicides (captafol, captan, ditalimfos, folpet, thiochlorfenphim); dinitrophenol fungicides (binapacryl, dinobuton, dinocap, dinocap-4, dinocap-6, meptyldinocap, dinocton, dinopenton, dinosulfon, dinoterbon, DNOC); dithiocarbamate fungicides (amobam, asomate, azithiram, carbamorph, cufraneb, cuprobam, disulfiram, ferbam, metam, nabam, tecoram, thiram, urbacide, ziram); cyclic dithiocarbamate fungicides (dazomet, etem, milneb); polymeric dithiocarbamate fungicides (mancopper, mancozeb, maneb, metiram, polycarbamate, propineb, zineb); dithiolane fungicides (isoprothiolane, saijunmao); fumigant fungicides (carbon disulfide, cyanogen, dithioether, methyl bromide, methyl iodide, sodium tetrathiocarbonate); hydrazide fungicides (benquinox, saijunmao); imidazole fungicides (cyazofamid, fenamidone, fenapanil, glyodin, iprodione, isovaledione, pefurazoate, triazoxide); conazole fungicides (imidazoles) (climbazole, clotrimazole, imazalil, oxpoconazole, prochloraz, triflumizole); inorganic fungicides (potassium azide, potassium thiocyanate, sodium azide, sulfur, see also copper fungicides, see also inorganic mercury fungicides); mercury fungicides; inorganic mercury fungicides (mercuric chloride, mercuric oxide, mercurous chloride); organomercury fungicides ((3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate); morpholine fungicides (aldimorph, benzamorf, carbamorph, dimethomorph, dodemorph, fenpropimorph, flumorph, tridemorph); organophosphorus fungicides (ampropylfos, ditalimfos, EBP, edifenphos, fosetyl, hexylthiofos, inezin, iprobenfos, izopamfos, kejunlin, phosdiphen, pyrazophos, tolclofos-methyl, triamiphos); organotin fungicides (decafentin, fentin, tributyltin oxide); oxathiin fungicides (carboxin, oxycarboxin); oxazole fungicides (chlozolinate, dichlozoline, drazoxolon, famoxadone, hymexazol, metazoxolon, myclozolin, oxadixyl, oxathiapiprolin, pyrisoxazole, vinclozolin); polysulfide fungicides (barium polysulfide, calcium polysulfide, potassium polysulfide, sodium polysulfide); pyrazole fungicides (benzovindiflupyr, bixafen, fenpyrazamine, fluxapyroxad, furametpyr, isopyrazam, oxathiapiprolin, penflufen, penthiopyrad, pyraclostrobin, pyrametostrobin, pyraoxystrobin, rabenzazole, sedaxane); pyridine fungicides (boscalid, buthiobate, dipyrithione, fluazinam, fluopicolide, fluopyram, parinol, picarbutrazox, pyribencarb, pyridinitril, pyrifenox, pyrisoxazole, pyroxychlor, pyroxyfur, triclopyricarb); pyrimidine fungicides (bupirimate, diflumetorim, dimethirimol, ethirimol, fenarimol, ferimzone, nuarimol, triarimol); anilinopyrimidine fungicides (cyprodinil, mepanipyrim, pyrimethanil); pyrrole fungicides (dimetachlone, fenpiclonil, fludioxonil, fluoroimide); quaternary ammonium fungicides (berberine, sanguinarine); quinoline fungicides (ethoxyquin, halacrinate, 8-hydroxyquinoline sulfate, quinacetol, quinoxyfen, tebufloquin); quinone fungicides (chloranil, dichlone, dithianon); quinoxaline fungicides (chinomethionat, chlorquinox, thioquinox); thiadiazole fungicides (etridiazole, saisentong, thiodiazole-copper, zinc thiazole); thiazole fungicides (ethaboxam, isotianil, metsulfovax, octhilinone, oxathiapiprolin, thiabendazole, thifluzamide); thiazolidine fungicides (flutianil, thiadifluor); thiocarbamate fungicides (methasulfocarb, prothiocarb); thiophene fungicides (ethaboxam, isofetamid, silthiofam); triazine fungicides (anilazine); triazole fungicides (amisulbrom, bitertanol, fluotrimazole, triazbutil); conazole fungicides (triazoles) (azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, huanjunzuo, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P); triazolopyrimidine fungicides (ametoctradin); urea fungicides (bentaluron, pencycuron, quinazamid); zinc fungicides (acypetacs-zinc, copper zinc chromate, cufraneb, mancozeb, metiram, polycarbamate, polyoxorim-zinc, propineb, zinc naphthenate, zinc thiazole, zinc trichlorophenoxide, zineb, ziram); unclassified fungicides (acibenzolar, acypetacs, allyl alcohol, benzalkonium chloride, bethoxazin, bromothalonil, chitosan, chloropicrin, DBCP, dehydroacetic acid, diclomezine, diethyl pyrocarbonate, ethylicin, fenaminosulf, fenitropan, fenpropidin, formaldehyde, furfural, hexachlorobutadiene, methyl isothiocyanate, nitrostyrene, nitrothal-isopropyl, OCH, pentachlorophenyl laurate, 2-phenylphenol, phthalide, piperalin, propamidine, proquinazid, pyroquilon, sodium orthophenylphenoxide, spiroxamine, sultropen, thicyofen, tricyclazole), or mefenoxam.

Non-limiting embodiments of the invention include:

1. A composition comprising:

(a) at least one of bacterial strain AIP1620, AIP050999, and CGA267356, or an active variant of any thereof, wherein the active variant comprises a bacterial strain having a genome within a Mash distance of about 0.015; and

(b) at least one synthetic fungicide selected from the group consisting of tetraconazole, triflumizole, azoxystrobin, flutriafol, tebuconazole, chlorothalonil, and difenoconazole;

wherein said composition comprises an active ingredient weight ratio selected from the group consisting of:
(i) an active ingredient weight ratio of (a):tetraconazole (lb/lb) between about 1:10 and about 1000:1;
(ii) an active ingredient weight ratio of (a):triflumizole (lb/lb) between about 1:10 and about 100:1;
(iii) an active ingredient weight ratio of (a):azoxystrobin (lb/lb) between about 1:10 and about 500:1;
(iv) an active ingredient weight ratio of (a):flutriafol (lb/lb) between about 1:10 and about 1000:1;
(v) an active ingredient weight ratio of (a):tebuconazole (lb/lb) between about 1:10 and about 500:1;
(vi) an active ingredient weight ratio of (a):chlorothalonil (lb/lb) between about 1:100 and about 500:1; and
(vii) an active ingredient weight ratio of (a):difenoconazole (lb/lb) between about 1:10 and about 500:1.

2. The composition of embodiment 1, wherein said composition comprises an active ingredient weight ratio selected from the group consisting of:
(i) an active ingredient weight ratio of (a):tetraconazole (lb/lb) between about 1:1 and about 100:1;
(ii) an active ingredient weight ratio of (a):azoxystrobin (lb/lb) between about 1:1 and about 20:1;
(iii) an active ingredient weight ratio of (a):chlorothalonil (lb/lb) between about 1:10 and about 10:1;
iv) an active ingredient weight ratio of (a):tebuconazole (lb/lb) between about 1:1 and about 50:1;
v) an active ingredient weight ratio of (a):flutriafol (lb/lb) between about 1:1 and about 100:1;
vi) an active ingredient weight ratio of (a):triflumizole (lb/lb) between about 1:10 and about 20:1; and
vii) an active ingredient weight ratio of (a):difenoconazole (lb/lb) between about 1:1 and about 50:1.

3. The composition of embodiment 2, wherein said composition comprises an active ingredient weight ratio selected from the group consisting of:
(i) an active ingredient weight ratio of (a):azoxystrobin (lb/lb) of about 7.8:1;
(ii) an active ingredient weight ratio of (a):chlorothalonil (lb/lb) of about 1.1:1.0;
(iii) an active ingredient weight ratio of (a):tebuconazole (lb/lb) of about 6.7:1;
(iv) an active ingredient weight ratio of (a):flutriafol (lb/lb) of about 62.5:1;
(v) an active ingredient weight ratio of (a):triflumizole (lb/lb) of about 1.66:1; and
(vi) an active ingredient weight ratio of (a):difenoconazole (lb/lb) of about 25:1.

4. The composition of any one of embodiments 1-3, wherein said composition comprises at least 400 μg pyrrolnitrin per gram of cells of said bacterial strain.

5. The composition of any one of embodiments 1-4, wherein said composition comprises a wettable powder, dry formulation, wettable granule, spray dried formulation, or agglomerated formulation comprising said bacterial strain or the active variant of any thereof.

6. The composition of embodiment 5, wherein said composition comprises a dry flowable comprising at least one of azoxystrobin, chlorothalonil, flutriafol, triflumazole, difenoconazole, and tebuconazole.

7. The composition of embodiment 5, wherein said composition comprises a liquid flowable formulation comprising at least one of azoxystrobin, chlorothalonil, flutriafol, triflumazole, and difenoconazole.

8. The composition of any one of embodiments 1-4, wherein said (a), (b), or both (a) and (b) comprise a water dispersable granule.

9. The composition of any one of embodiments 1-4, wherein said (a) comprises a cell paste.

10. The composition of any one of embodiments 1-9, wherein an effective amount of the composition improves an agronomic trait of interest of a plant or controls a plant pathogen that causes a plant disease.

11. The composition of embodiment 10, wherein the plant disease is a plant disease caused by a fungal pathogen or fungal-like pathogen.

12. The composition of embodiment 10, wherein the plant pathogen is Asian Soybean Rust (ASR), powdery mildew, anthracnose, target spot, early blight, head drop, downy mildew, gray mold, and/or zonate leaf spot.

13. The composition of embodiment 10, wherein said plant pathogen comprises at least one fungal pathogen or fungal-like pathogen.

14. The composition of embodiment 10, wherein said at least one plant pathogen comprises Botrytis spp., Bremia spp., Cersospora spp., Corynespora spp., Alternatia spp., Fusarium spp., Podosphaera spp., Gleocercospora spp., Pseudoperonospora spp., Phakopsora sp., Puccinia spp., Pythium spp., Phytophthora spp., Rhizoctonia spp., Sclerotinia spp., Verticillium spp., Colletotrichum ssp. or Monilinia spp.

15. The composition of embodiment 13, wherein said at least one plant pathogen comprises Botrytis cinerea, Cercospora sojina, Corynespora cassiicola, Alternaria solani, Alternaria dauci, Bremia lactucae, Gleocercospora sorghi, Rhizoctonia solani, Erysiphe necator, Podosphaera xanthii, Colletotrichum cereal, Colletotrichum graminicola, Fusarium nivale, Plasmopara viticola, Peronospora belbahrii, Pythium aphanidermatum, Pythium sylvaticum, Pythium myriotylum, Pythium ultimum, Phytophthora nicotianae, Phytophthora infestans, Phytophthora tropicalis, Phytophthora sojae, Pseudoperonospora cubensis, Fusarium graminearum, Fusarium solani, Phakopsora pachyrizi, Sclerotinia minor, or Venturia inaequalisa.

16. The composition of any one of embodiments 1-15, wherein said composition comprises said synthetic fungicide at a concentration for application lower than the suggested application rate.

17. The composition of any one of embodiments 1-16, wherein said composition comprises at least one of AIP1620, AIP050999, and CGA267356, or the active variant of any thereof at a concentration for application lower than the suggested application rate.

18. The composition of embodiment 17, wherein said composition comprises at least one of AIP1620, AIP050999, and CGA267356, or the active variant of any thereof at a concentration for application at about 0.5 lb/acre to about 2.49 lb/acre.

19. The composition of embodiment 18, wherein said composition comprises at least one of AIP1620, AIP050999, and CGA267356, or the active variant of any thereof at a concentration for application at about 0.5 lb/acre or about 1.25 lb/acre.

20. The compositions of any one of embodiments 1-19, wherein said composition comprises a kit having said synthetic fungicide in a spatially separated arrangement from said at least one of AIP1620, AIP050999, and CGA267356, or the active variant of any thereof.

21. A plant or plant part comprising an effective amount of the composition of any one of embodiments 1-20 on the surface of said plant or plant part.

22. A seed coated with the composition of any one of embodiments 1-20.

23. The seed of embodiment 22, wherein said seed is a monocot.

24. The seed of embodiment 22, wherein said seed is a dicot.

25. The seed of embodiment 22, wherein said seed is selected from the group consisting of corn (maize), sorghum, wheat, sunflower, tomato, crucifers, peppers, potato, cotton, rice, soybean, sugarbeet, sugarcane, tobacco, barley, oilseed rape, Brassica sp., alfalfa, rye, millet, safflower, peanuts, sweet potato, cassava, coffee, coconut, pineapple, citrus trees, cocoa, tea, banana, avocado, fig, guava, mango, olive, papaya, cashew, macadamia, almond, oats, vegetables, ornaments, and conifers.

26. A method for growing a plant susceptible to a plant disease or improving an agronomic trait of interest in a plant comprising applying to the plant an effective amount of a combination comprising:

(a) at least one of bacterial strain AIP1620, AIP050999, and CGA267356, or an active variant of any thereof wherein the active variant comprises a bacterial strain having a genome within a Mash distance of about 0.015; and

(b) at least one synthetic fungicide selected from the group consisting of tetraconazole, triflumizole, azoxystrobin, flutriafol, tebuconazole, chlorothalonil, and difenoconazole;

wherein said method comprises applying (a) and (b) at an active ingredient weight ratio selected from the group consisting of:
(i) an active ingredient weight ratio of (a):tetraconazole (lb/lb) between about 1:10 and about 1000:1;
(ii) an active ingredient weight ratio of (a):triflumizole (lb/lb) between about 1:10 and about 100:1;
(iii) an active ingredient weight ratio of (a):azoxystrobin (lb/lb) between about 1:10 and about 500:1;
(iv) an active ingredient weight ratio of (a):flutriafol (lb/lb) between about 1:10 and about 1000:1;
(v) an active ingredient weight ratio of (a):tebuconazole (lb/lb) between about 1:10 and about 500:1;
(vi) an active ingredient weight ratio of (a):chlorothalonil (lb/lb) between about 1:100 and about 500:1; and
(vii) an active ingredient weight ratio of (a):difenoconazole (lb/lb) between about 1:10 and about 500:1;
wherein said effective amount controls a plant pathogen that causes the plant disease or improves the agronomic trait of interest.

27. The method of embodiment 26, wherein said method increases yield of the plant susceptible to the plant disease.

28. A method for controlling a plant pathogen that causes a plant disease in an area of cultivation comprising:

planting the area of cultivation with seeds or plants susceptible to the plant disease; and

applying to the plant susceptible to the plant disease or area of cultivation an effective amount of a combination comprising:
(a) at least one of bacterial strain AIP1620, AIP050999, and CGA267356, or an active variant of any thereof; and wherein the active variant comprises a bacterial strain having a genome within a Mash distance of about 0.015; and
(b) at least one synthetic fungicide selected from the group consisting of tetraconazole, triflumizole, azoxystrobin, flutriafol, tebuconazole, chlorothalonil, and difenoconazole;

wherein said method comprises applying (i) and (ii) at an active ingredient weight ratio selected from the group consisting of:
(i) an active ingredient weight ratio of (i):tetraconazole (lb/lb) between about 1:10 and about 1000:1;
(ii) an active ingredient weight ratio of (i):triflumizole (lb/lb) between about 1:10 and about 100:1;
(iii) an active ingredient weight ratio of (i):azoxystrobin (lb/lb) between about 1:10 and about 500:1;
(iv) an active ingredient weight ratio of (i):flutriafol (lb/lb) between about 1:10 and about 1000:1;
(v) an active ingredient weight ratio of (i):tebuconazole (lb/lb) between about 1:10 and about 500:1;
(vi) an active ingredient weight ratio of (i):chlorothalonil (lb/lb) between about 1:100 and about 500:1; and
(vii) an active ingredient weight ratio of (i):difenoconazole (lb/lb) between about 1:10 and about 500:1; and wherein said effective amount controls said plant pathogen that causes said plant disease.

29. A method of treating or preventing a plant disease comprising applying to a plant having a plant disease or at risk of developing a plant disease an effective amount of a combination comprising:

(a) at least one of bacterial strain AIP1620, AIP050999, and CGA267356 or an active variant of any thereof, wherein the active variant comprises a bacterial strain having a genome within a Mash distance of about 0.015; and

(b) at least one synthetic fungicide selected from the group consisting of tetraconazole, triflumizole, azoxystrobin, flutriafol, tebuconazole, chlorothalonil, and difenoconazole;

wherein said method comprises applying (a) and (b) at an active ingredient weight ratio selected from the group consisting of:
(i) an active ingredient weight ratio of (a):tetraconazole (lb/lb) between about 1:10 and about 1000:1;
(ii) an active ingredient weight ratio of (a):triflumizole (lb/lb) between about 1:10 and about 100:1;
(iii) an active ingredient weight ratio of (a):azoxystrobin (lb/lb) between about 1:10 and about 500:1;
(iv) an active ingredient weight ratio of (a):flutriafol (lb/lb) between about 1:10 and about 1000:1;
(v) an active ingredient weight ratio of (a):tebuconazole (lb/lb) between about 1:10 and about 500:1;
(vi) an active ingredient weight ratio of (a):chlorothalonil (lb/lb) between about 1:100 and about 500:1; and
(vii) an active ingredient weight ratio of (a):difenoconazole (lb/lb) between about 1:10 and about 500:1; and

wherein said effective amount controls a plant pathogen that causes the plant disease.

30. The method of any one of embodiments 26-29, wherein said method comprises applying (a) and (b) at an active ingredient weight ratio selected from the group consisting of:
(i) an active ingredient weight ratio of (b):tetraconazole (lb/lb) between about 1:1 and about 100:1;
(ii) an active ingredient weight ratio of (b):azoxystrobin (lb/lb) between about 1:1 and about 20:1;
(iii) an active ingredient weight ratio of (b):chlorothalonil (lb/lb) between about 1:10 and about 10:1;
(iv) an active ingredient weight ratio of (b):tebuconazole (lb/lb) between about 1:1 and about 50:1;
(v) an active ingredient weight ratio of (b):flutriafol (lb/lb) between about 1:1 and about 100:1;
(vi) an active ingredient weight ratio of (b):triflumizole (lb/lb) between about 1:10 and about 20:1; and
(vii) an active ingredient weight ratio of (b):difenoconazole (lb/lb) between about 1:1 and about 50:1.

31. The method of embodiment 30, wherein said method comprises applying (a) and (b) at an active ingredient weight ratio selected from the group consisting of:
(i) an active ingredient weight ratio of (b):azoxystrobin (lb/lb) of about 7.8:1;
(ii) an active ingredient weight ratio of (b):chlorothalonil (lb/lb) of about 1.0:1.2;
(iii) an active ingredient weight ratio of (b):tebuconazole (lb/lb) of about 22.2:1;
(iv) an active ingredient weight ratio of (b):flutriafol (lb/lb) of about 62.5:1;
(v) an active ingredient weight ratio of (b):triflumizole (lb/lb) of about 1.66:1; and
(vi) an active ingredient weight ratio of (b):difenoconazole (lb/lb) of about 25:1.

32. The method of any one of embodiments 26-31, wherein said method comprises applying at least about 10¹² to about 10¹⁶ colony forming units (CFU) of bacterial strain, or a combination of cells or the active variant of any thereof per hectare.

33. The method of any one of embodiments 26-32, wherein the plant disease is a plant disease caused by a fungal pathogen.

34. The method of embodiment 32, wherein the plant disease is Asian Soybean Rust (ASR), anthracnose, target spot, early blight, head drop, downy mildew, powdery mildew, gray mold, and/or zonate leaf spot.

35. The method of any one of embodiments 26-32, wherein the plant pathogen comprises at least one fungal pathogen.

36. The method of embodiment 26-32, wherein said at least one plant pathogen comprises Botrytis spp., Bremia spp., Cersospora spp., Corynespora spp., Alternatia spp., Fusarium spp., Podosphaera spp., Gleocercospora spp., Pseudoperonospora spp., Phakopsora sp., Puccinia spp., Pythium spp., Phytophthora spp., Rhizoctonia spp., Sclerotinia spp., Verticillium spp., Colletotrichum ssp., and Monilinia spp.

37. The method of embodiment 35, wherein said plant pathogen comprises Botrytis cinerea, Cercospora sojina, Corynespora cassiicola, Alternaria solani, Alternaria dauci, Bremia lactucae, Gleocercospora sorghi, Rhizoctonia solani, Erysiphe necator, Podosphaera xanthii, Colletotrichum cereal, Colletotrichum graminicola, Fusarium nivale, Plasmopara viticola, Peronospora belbahrii, Pythium aphanidermatum, Pythium sylvaticum, Pythium myriotylum, Pythium ultimum, Phytophthora nicotianae, Phytophthora infestans, Phytophthora tropicalis, Phytophthora sojae, Pseudoperonospora cubensis, Fusarium graminearum, Fusarium solani, Phakopsora pachyrizi, Sclerotinia minor, or Venturia inaequalisa.

38. The method of any one of embodiments 26-37, wherein said effective amount comprises an amount of the synthetic fungicide that is lower than the suggested application amount, such as 10-20% lower or 20-40% lower than the suggested application amount.

39. The method of any one of embodiments 26-38, wherein said effective amount comprises an amount of at least one of AIP1620, AIP050999, and CGA267356, or the active variant of any thereof that is lower than the suggested application amount.

40. The method of embodiment 39, wherein said effective amount comprises about 0.5 lb/acre to about 2.49 lb/acre of at least one of AIP1620, AIP050999, and CGA267356, or the active variant of any thereof.

41. The method of embodiment 40, wherein said effective amount comprises about 0.5 lb/acre or about 1.25 lb/acre of at least one of AIP1620, AIP050999, and CGA267356, or the active variant of any thereof.

42. The method of any one of embodiments 26-41, wherein the bacterial strain or active variant thereof and the synthetic fungicide are applied simultaneously.

43. The method of any one of embodiments 26-41, wherein the bacterial strain or active variant thereof and the synthetic fungicide are applied sequentially.

44. The method of any one of embodiments 26-41, wherein the bacterial strain or active variant thereof and the synthetic fungicide are applied sequentially, alternating between the two.

45. The method of any one of embodiments 26-44, wherein said plant is a monocot.

46. The method of any one of embodiments 26-44, wherein said plant is a dicot.

47. The method of any one of embodiments 26-44, wherein said plant is selected from the group consisting of corn (maize), sorghum, wheat, sunflower, tomato, crucifers, peppers, potato, cotton, rice, soybean, sugarbeet, sugarcane, tobacco, barley, oilseed rape, Brassica sp., alfalfa, rye, millet, safflower, peanuts, sweet potato, cassava, coffee, coconut, pineapple, citrus trees, cocoa, tea, banana, avocado, fig, guava, mango, olive, papaya, cashew, macadamia, almond, oats, vegetables, ornaments, and conifers.

The following examples are offered by way of illustration and not by way of limitation.

### EXPERIMENTAL

### Example 1. Field Trials of Treatment with AIP1620 and Synthetic Fungicide

This example demonstrates that combinations of AIP1620 bacterial strain at reduced rates, mixed with reduced rates of synthetic fungicides are as, or more effective than full rates of synthetic fungicides in a variety of field trials. This concept allows growers to gain the benefits of reducing overall use of synthetic fungicides while maintaining, and often improving overall product performance. Examples below include four major classes of synthetic fungicides: a strobilurin (Azoxystrobin), several demethylation inhibitors (Tebuconazole, Difenoconazole and Triflumazole), a broad-spectrum multisite inhibitor (Chlorothalonil) and a Ketose-reductase inhibitor (Fenhexamid).

### Methods

The target crop was grown in research plots using normal production methods. Products were applied as a foliar spray in water along with a non-ionic surfactant several times during the growing season. AIP1620 was applied at a half rate of 2.5 lbs/acre alone, or in combination with a commercially-available formulation of each synthetic fungicide. Products were mixed in spray tanks and applied to four replicate plots as a foliar spray. Unless indicated otherwise, natural infestation of the crop occurred. Disease incidence or severity was visually evaluated periodically, depending on the level of infestation and particular disease. Results across replicated plots were averaged to account for natural variability. Treated plots were compared to untreated controls and Percent Control for each treatment was calculated as follows:

% Control=((1−(disease in treated plot/disease in control plot))*100

### Results

### Azoxystrobin

The effects of AIP1620 and azoxystrobin, alone or in combination, were tested on target spot of tomato (Corynespora cassiicola). Disease severity was measured and results are provided in Table 2. Synergy between AIP1620 and azoxystrobin was observed.

TABLE 2

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 59 |
| AIP1620 50% WP | 2.5 | lbs/A | 1.25 | lbs active/A | 34 |
| AIP1620 50% WP + | 2.5 lbs/A + | | 1.25 lbs active/A + | | 65 |
| Azoxystrobin 22.9% F | 10 fl oz/A | | 0.16 lbs active/A | | |
| Azoxystrobin 22.9% F | 10 | fl oz/A | 0.16 | lbs active/A | 13 |
| Azoxystrobin 22.9% F | 15 | fl oz/A | 0.25 | lbs active/A | 38 |

The effects of AIP11620 and azoxystrobin, alone or in combination, were tested on early blight of tomato (Alternaria solani). Disease severity was measured and results are provided in Table 3. Synergy between AIP1620 and azoxystrobin was observed.

TABLE 3

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 56 |
| AIP1620 50% WP | 2.5 | lbs/A | 1.25 | lbs active/A | 16 |
| AIP1620 50% WP + | 2.5 lbs/A + | | 1.25 lbs active/A + | | 53 |
| Azoxystrobin 22.9% F | 10 fl oz/A | | 0.16 lbs active/A | | |
| Azoxystrobin 22.9% F | 10 | fl oz/A | 0.16 | lbs active/A | 6 |
| Azoxystrobin 22.9% F | 15 | fl oz/A | 0.25 | lbs active/A | 39 |

The effects of AIP1620 and azoxystrobin, alone or in combination, were tested on lettuce head drop (Sclerotinia minor). Disease incidence was measured and results are provided in Table 4.

TABLE 4

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 25 |
| AIP1620 50% WP | 2.5 | lbs/A | 1.25 | lbs active/A | 32 |
| AIP1620 50% WP + | 2.5 lbs/A + | | 1.25 lbs active/A + | | 48 |
| Azoxystrobin 22.9% F | 10 fl oz/A | | 0.16 lbs active/A | | |
| Azoxystrobin 22.9% F | 10 | fl oz/A | 0.16 | lbs active/A | 42 |
| Azoxystrobin 22.9% F | 15 | fl oz/A | 0.25 | lbs active/A | 38 |

The effects of AIP1620 and azoxystrobin, alone or in combination, were tested on lettuce downy mildew (Bremia lactuca). Disease severity was measured and results are provided in Table 5.

TABLE 5

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 51 |
| AIP1620 50% WP | 2.5 | lbs/A | 1.25 | lbs active/A | 47 |
| AIP1620 50% WP + | 2.5 lbs/A + | | 1.25 lbs active/A + | | 80 |
| Azoxystrobin 22.9% F | 10 fl oz/A | | 0.16 lbs active/A | | |
| Azoxystrobin 22.9% F | 10 | fl oz/A | 0.16 | lbs active/A | 63 |
| Azoxystrobin 22.9% F | 15 | fl oz/A | 0.25 | lbs active/A | 69 |

The effects of AIP1620 and azoxystrobin, alone or in combination, were tested on gray mold of lettuce (Botrytis spp.). Disease severity was measured and results are provided in Table 6.

TABLE 6

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 51 |
| AIP1620 50% WP | 2.5 | lbs/A | 1.25 | lbs active/A | 59 |
| AIP1620 50% WP + | 2.5 lbs/A + | | 1.25 lbs active/A + | | 78 |
| Azoxystrobin 22.9% F | 10 fl oz/A | | 0.16 lbs active/A | | |
| Azoxystrobin 22.9% F | 10 | fl oz/A | 0.16 | lbs active/A | 56 |
| Azoxystrobin 22.9% F | 15 | fl oz/A | 0.25 | lbs active/A | 63 |

The effects of AIP11620 and azoxystrobin, alone or in combination, were tested on early blight of potato (Alternaria solani). Disease severity was measured and results are provided in Table 7.

TABLE 7

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 28 |
| AIP1620 50% WP | 2.5 | lbs/A | 1.25 | lbs active/A | 34 |
| AIP1620 50% WP + | 2.5 lbs/A + | | 1.25 lbs active/A + | | 57 |
| Azoxystrobin .8 SG | 0.2 lbs/A | | 0.16 lbs active/A | | |
| Azoxystrobin .8 SG | 0.2 | lbs/A | 0.16 | lbs active/A | 47 |
| Azoxystrobin .8 SG | 0.3 | lbs/A | 0.24 | lbs active/A | 56 |

The effects of AIP1620 and azoxystrobin, alone or in combination, were tested on squash downy mildew (Pseudoperonospora cubensis). Disease severity was measured and results are provided in Table 8. Synergy between AIP1620 and azoxystrobin was observed.

TABLE 8

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 41 |
| AIP1620 50% WP | 2.5 | lbs/A | 1.25 | lbs active/A | 6 |
| AIP1620 50% WP + | 2.5 lbs/A + | | 1.25 lbs active/A + | | 87 |
| Azoxystrobin 22.9% F | 10 fl oz/A | | 0.16 lbs active/A | | |
| Azoxystrobin 22.9% F | 10 | fl oz/A | 0.16 | lbs active/A | 64 |
| Azoxystrobin 22.9% F | 15 | fl oz/A | 0.25 | lbs active/A | 91 |

The effects of AIP1620 and azoxystrobin, alone or in combination, were tested on squash powdery mildew (Podosphaera xanthii). Disease severity was measured and results are provided in Table 9.

TABLE 9

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 62 |
| AIP1620 50% WP | 2.5 | lbs/A | 1.25 | lbs active/A | 41 |
| AIP1620 50% WP + | 2.5 lbs/A + | | 1.25 lbs active/A + | | 95 |
| Azoxystrobin 22.9% F | 10 fl oz/A | | 0.16 lbs active/A | | |
| Azoxystrobin 22.9% F | 10 | fl oz/A | 0.16 | lbs active/A | 90 |
| Azoxystrobin 22.9% F | 15 | fl oz/A | 0.25 | lbs active/A | 97 |

The effects of AIP11620 and azoxystrobin, alone or in combination, were tested on early blight of carrot (Alternaria dauci). Disease severity was measured and results are provided in Table 10.

TABLE 10

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 43 |
| AIP1620 50% WP | 2.5 | lbs/A | 1.25 | lbs active/A | 43 |
| AIP1620 50% WP+ | 2.5 lbs/A + | | 1.25 lbs active/A + | | 80 |
| Azoxystrobin 22.9% F | 7.75 fl oz/A | | 0.12 lbs active/A | | |
| Azoxystrobin 22.9% F | 7.75 fl oz/A | | 0.12 | lbs active/A | 73 |
| | fl oz/A | | | | |
| Azoxystrobin 22.9% F | 15.5 | fl oz/A | 0.24 | lbs active/A | 45 |

### AIP1620 and Chlorothalonil

The effects of AIP11620 and chlorothalonil, alone or in combination, were tested on target spot of tomato (Corynespora cassiicola). Disease severity was measured and results are provided in Table 11.

TABLE 11

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 32 |
| AIP1620 50% WP | 2.5 | lbs/A | 1.25 | lbs active/A | 23 |
| AIP1620 50% WP + | 2.5 lbs/A + | | 1.25 lbs active/A + | | 24 |
| Chlorothalonil 720F | 2 pt/A | | 1.5 lbs active/A | | |
| (720 g/L) | | | | | |
| Chlorothalonil 720F | 2 | pt/A | 1.5 | lbs active/A | 19 |
| Chlorothalonil 720F | 3 | pt/A | 2.25 | lbs active/A | 23 |

The effects of AIP1620 and chlorothalonil, alone or in combination, were tested on downy mildew of squash (Pseudoperonospora cubensis). Disease severity was measured and results are provided in Table 12.

TABLE 12

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 68 |
| AIP1620 50% WP | 2.5 | lbs/A | 1.25 | lbs active/A | 58 |
| AIP1620 50% WP + | 2.5 lbs/A + | | 1.25 lbs active/A + | | 91 |
| Chlorothalonil 720F | 2 pt/A | | 1.5 lbs active/A | | |
| Chlorothalonil 720F | 2 | pt/A | 1.5 | lbs active/A | 83 |
| Chlorothalonil 720F | 3 | pt/A | 2.25 | lbs active/A | 91 |

The effects of AIP11620 and chlorothalonil, alone or in combination, were tested on powdery mildew of squash (Podosphaera xanthii). Disease severity was measured and results are provided in Table 13.

TABLE 13

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 53 |
| AIP1620 50% WP | 2.5 | lbs/A | 1.25 | lbs active/A | 49 |
| AIP1620 50% WP + | 2.5 lbs/A + | | 1.25 lbs active/A + | | 91 |
| Chlorothalonil 720F | 2 pt/A | | 1.5 lbs active/A | | |
| Chlorothalonil 720F | 2 | pt/A | 1.5 | lbs active/A | 77 |
| Chlorothalonil 720F | 3 | pt/A | 2.25 | lbs active/A | 89 |

### AIP1620 and Tebuconazole

The effects of AIP1620 and tebuconazole, alone or in combination, were tested on gray mold of grape (Botrytis cinerea). Disease incidence was measured and results are provided in Table 14.

TABLE 14

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 100 |
| AIP1620 50% WP | 2.5 | lbs/A | 1.25 | lbs active/A | 70 |
| AIP1620 50% WP + | 2.5 lbs/A + | | 1.25 lbs active/A + | | 100 |
| Tebuconazole 45% WDG | 2.0 oz/A | | 0.9 oz active/A | | |
| Tebuconazole 45% WDG | 2.0 | oz/A | 0.9 | oz active/A | 65 |
| Tebuconazole 45% WDG | 4.0 | oz/A | 1.8 | oz active/A | 100 |

### AIP1620 and Flutriafol

The effects of AIP1620 and flutriafol, alone or in combination, were tested on target spot of tomato (Corenospora casiicola). Disease incidence was measured and results are provided in Table 15.

TABLE 15

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 85 |
| AIP1620 50% WP | 2.5 | lbs/A | 1.25 | lbs active/A | 57 |
| AIP1620 50% WP + | 2.5 lbs/A + | | 1.25 lbs active/A + | | 100 |
| Flutriafol 11F | 2.5 fl oz/A | | 0.02 lbs active/A | | |
| Flutriafol 11F | 2.5 | fl oz/A | 0.02 | lbs active/A | 85 |
| Flutriafol 11F | 5 | fl oz/A | 0.04 | lbs active/A | 57 |

The effects of AIP1620 and flutriafol, alone or in combination, were tested on zonate leaf spot of tomato (Gleocercospora sorghi). Disease incidence was measured and results are provided in Table 16.

TABLE 16

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 52 |
| AIP1620 50% WP | 2.5 | lbs/A | 1.25 | lbs active/A | 2 |
| AIP1620 50% WP + | 2.5 lbs/A + | | 1.25 lbs active/A + | | 82 |
| Flutriafol 11F | 2.5 fl oz/A | | 0.02 lbs active/A | | |
| Flutriafol 11F | 2.5 | fl oz/A | 0.02 | lbs active/A | 80 |
| Flutriafol 11F | 5 | fl oz/A | 0.04 | lbs active/A | 86 |

### AIP1620 and Triflumazole

The effects of AIP11620 and triflumazole, alone or in combination, were tested on powdery mildew of squash (Podosphaera xanthii). Disease incidence was measured and results are provided in Table 17.

TABLE 17

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 48 |
| AIP1620 50% WP | 2.5 | lbs/A | 1.25 | lbs active/A | 34 |
| AIP1620 50% WP + | 2.5 lbs/A + | | 1.25 lbs active/A + | | 81 |
| Triflumazole 42% F | 7 fl oz/A | | 0.75 lbs active/A | | |
| Triflumazole 42% F | 7 | fl oz/A | 0.75 | lbs active/A | 69 |
| Triflumazole 42% F | 14 | fl oz/A | 1.5 | lbs active/A | 86 |

### AIP1620 and Difenoconazole

The effects of AIP1620 and difenoconazole, alone or in combination, were tested on target spot of tomato (Corenospora casiicola). Disease severity on new growth was measured and results are provided in Table 18.

TABLE 18

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 26 |
| AIP1620 50% WP | 2.5 | lbs/A | 1.25 | lbs active/A | 29 |
| AIP1620 50% WP + | 2.5 lbs/A + | | 1.25 lbs active/A + | | 43 |
| Difenconazole 23.2% F | 3 fl oz/A | | 0.05 lbs active/A | | |
| Difenconazole 23.2% F | 3 | fl oz/A | 0.05 | lbs active/A | 26 |
| Difenconazole 23.2% F | 6 | fl oz/A | 0.10 | lbs active/A | 44 |

The effects of AIP1620 and difenoconazole, alone or in combination, were tested on early blight of tomato (Alternaria solani). Disease severity on new growth was measured and results are provided in Table 19.

TABLE 19

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 20 |
| AIP1620 50% WP | 2.5 | lbs/A | 1.25 | lbs active/A | 15 |
| AIP1620 50% WP + | 2.5 lbs/A + | | 1.25 lbs active/A + | | 37 |
| Difenconazole 23.2% F | 3 fl oz/A | | 0.05 lbs active/A | | |
| Difenconazole 23.2% F | 3 | fl oz/A | 0.05 | lbs active/A | 25 |
| Difenconazole 23.2% F | 6 | fl oz/A | 0.10 | lbs active/A | 44 |

The effects of AIP1620 and difenoconazole, alone or in combination, were tested on gray mold of lettuce (Botrytis cinerea). Disease severity was measured and results are provided in Table 20.

TABLE 20

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 59 |
| AIP1620 50% WP | 2.5 | lbs/A | 1.25 | lbs active/A | 51 |
| AIP1620 50% WP + | 2.5 lbs/A + | | 1.25 lbs active/A + | | 64 |
| Difenconazole 23.2% F | 3 fl oz/A | | 0.05 lbs active/A | | |
| Difenconazole 23.2% F | 3 | fl oz/A | 0.05 | lbs active/A | 24 |
| Difenconazole 23.2% F | 6 | fl oz/A | 0.10 | lbs active/A | 50 |

The effects of AIP1620 and difenoconazole, alone or in combination, were tested on lettuce drop (Sclerotinia minor). Disease incidence was measured and results are provided in Table 21.

TABLE 21

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 25 |
| AIP1620 50% WP | 2.5 | lbs/A | 1.25 | lbs active/A | 32 |
| AIP1620 50% WP + | 2.5 lbs/A + | | 1.25 lbs active/A + | | 51 |
| Difenconazole 23.2% F | 3 fl oz/A | | 0.05 lbs active/A | | |
| Difenconazole 23.2% F | 3 | fl oz/A | 0.05 | lbs active/A | 46 |
| Difenconazole 23.2% F | 6 | fl oz/A/A | 0.10 | lbs active/A | 20 |

The effects of AIP1620 and difenoconazole, alone or in combination, were tested on powdery mildew (Podosphaera xanthii). Disease incidence was measured and results are provided in Table 22.

TABLE 22

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 53 |
| AIP1620 50% WP | 2.5 | lbs/A | 1.25 | lbs active/A | 46 |
| AIP1620 50% WP + | 2.5 lbs/A + | | 1.25 lbs active/A + | | 91 |
| Difenconazole 23.2% F | 3 fl oz/A | | 0.05 lbs active/A | | |
| Difenconazole 23.2% F | 3 | fl oz/A | 0.05 | lbs active/A | 71 |
| Difenconazole 23.2% F | 6 | fl oz/A/A | 0.10 | lbs active/A | 93 |

The effects of AIP1620 and azoxystrobin, alone or in combination, were tested on damping off of carrot (Pythium spp.). Disease incidence was measured and results are provided in Table 23.

TABLE 23

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 14.5 |
| AIP1620 50% WP | 2.5 | lbs/A | 1.25 | lbs active/A | 15.6 |
| AIP1620 50% WP + | 2.5 lbs/A + | | 1.25 lbs active/A + | | 25.2 |
| Azoxystrobin 22.9% F | 7.75 fl oz/A | | 0.12 lbs active/A | | |
| Azoxystrobin 22.9% F | 10 fl oz/A | | 0.16 | lbs active/A | 10.2 |
| | fl oz/A | | | | |
| Azoxystrobin 22.9% F | 15.5 | fl oz/A | 0.24 | lbs active/A | 18 |

The effects of AIP1620 and fenhexamid, alone or in combination, were tested on powdery mildew of grape (Erysiphe necator). Disease incidence was measured and results are provided in Table 24.

TABLE 24

| | Dose Rate | | Dose Rate | | % |
|---|---|---|---|---|---|
| Treatment | (product) | | (active ingredient) | | Control |
| AIP1620 50% WP | 5.0 | lbs/A | 2.5 | lbs active/A | 35 |
| AIP1620 50% WP | 2.5 | lbs/A | 1.25 | lbs active/A | 37 |
| AIP1620 50% WP + | 2.5 lbs/A + | | 1.25 lbs active/A + | | 48 |
| Fenhexamid 50 WG | 1.5 lb/A | | 0.75 lbs active/A | | |
| Fenhexamid 50 WG | 1.5 | lbs/A | 0.75 | lbs active/A | 32 |
| Fenhexamid 50 WG | 3 | lbs/A | 1.5 | lbs active/A | 45 |

1. A composition comprising:
(a) at least one of bacterial strain AIP1620, AIP050999, and CGA267356; and
(b) at least one synthetic fungicide selected from the group consisting of tetraconazole, triflumizole, azoxystrobin, flutriafol, tebuconazole, chlorothalonil, and difenoconazole;
wherein said composition comprises an active ingredient weight ratio selected from the group consisting of:
(i) an active ingredient weight ratio of (a):tetraconazole (lb/lb) between about 1:10 and about 1000:1;
(ii) an active ingredient weight ratio of (a):triflumizole (lb/lb) between about 1:10 and about 100:1;
(iii) an active ingredient weight ratio of (a):azoxystrobin (lb/lb) between about 1:10 and about 500:1;
(iv) an active ingredient weight ratio of (a):flutriafol (lb/lb) between about 1:10 and about 1000:1;
(v) an active ingredient weight ratio of (a):tebuconazole (lb/lb) between about 1:10 and about 500:1;
(vi) an active ingredient weight ratio of (a):chlorothalonil (lb/lb) between about 1:100 and about 500:1; and
(vii) an active ingredient weight ratio of (a):difenoconazole (lb/lb) between about 1:10 and about 500:1.

2. The composition of claim 1, wherein said composition comprises an active ingredient weight ratio selected from the group consisting of:
(i) an active ingredient weight ratio of (a):tetraconazole (lb/lb) between about 1:1 and about 100:1;
(ii) an active ingredient weight ratio of (a):azoxystrobin (lb/lb) between about 1:1 and about 20:1;
(iii) an active ingredient weight ratio of (a):chlorothalonil (lb/lb) between about 1:10 and about 10:1;
iv) an active ingredient weight ratio of (a):tebuconazole (lb/lb) between about 1:1 and about 50:1;
v) an active ingredient weight ratio of (a):flutriafol (lb/lb) between about 1:1 and about 100:1;
vi) an active ingredient weight ratio of (a):triflumizole (lb/lb) between about 1:10 and about 20:1; and
vii) an active ingredient weight ratio of (a):difenoconazole (lb/lb) between about 1:1 and about 50:1.

3. The composition of claim 2, wherein said composition comprises an active ingredient weight ratio selected from the group consisting of:
(i) an active ingredient weight ratio of (a):azoxystrobin (lb/lb) of about 7.8:1;
(ii) an active ingredient weight ratio of (a):chlorothalonil (lb/lb) of about 1.0:1.2;
(iii) an active ingredient weight ratio of (a):tebuconazole (lb/lb) of about 22.2:1;
(iv) an active ingredient weight ratio of (a):flutriafol (lb/lb) of about 62.5:1;
(v) an active ingredient weight ratio of (a):triflumizole (lb/lb) of about 1.66:1; and
(vi) an active ingredient weight ratio of (a):difenoconazole (lb/lb) of about 25:1.

4. The composition of any one of claims 1-3, wherein said composition comprises at least 400 μg pyrrolnitrin per gram of cells of said bacterial strain.

5. The composition of any one of claims 1-4, wherein said composition comprises a wettable powder, dry formulation, wettable granule, spray dried formulation, or agglomerated formulation comprising said bacterial strain.

6. The composition of claim 5, wherein said composition comprises a dry flowable comprising at least one of azoxystrobin, chlorothalonil, flutriafol, triflumazole, difenoconazole, and tebuconazole.

7. The composition of any one of claims 1-4, wherein said (a), (b), or both (a) and (b) comprise a water dispersable granule.

8. The composition of any one of claims 1-4, wherein said (a) comprises a cell paste.

9. The composition of any one of claims 1-8, wherein an effective amount of the composition improves an agronomic trait of interest of a plant or controls a plant pathogen that causes a plant disease.

10. The composition of claim 9, wherein the plant disease is a plant disease caused by a fungal pathogen or fungal-like pathogen.

11. The composition of claim 9, wherein the plant pathogen is Asian Soybean Rust (ASR), powdery mildew, anthracnose, target spot, early blight, head drop, downy mildew, gray mold, and/or zonate leaf spot.

12. The composition of claim 9, wherein said plant pathogen comprises at least one fungal pathogen or fungal-like pathogen.

13. The composition of claim 9, wherein said at least one plant pathogen comprises Botrytis spp., Bremia spp., Cersospora spp., Corynespora spp., Alternatia spp., Fusarium spp., Podosphaera spp., Gleocercospora spp., Pseudoperonospora spp., Phakopsora sp., Puccinia spp., Pythium spp., Phytophthora spp., Rhizoctonia spp., Sclerotinia spp., Verticillium spp., Colletotrichum ssp. or Monilinia spp.

14. The composition of claim 13, wherein said at least one plant pathogen comprises Botrytis cinerea, Cercospora sojina, Corynespora cassiicola, Alternaria solani, Alternaria dauci, Bremia lactucae, Gleocercospora sorghi, Rhizoctonia solani, Erysiphe necator, Podosphaera xanthii, Colletotrichum cereal, Colletotrichum graminicola, Fusarium nivale, Plasmopara viticola, Peronospora belbahrii, Pythium aphanidermatum, Pythium sylvaticum, Pythium myriotylum, Pythium ultimum, Phytophthora nicotianae, Phytophthora infestans, Phytophthora tropicalis, Phytophthora sojae, Pseudoperonospora cubensis, Fusarium graminearum, Fusarium solani, Phakopsora pachyrizi, Sclerotinia minor, or Venturia inaequalisa.

15. The composition of any one of claims 1-14, wherein said composition comprises said synthetic fungicide at a concentration for application lower than the suggested application rate.

16. The composition of any one of claims 1-15, wherein said composition comprises at least one of AIP1620, AIP050999, and CGA267356 at a concentration for application lower than the suggested application rate.

17. The composition of claim 16, wherein said composition comprises at least one of AIP1620, AIP050999, and CGA267356 at a concentration for application at about 0.5 lb/acre to about 2.49 lb/acre.

18. The composition of claim 17, wherein said composition comprises at least one of AIP1620, AIP050999, and CGA267356 at a concentration for application at about 0.5 lb/acre or about 1.25 lb/acre.

19. The compositions of any one of claims 1-18, wherein said composition comprises a kit having said synthetic fungicide in a spatially separated arrangement from said at least one of AIP1620, AIP050999, and CGA267356.

20. A plant or plant part comprising an effective amount of the composition of any one of claims 1-20 on the surface of said plant or plant part.

21. A seed coated with the composition of any one of claims 1-19.

22. The seed of claim 21, wherein said seed is a monocot.

23. The seed of claim 21, wherein said seed is a dicot.

24. The seed of claim 21, wherein said seed is selected from the group consisting of corn (maize), sorghum, wheat, sunflower, tomato, crucifers, peppers, potato, cotton, rice, soybean, sugarbeet, sugarcane, tobacco, barley, oilseed rape, Brassica sp., alfalfa, rye, millet, safflower, peanuts, sweet potato, cassava, coffee, coconut, pineapple, citrus trees, cocoa, tea, banana, avocado, fig, guava, mango, olive, papaya, cashew, macadamia, almond, oats, vegetables, ornaments, and conifers.

25. A method for growing a plant susceptible to a plant disease or improving an agronomic trait of interest in a plant comprising applying to the plant an effective amount of a combination comprising:
(a) at least one of bacterial strain AIP1620, AIP050999, and CGA267356; and
(b) at least one synthetic fungicide selected from the group consisting of tetraconazole, triflumizole, azoxystrobin, flutriafol, tebuconazole, chlorothalonil, and difenoconazole;
wherein said method comprises applying (a) and (b) at an active ingredient weight ratio selected from the group consisting of:
(i) an active ingredient weight ratio of (a):tetraconazole (lb/lb) between about 1:10 and about 1000:1;
(ii) an active ingredient weight ratio of (a):triflumizole (lb/lb) between about 1:10 and about 100:1;
(iii) an active ingredient weight ratio of (a):azoxystrobin (lb/lb) between about 1:10 and about 500:1;
(iv) an active ingredient weight ratio of (a):flutriafol (lb/lb) between about 1:10 and about 1000:1;
(v) an active ingredient weight ratio of (a):tebuconazole (lb/lb) between about 1:10 and about 500:1;
(vi) an active ingredient weight ratio of (a):chlorothalonil (lb/lb) between about 1:100 and about 500:1; and
(vii) an active ingredient weight ratio of (a):difenoconazole (lb/lb) between about 1:10 and about 500:1;
wherein said effective amount controls a plant pathogen that causes the plant disease or improves the agronomic trait of interest.

26. The method of claim 25, wherein said method increases yield of the plant susceptible to the plant disease.

27. A method for controlling a plant pathogen that causes a plant disease in an area of cultivation comprising:
planting the area of cultivation with seeds or plants susceptible to the plant disease; and
applying to the plant susceptible to the plant disease or area of cultivation an effective amount of a combination comprising:
(a) at least one of bacterial strain AIP1620, AIP050999, and CGA267356; and
(b) at least one synthetic fungicide selected from the group consisting of tetraconazole, triflumizole, azoxystrobin, flutriafol, tebuconazole, chlorothalonil, and difenoconazole;
wherein said method comprises applying (i) and (ii) at an active ingredient weight ratio selected from the group consisting of:
(i) an active ingredient weight ratio of (i):tetraconazole (lb/lb) between about 1:10 and about 1000:1;
(ii) an active ingredient weight ratio of (i):triflumizole (lb/lb) between about 1:10 and about 100:1;
(iii) an active ingredient weight ratio of (i):azoxystrobin (lb/lb) between about 1:10 and about 500:1;
(iv) an active ingredient weight ratio of (i):flutriafol (lb/lb) between about 1:10 and about 1000:1;
(v) an active ingredient weight ratio of (i):tebuconazole (lb/lb) between about 1:10 and about 500:1;
(vi) an active ingredient weight ratio of (i):chlorothalonil (lb/lb) between about 1:100 and about 500:1; and
(vii) an active ingredient weight ratio of (i):difenoconazole (lb/lb) between about 1:10 and about 500:1; and
wherein said effective amount controls said plant pathogen that causes said plant disease.

28. A method of treating or preventing a plant disease comprising applying to a plant having a plant disease or at risk of developing a plant disease an effective amount of a combination comprising:
(a) at least one of bacterial strain AIP1620, AIP050999, and CGA267356; and
(b) at least one synthetic fungicide selected from the group consisting of tetraconazole, triflumizole, azoxystrobin, flutriafol, tebuconazole, chlorothalonil, and difenoconazole;
wherein said method comprises applying (a) and (b) at an active ingredient weight ratio selected from the group consisting of:
(i) an active ingredient weight ratio of (a):tetraconazole (lb/lb) between about 1:10 and about 1000:1;
(ii) an active ingredient weight ratio of (a):triflumizole (lb/lb) between about 1:10 and about 100:1;
(iii) an active ingredient weight ratio of (a):azoxystrobin (lb/lb) between about 1:10 and about 500:1;
(iv) an active ingredient weight ratio of (a):flutriafol (lb/lb) between about 1:10 and about 1000:1;
(v) an active ingredient weight ratio of (a):tebuconazole (lb/lb) between about 1:10 and about 500:1;
(vi) an active ingredient weight ratio of (a):chlorothalonil (lb/lb) between about 1:100 and about 500:1; and
(vii) an active ingredient weight ratio of (a):difenoconazole (lb/lb) between about 1:10 and about 500:1; and
wherein said effective amount controls a plant pathogen that causes the plant disease.

29. The method of any one of claims 25-28, wherein said method comprises applying (a) and (b) at an active ingredient weight ratio selected from the group consisting of:
(i) an active ingredient weight ratio of (b):tetraconazole (lb/lb) between about 1:1 and about 100:1;
(ii) an active ingredient weight ratio of (b):azoxystrobin (lb/lb) between about 1:1 and about 20:1;
(iii) an active ingredient weight ratio of (b):chlorothalonil (lb/lb) between about 1:10 and about 10:1;
(iv) an active ingredient weight ratio of (b):tebuconazole (lb/lb) between about 1:1 and about 50:1;
(v) an active ingredient weight ratio of (b):flutriafol (lb/lb) between about 1:1 and about 100:1;
(vi) an active ingredient weight ratio of (b):triflumizole (lb/lb) between about 1:10 and about 20:1; and
(vii) an active ingredient weight ratio of (b):difenoconazole (lb/lb) between about 1:1 and about 50:1.

30. The method of claim 29, wherein said method comprises applying (a) and (b) at an active ingredient weight ratio selected from the group consisting of:
(i) an active ingredient weight ratio of (b):azoxystrobin (lb/lb) of about 7.8:1;
(ii) an active ingredient weight ratio of (b):chlorothalonil (lb/lb) of about 1.0:1.2;
(iii) an active ingredient weight ratio of (b):tebuconazole (lb/lb) of about 22.2:1;
(iv) an active ingredient weight ratio of (b):flutriafol (lb/lb) of about 62.5:1;
(v) an active ingredient weight ratio of (b):triflumizole (lb/lb) of about 1.66:1; and
(vi) an active ingredient weight ratio of (b):difenoconazole (lb/lb) of about 25:1.

31. The method of any one of claims 25-30, wherein said method comprises applying at least about 10¹² to about 10¹⁶ colony forming units (CFU) of bacterial strain, or a combination of cells per hectare.

32. The method of any one of claims 25-31, wherein the plant disease is a plant disease caused by a fungal pathogen.

33. The method of claim 31, wherein the plant disease is Asian Soybean Rust (ASR), anthracnose, target spot, early blight, head drop, downy mildew, powdery mildew, gray mold, and/or zonate leaf spot.

34. The method of any one of claims 25-31, wherein the plant pathogen comprises at least one fungal pathogen.

35. The method of claim 25-31, wherein said at least one plant pathogen comprises Botrytis spp., Bremia spp., Cersospora spp., Corynespora spp., Alternatia spp., Fusarium spp., Podosphaera spp., Gleocercospora spp., Pseudoperonospora spp., Phakopsora sp., Puccinia spp., Pythium spp., Phytophthora spp., Rhizoctonia spp., Sclerotinia spp., Verticillium spp., Colletotrichum ssp., and Monilinia spp.

36. The method of claim 34, wherein said plant pathogen comprises Botrytis cinerea, Cercospora sojina, Corynespora cassiicola, Alternaria solani, Alternaria dauci, Bremia lactucae, Gleocercospora sorghi, Rhizoctonia solani, Erysiphe necator, Podosphaera xanthii, Colletotrichum cereal, Colletotrichum graminicola, Fusarium nivale, Plasmopara viticola, Peronospora belbahrii, Pythium aphanidermatum, Pythium sylvaticum, Pythium myriotylum, Pythium ultimum, Phytophthora nicotianae, Phytophthora infestans, Phytophthora tropicalis, Phytophthora sojae, Pseudoperonospora cubensis, Fusarium graminearum, Fusarium solani, Phakopsora pachyrizi, Sclerotinia minor, or Venturia inaequalisa.

37. The method of any one of claims 25-36, wherein said effective amount comprises an amount of the synthetic fungicide that is lower than the suggested application amount.

38. The method of claim 37, wherein said effective amount comprises an amount of the synthetic fungicide that is 10-20% lower than then suggested application amount.

39. The method of claim 38, wherein said effective amount comprises an amount of the synthetic fungicide that is 20-40% lower than then suggested application amount.

40. The method of any one of claims 25-39, wherein the bacterial strain and the synthetic fungicide are applied simultaneously.

41. The method of any one of claims 25-39, wherein the bacterial strain and the synthetic fungicide are applied sequentially.

42. The method of any one of claims 25-39, wherein the bacterial strain and the synthetic fungicide are applied sequentially, alternating between the two.

43. The method of any one of claims 25-42, wherein said plant is a monocot.

44. The method of any one of claims 25-42, wherein said plant is a dicot.

45. The method of any one of claims 25-42, wherein said plant is selected from the group consisting of corn (maize), sorghum, wheat, sunflower, tomato, crucifers, peppers, potato, cotton, rice, soybean, sugarbeet, sugarcane, tobacco, barley, oilseed rape, Brassica sp., alfalfa, rye, millet, safflower, peanuts, sweet potato, cassava, coffee, coconut, pineapple, citrus trees, cocoa, tea, banana, avocado, fig, guava, mango, olive, papaya, cashew, macadamia, almond, oats, vegetables, ornaments, and conifers.
